(19) United States
(12) Patent Application Publication
(10) Pub. No.: US 2003/0046396 A1
(43) Pub. Date: Mar. 6, 2003

(54) Systems and methods for managing resource utilization in information management environments

(76) Inventors: Roger K. Richter, Leander, TX (US); Chaoxin C. Qiu, Austin, TX (US); Scott C. Johnson, Round Rock, TX (US)

Correspondence Address: William W. Enders, O'KEEFE, EGAN & PETERMAN, Building C, Suite 200, 1101 Capital of Texas Highway South, Austin, TX, 78746, US

(21) Appl. No.: 10/117,028

(22) Filed: Apr. 5, 2002

Related U.S. Application Data
(63) Continuation-in-part of application No. 10/003,683, filed on Nov. 2, 2001.
(63) Continuation-in-part of application No. 09/879,810, filed on Jun. 12, 2001.
(63) Continuation-in-part of application No. 09/797,200, filed on Mar. 1, 2001.
(63) Continuation-in-part of application No. 09/947,869, filed on Sep. 6, 2001.
(63) Continuation-in-part of application No. 09/879,810, filed on Jun. 12, 2001.
(63) Continuation-in-part of application No. 09/797,198, filed on Mar. 1, 2001.
(63) Continuation-in-part of application No. 10/003,728, filed on Nov. 2, 2001.
(60) Provisional application No. 60/353,104, filed on Jan. 30, 2002.
(60) Provisional application No. 60/285,211, filed on Apr. 20, 2001.
(60) Provisional application No. 60/291,073, filed on May 15, 2001.
(60) Provisional application No. 60/246,401, filed on Nov. 7, 2000.
(60) Provisional application No. 60/187,211, filed on Mar. 3, 2000.
(60) Provisional application No. 60/246,373, filed on Nov. 7, 2000.
(60) Provisional application No. 60/187,211, filed on Mar. 3, 2000.
(60) Provisional application No. 60/291,073, filed on May 15, 2001.
(60) Provisional application No. 60/246,445, filed on Nov. 7, 2000.
(60) Provisional application No. 60/285,211, filed on Apr. 20, 2001.

(51) Int. Cl. G06F 15/173

(52) U.S. Cl. 709/226

(57) ABSTRACT

Resource usage accounting may be implemented in information management environments using resource utilization values. Resource usage accounting may be employed, for example, to make possible run-time enforcement of system operations on one or more subsystems or processing engines of an information management system, such as a content delivery system, for example, to advantageously provide intelligent admission control in a distributed environment. In one embodiment, resource usage accounting may be implemented to make possible the management of system resources on a per subsystem or processing engine basis, for example, based on at least two types of resource utilization indicative information: 1) resource usage that has been tracked internally throughout the life span of the overload and policy finite state machine module; and 2) resource status messages received directly or indirectly from one or more subsystems or processing engines.

This application claims priority to co-pending Provisional Application Serial No. 60/353,104 filed on Jan. 30, 2002 which is entitled “SYSTEMS AND METHODS FOR MANAGING RESOURCE UTILIZATION IN INFORMATION MANAGEMENT ENVIRONMENTS,” the disclosure of which is incorporated herein by reference. This application is also a continuation-in-part of co-pending U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS,” which itself is a continuation-in-part of co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” and which also claims priority from co-pending U.S. Provisional Application Serial No. 60/285,211 filed on Apr. 20, 2001 which is entitled “SYSTEMS AND METHODS FOR PROVIDING DIFFERENTIATED SERVICE IN A NETWORK ENVIRONMENT,” and which also claims priority from co-pending U.S. Provisional Application Serial No. 60/291,073 filed on May 15, 2001 which is entitled “SYSTEMS AND METHODS FOR PROVIDING DIFFERENTIATED SERVICE IN A NETWORK ENVIRONMENT,” and which also claims priority from U.S. Provisional Application Serial No. 60/246,401 filed on Nov. 7, 2000 which is entitled “SYSTEM AND METHOD FOR THE DETERMINISTIC DELIVERY OF DATA AND SERVICES,” and which is a continuation-in-part of co-pending U.S. patent application Ser. No. 09/797,200 filed on Mar. 1, 2001 which is entitled “SYSTEMS AND METHODS FOR THE DETERMINISTIC MANAGEMENT OF INFORMATION” which itself claims priority from U.S. Application Serial No. 60/187,211 filed on Mar. 3, 2000 which is entitled “SYSTEM AND APPARATUS FOR INCREASING FILE SERVER BANDWIDTH,” the disclosures of each being incorporated herein by reference. The above-referenced U.S. patent application Ser. No. 10/003,683 filed on Nov. 2, 2001 entitled “SYSTEMS AND METHODS FOR USING DISTRIBUTED INTERCONNECTS IN INFORMATION MANAGEMENT ENVIRONMENTS” is also a continuation-in-part of U.S. patent application Ser. No. 09/797,404 filed on Mar. 1, 2001 which is entitled “INTERPROCESS COMMUNICATIONS WITHIN A NETWORK NODE USING SWITCH FABRIC,” which itself claims priority to U.S. Provisional Application Serial No. 60/246,373 filed on Nov. 7, 2000 which is entitled “INTERPROCESS COMMUNICATIONS WITHIN A NETWORK NODE USING SWITCH FABRIC,” and which also claims priority to U.S. Provisional Application Serial No. 60/187,211 filed on Mar. 3, 2000 which is entitled “SYSTEM AND APPARATUS FOR INCREASING FILE SERVER BANDWIDTH,” the disclosures of each of the foregoing applications being incorporated herein by reference. This application is also a continuation-in-part of co-pending U.S. patent application Ser. No. 09/947,869 filed on Sep. 6, 2001 which is entitled “SYSTEMS AND METHODS FOR RESOURCE MANAGEMENT IN INFORMATION STORAGE ENVIRONMENTS,” which is a continuation-in-part of co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” and which also claims priority from co-pending U.S. Provisional Application Serial No. 60/285,211 filed on Apr. 20, 2001 which is entitled “SYSTEMS AND METHODS FOR PROVIDING DIFFERENTIATED SERVICE IN A NETWORK ENVIRONMENT,” and which also claims priority from co-pending U.S. Provisional Application Serial No. 60/291,073 filed on May 15, 2001 which is entitled “SYSTEMS AND METHODS FOR PROVIDING DIFFERENTIATED SERVICE IN A NETWORK ENVIRONMENT,” and which is a continuation-in-part of co-pending U.S. Patent Application Serial No. 09/797,198 filed on Mar. 1, 2001 which is entitled “SYSTEMS AND METHODS FOR MANAGEMENT OF MEMORY,” and which is a continuation-in-part of co-pending U.S. patent application Ser. No. 09/797,201 filed on Mar. 1, 2001 which is entitled “SYSTEMS AND METHODS FOR MANAGEMENT OF MEMORY IN INFORMATION DELIVERY ENVIRONMENTS,” and which also claims priority from U.S. Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS,” and which also claims priority from U.S. Provisional Application Serial No. 60/246,359 filed on Nov. 7, 2000 which is entitled “CACHING ALGORITHM FOR MULTIMEDIA SERVERS,” and which is a continuation-in-part of co-pending U.S. patent application Ser. No. 09/797,200 filed on Mar. 1, 2001 which is entitled “SYSTEMS AND METHODS FOR THE DETERMINISTIC MANAGEMENT OF INFORMATION” which itself claims priority from U.S. Application Serial No. 60/246,401 filed on Nov. 7, 2000 which is entitled “SYSTEM AND METHOD FOR THE DETERMINISTIC DELIVERY OF DATA AND SERVICES” and Provisional Application Serial No. 60/187,211 filed on Mar. 3, 2000 which is entitled “SYSTEM AND APPARATUS FOR INCREASING FILE SERVER BANDWIDTH,” the disclosure of each of the foregoing applications being incorporated herein by reference. This application is also a continuation-in-part of U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT,” which is incorporated herein by reference.

### BACKGROUND OF THE INVENTION

The present invention relates generally to computing systems, and more particularly to network connected computing systems.

Most network computing systems, including servers and switches, are typically provided with a number of subsystems that interact to accomplish the designated task/s of the individual computing system. Each subsystem within such a network computing system is typically provided with a number of resources that it utilizes to carry out its function. In operation, one or more of these resources may become a bottleneck as load on the computing system increases, ultimately resulting in degradation of client connection quality, severance of one or more client connections, and/or server crashes.

Network computing system bottlenecks have traditionally been dealt with by throwing more resources at the problem. For example, when performance degradation is encountered, more memory, a faster CPU (central processing unit), multiple CPU's, or more disk drives are added to the server in an attempt to alleviate the bottlenecks. Such solutions therefore typically involve spending more money to add more hardware. Besides being expensive and time consuming, the addition of hardware often only serves to push the bottleneck to a different subsystem or resource.

Issues associated with thin last mile access networks are currently being addressed by technologies such as DSL and cable modems, while overrun core networks are being improved using, for example, ultra-high speed switching/routing and wave division multiplexing technologies. However, even with the implementation of such technologies, end user expectations of service quality per device and content usage experience is often not met due to network equipment limitations encountered in the face of the total volume of network usage. Lack of network quality assurance for information management applications such as content delivery makes the implementation of mission-critical or high quality content delivery undesirable on networks such as the Internet, limiting service growth and profitability and leaving content delivery and other information management applications as thin profit commodity businesses on such networks.

Often the ultimate network bottleneck is the network server itself. For example, to maintain high-quality service for a premium customer necessarily requires that the traditional video server be under-utilized so that sufficient bandwidth is available to deliver a premium video stream without packet loss. However, to achieve efficient levels of utilization the server must handle multiple user sessions simultaneously, often including both premium and non-premium video streams. In this situation, the traditional server often becomes overloaded, and delivers all streams with equal packet loss. Thus, the premium customer has the same low quality experience as a non-premium customer.

A number of standards, protocols and techniques have been developed over the years to provide varying levels of treatment for different types of traffic on local area networks (“LANs”). These standards have been implemented at many Open System Interconnection (“OSI”) levels. For example, Ethernet has priority bits in the 802.1p/q header, and. TCP/IP has TOS bits. Presumably, switches and routers would use these bits to give higher priority to packets labeled with one set of bits, as opposed to another. RSVP is a signaling protocol that is used to reserve resources throughout the LAN (from one endpoint to another), so that bandwidth for a connection can be guaranteed. Many of these protocols have being considered for use within the Internet.

In the past, some attempts to allocate network resources and ensure service quality have relied on over provisioning of system resources, such as processing capacity. However, over provisioning is inefficient and costly. In other cases, reactive methodology has been applied that considers fixed network parameters such as bandwidth, packets and latency. One example of such a methodology is known as Asynchronous Transfer Mode (“ATM”). Such methodologies suffer from many disadvantages, including the inability to enforce resource allocation at the information management source and thus, inability to guarantee priority of information management.

### SUMMARY OF THE INVENTION

Disclosed herein are systems and methods for the deterministic management of information, such as management of the delivery of content across a network that utilizes computing systems such as servers, switches and/or routers. Among the many advantages provided by the disclosed systems and methods are increased performance and improved predictability of such computing systems in the performance of designated tasks across a wide range of loads. Examples include greater predictability in the capability of a network server, switch or router to process and manage information such as content requests, and acceleration in the delivery of information across a network utilizing such computing systems.

Deterministic embodiments of the disclosed systems and methods may be implemented to achieve substantial elimination of indeterminate application performance characteristics common with conventional information management systems, such as conventional content delivery infrastructures. For example, the disclosed systems and methods may be advantageously employed to solve unpredictability, delivery latencies, capacity planning, and other problems associated with general application serving in a computer network environment, for example, in the delivery of streaming media, data and/or services. Other advantages and benefits possible with implementation of the disclosed systems and methods include maximization of hardware resource use for delivery of content while at the same time allowing minimization of the need to add expensive hardware across all functional subsystems simultaneously to a content delivery system, and elimination of the need for an application to have intimate knowledge of the hardware it intends to employ by maintaining such knowledge in the operating system of a deterministically enabled computing component.

In one exemplary embodiment, the disclosed systems and methods may be employed with network content delivery systems to manage content delivery hardware in a manner to achieve efficient and predictable delivery of content. In another exemplary embodiment, deterministic delivery of data through a content delivery system may be implemented with end-to-end consideration of QoS priority policies within and across all components from storage disk to wide area network (WAN) interface. In yet another exemplary embodiment, delivery of content may be tied to the rate at which the content is delivered from networking components. In yet another exemplary embodiment, predictability of resource capacities may be employed to enable and facilitate implementation of processing policies. These and other benefits of the disclosed methods and systems may be achieved, for example, by incorporating intelligence into individual system components.

The disclosed systems and methods may be implemented to utilize end-to-end consideration of quality assurance parameters so as to provide scalable and practical mechanisms that allow varying levels of service to be differentially tailored or personalized for individual network users. Consideration of such quality or policy assurance parameters may be used to advantageously provide end-to-end network systems, such as end-to-end content delivery infrastructures, with network -based mechanisms that provide users with class of service (“CoS”), quality of service (“QoS”), connection admission control, etc. This ability may be used by service providers (“xSPs”) to offer their users premium information management services for premium prices. Examples of such xSPs include, but are not limited to, Internet service providers (“ISPs”), application service providers (“ASPs”), content delivery service providers (“CDSPs”), storage service providers (“SSPs”), content providers (“CPs”), Portals, etc.

Certain embodiments of the disclosed systems and methods may be advantageously employed in network computing system environments to enable differentiated service provisioning, for example, in accordance with business objectives. Examples of types of differentiated service provisioning that may be implemented include, but are not limited to, re-provisioned and real time system resource allocation and management, service, metering, billing, etc. In other embodiments disclosed herein, monitoring, tracking and/or reporting features may be implemented in network computing system environments. Advantageously, these functions may be implemented at the resource, platform subsystem, platform, and/or application levels, to fit the needs of particular network environments. In other examples, features that may be implemented include, but are not limited to, system and Service Level Agreement (SLA) performance reporting, content usage tracking and reporting (e.g., identity of content accessed, identity of user accessing the content, bandwidth at which the content is accessed, frequency and/or time of day of access to the content, processing resources used, etc.), bill generation and/or billing information reporting, etc. Advantageously, the disclosed systems and methods make possible the delivery of such differentiated information management features at the edge of a network (e.g., across single or multiple nodes), for example, by using SLA policies to control system resource allocation to service classes (e.g., packet processing, transaction/data request processing) at the network edge, etc.

In one disclosed embodiment, an information management system platform may be provided that is capable of delivering content, applications and/or services to a network with service guarantees specified through policies. Such a system platform may be advantageously employed to provide an overall network infrastructure the ability to provide differentiated services for bandwidth consumptive applications from the xSP standpoint, advantageously allowing implementation of rich media audio and video content delivery applications on such networks.

In a further embodiment disclosed herein, a separate operating system or operating system method may be provided that is inherently optimized to allow standard/traditional network-connected compute system applications (or other applications designed for traditional I/O intensive environments) to be run without modification on the disclosed systems having multi-layer asymmetrical processing architecture, although optional modifications and further optimization are possible if so desired. Examples include, but are not limited to, applications related to streaming, HTTP, storage networking (network attached storage (NAS), storage area network (SAN), combinations thereof, etc.), data base, caching, life sciences, etc.

In yet another embodiment disclosed herein, a utility-based computing process may be implemented to manage information and provide differentiated service using a process that includes provisioning of resources (e.g., based on SLA policies), tracking and logging of provisioning statistics (e.g., to measure how well SLA policies have been met), and transmission of periodic logs to a billing system (e.g., for SLA verification, future resource allocation, bill generation, etc.). Such a process may also be implemented so as to be scalable to bandwidth requirements (network (NET), compute, storage elements, etc.), may be deterministic at various system levels (below the operating system level, at the application level, at the subsystem or subscriber flow level, etc.), may be implemented across all applications hosted (HTTP, RTSP, NFS, etc.), as well as across multiple users and multiple applications, systems, and operating system configurations.

Advantageously, the scalable and deterministic aspects of certain embodiments disclosed herein may be implemented in a way so as to offer surprising and significant advantages with regard to differentiated service, while at the same time providing reduced total cost of system use, and increased performance for system cost relative to traditional computing and network systems. Further, these scalable and deterministic features may be used to provide information management systems capable of performing differentiated service functions or tasks such as service prioritization, monitoring, and reporting functions in a fixed hardware implementation platform, variable hardware implementation platform or distributed set of platforms (either full system or distributed subsystems across a network), and which may be further configured to be capable of delivering such features at the edge of a network in a manner that is network transport independent.

In one specific example, deterministic management of information may be implemented to extend network traffic management principles to achieve a true end-to-end quality experience, for example, all the way to the stored content in a content delivery system environment. For example, the disclosed systems and methods may be implemented in one embodiment to provide differentiated service functions or tasks (e.g., that may be content-aware, user-aware, application-aware, etc.) in a storage spindle-to-WAN edge router environment, and in doing so make possible the delivery of differentiated information services and/or differentiated business services.

Other embodiments disclosed herein may be implemented in an information management environment to provide active run-time enforcement of system operations, e.g., overload protection, monitoring of system and subsystem resource state, handling of known and unknown exceptions, arrival rate control, response latency differentiation based on CoS, rejection rate differentiation based on CoS, combinations thereof, etc. In one implementation, a system and method for admission control may be provided that is capable of arrival shaping and overload protection. Arrival shaping features may be implemented using, for example, CoS-based scheduling or priority queues and a variety of weighted-round-robin scheduling algorithms. Overload protection features may be implemented, for example, using a table-driven resource usage bookkeeping methodology in conjunction with a status-driven self-calibration (e.g., where resource utilization feedback information from subsystems may be used to automatically adjust the resource utilization table and thus, adjust the total capacity of a subsystem).

Using the disclosed systems and methods, active run-time enforcement of system operations may be advantageously employed to ensure the delivery of differentiated service(s) by enforcing policy-based access and delivery of system/subsystem resources in multi-tenant and/or multi-class of service environments. In this regard, the disclosed systems and methods may be implemented to monitor, predict and/or control system/subsystem run-time resource utilization values in relation to threshold resource utilization values to avoid over utilization of system/subsystem resources that may result in degradation of service quality such as may be experienced in traditional network-based QoS environments, and/or to enforce operational/allocation policies based on threshold levels. By tracking current resource utilization in relation to maximum resource utilization threshold/s, multiple tenants may be allocated available system/subsystem resources according to one or more differentiated service policies in a manner that guarantees sufficient system/subsystem resource availability to satisfy such policies without degradation of service quality. Using the disclosed systems and methods, a variety of active run-time enforcement features may be implemented including, but not limited to, differentiated service (e.g., QoS) enforcement, overload protection, resource utilization threshold enforcement, etc.

In one exemplary embodiment, resource usage accounting may be based on a unit of resource capacity measurement that quantifies or otherwise represents resource utilization to achieve a certain system or subsystem data throughput (e.g., in the case of a streaming content delivery system, a unit that characterizes a resource consumption profile for supported streaming rate spectrum). Advantageously, such a resource capacity utilization unit may be used to represent a uni-dimensional resource utilization value that is based on or derived from multiple resource utilization dimensions (e.g., multiple resource principals). Examples of resource principals that may be monitored/predicted and employed alone or in combination to determine resource utilization values include, but are not limited to, resource principals that characterize system/subsystem compute resources (e.g., processing engine CPU utilization), memory resources (e.g., total memory available, buffer pool utilization), I/O resources (e.g., bus bandwidth, media bandwidth, content media), etc. Other possible principals that may be monitored/predicted and employed to determine resource utilization values include, but are not limited to, number of current connections, number of new connections, number of dropped-out connections, loading of applications (buffers), transaction latency, number or outstanding I/O requests, disk drive utilization, etc.

One specific example of a suitable resource capacity utilization unit that may be employed in the disclosed systems and methods is referred to herein as a “str-op”. A “str-op” represents a basic unit of resources required for a given system to generate one kbps of throughput. When implemented in a system having multiple subsystems, each subsystem may be provided with its own resource measurement table (e.g., str-op table), and system resources may be managed on a per subsystem basis. In one example implementation, resources for a subsystem may be managed based on at least two types of resource utilization indicative information by an overload and policy finite state machine module: 1) resource usage that has been tracked internally throughout the life span of the overload and policy finite state machine module; and 2) resource status messages continuously arriving at the overload and policy finite state machine module from directly or indirectly the subsystem. Advantageously, this methodology may be implemented to provide intelligent admission control in a distributed processing environment that may include multiple asymmetric processing engines.

The disclosed systems and methods may be implemented to achieve system level admission control via resource utilization assessment and prediction using an overload and policy finite state machine module that is also be capable of working with other system modules. For example, an overload and policy finite state machine module of a system management processing engine may be provided that is capable of working with a resource manager (e.g., monitoring agent) of a storage processing engine, and/or monitoring agents of other processing engine/s (e.g., application processing engines) to monitor the dynamic resource state in the system. If one or more subsystems indicate heavy workloads, such an overload and policy finite state machine module may be capable of switching itself to a temporary “status-driven” load so that unexpected exceptions may be caught online in a real-time manner. Further, through global knowledge of system workload, such an overload and policy finite state machine module may also communicate system/subsystem workload-related information to, for example, a network transport processing engine, for example, to guide load balancing (e.g., traffic steering, traffic shaping) to other processing engines (e.g., application processing engines) to enhance resource utilization driven operations.

In one respect, disclosed herein is a method of performing resource usage accounting in an information management environment in which multiple information management tasks are performed. The method may include characterizing resource consumption for each of the multiple information manipulation tasks performed in the information management environment based on an individual resource utilization value that is reflective of the resource consumption required to perform each of the multiple information manipulation tasks, and may also include tracking total resource consumption to perform the multiple information manipulation tasks in the information management environment based on the individual resource utilization values.

In another respect, disclosed herein is a method of performing resource usage accounting in an information management environment in which multiple information management tasks are performed. The method may include characterizing resource consumption for each of the multiple information manipulation tasks performed in the information management environment based on an individual resource utilization value that is reflective of the resource consumption required to perform each of the multiple information manipulation tasks, and tracking total resource consumption to perform the multiple information manipulation tasks in the information management environment based on the individual resource utilization values. In this method, at least one of the individual resource utilization values may be associated with a particular information manipulation task using an association that is configurable.

In another respect, disclosed herein is a resource usage accounting system for performing resource usage accounting in an information management environment, including a resource usage accounting module.

In another respect, disclosed herein is a network connectable information management system, including a plurality of multiple processing engines coupled together by a distributed interconnect, and a resource usage accounting system coupled to the multiple processing engines via the distributed interconnect. In this system, the resource usage accounting system may include a resource usage accounting module configured to track workload within the information management system.

In another respect, disclosed herein is a method of performing run-time enforcement of system operations in an information management environment in which multiple information management tasks are performed. This method may include monitoring resource consumption for each of the multiple information manipulation tasks performed in the information management environment based on an individual resource utilization value that is reflective of the resource consumption required to perform each of the multiple information manipulation tasks, tracking total resource consumption to perform the multiple information manipulation tasks in the information management environment based on the individual resource utilization values, and controlling the total resource consumption to avoid over utilization of one or more resources within the information management environment.

In another respect, disclosed herein is a method of enforcing differentiated service in an information management environment in which multiple information management tasks are performed, including performing resource usage accounting in the information management environment; and enforcing the differentiated service with respect to the performance of at least one of the information management tasks based at least in part on the resource usage accounting.

In another respect, disclosed herein is a determinism module for use in an information management environment, including an overload and policy finite state machine module and a resource usage accounting module.

In another respect, disclosed herein is a network connectable information management system, including a plurality of multiple processing engines coupled together by a distributed interconnect, and a determinism module coupled to the multiple processing engines via the distributed interconnect.

### BRIEF DESCRIPTION OF THE DRAWINGS

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C is a simplified schematic diagram showing one possible network content delivery system hardware configuration.

FIG. 1D is a simplified schematic diagram showing a network content delivery engine configuration possible with the network content delivery system hardware configuration of FIG. 1C.

FIG. 1E is a simplified schematic diagram showing an alternate network content delivery engine configuration possible with the network content delivery system hardware configuration of FIG. 1C.

FIG. 1F is a simplified schematic diagram showing another alternate network content delivery engine configuration possible with the network content delivery system hardware configuration of FIG. 1C.

FIGS. 1G-1J illustrate exemplary clusters of network content delivery systems.

FIG. 2 is a simplified schematic diagram showing another possible network content delivery system configuration.

FIG. 2A is a simplified schematic diagram showing a network endpoint computing system.

FIG. 2B is a simplified schematic diagram showing a network endpoint computing system.

FIG. 3 is a functional block diagram of an exemplary network processor.

FIG. 4 is a functional block diagram of an exemplary interface between a switch fabric and a processor.

FIG. 5 is a flow chart illustrating a method for the deterministic delivery of content according to one embodiment of the present invention.

FIG. 6 is a simplified schematic diagram illustrating a data center operable to perform deterministic delivery of content according to one embodiment of the present invention.

FIG. 7 is a simplified representation illustrating interrelation of various functional components of an information management system and method for delivering differentiated service according to one embodiment of the present invention.

FIG. 8 is a flow chart illustrating a method of providing differentiated service based on defined business objectives according to one embodiment of the present invention.

FIG. 9A is a simplified representation illustrating an endpoint information management node and data center connected to a network according to one embodiment of the disclosed content delivery system.

FIG. 9B is a simplified representation illustrating a traffic management node connected to a network according to one embodiment of the disclosed content delivery system.

FIG. 9C is a simplified representation of multiple edge content delivery nodes connected to a network according to one embodiment of the disclosed content delivery system.

FIG. 9D is a representation of components of an information management system interconnected across a network according to one embodiment of the disclosed content delivery system.

FIG. 10 is a flow chart illustrating a method of administering admission control according to one embodiment of the disclosed systems and methods.

FIG. 11A is a representation of processing module components that may be employed to implement the admission control policy of FIG. 10, according to one embodiment of the disclosed systems and methods.

FIG. 11B is a simplified representation of components of a content delivery system according to one embodiment of the disclosed systems and methods.

FIG. 11C is a simplified representation of interrelated functionalities that may be advantageously implemented using an overload and policy finite state machine module according to one embodiment of the disclosed systems and methods.

FIG. 12 illustrates available bandwidth as a function of average stream rate according to Example 4.

FIG. 13 illustrates number of streams as a function of stream rates according to Example 4.

FIG. 14 illustrates number of str-op resource capacity utilization units per stream as a function of stream rates according to Example 4.

FIG. 15 illustrates number of str-op resource capacity utilization units as a function of stream data rate according to Example 5.

FIG. 16 illustrates number of str-op resource capacity utilization units as a function of stream data rate according to Example 5.

FIG. 17 illustrates number of str-op resource capacity utilization units as a function of stream data rate according to Example 5.

FIG. 18 is a representation of a finite state machine for status management according to one embodiment of the disclosed systems and methods described in Example 8.

FIG. 19 is a flow chart illustrating a method for admission control using resource utilization value quantification according to one embodiment of the present invention.

### DESCRIPTION OF ILLUSTRATIVE EMBODIMENTS

Disclosed herein are systems and methods for operating network connected computing systems. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the present invention are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clients via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multi-processor system configured in a staged pipeline manner.

EXEMPLARY SYSTEM OVERVIEW

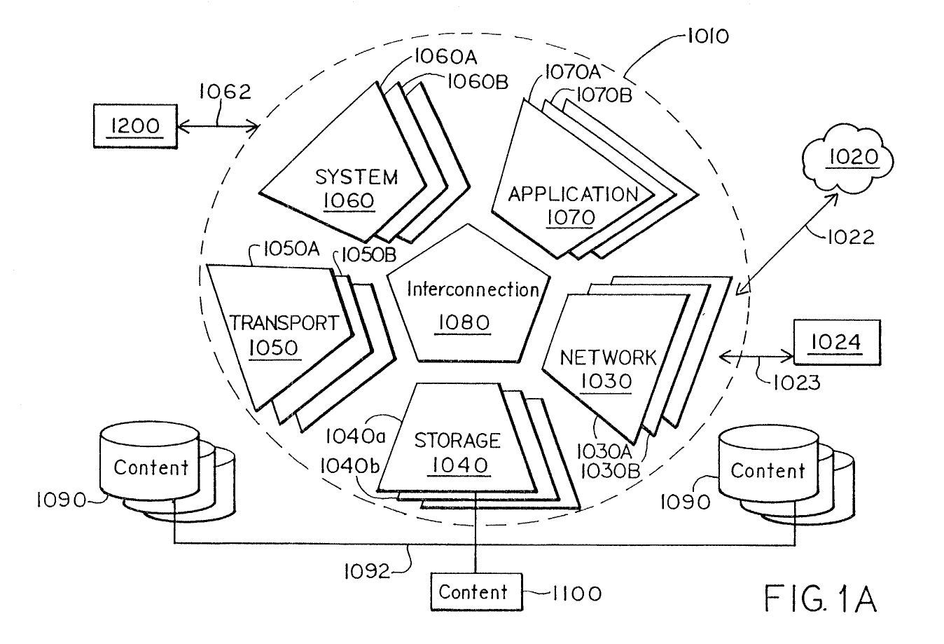

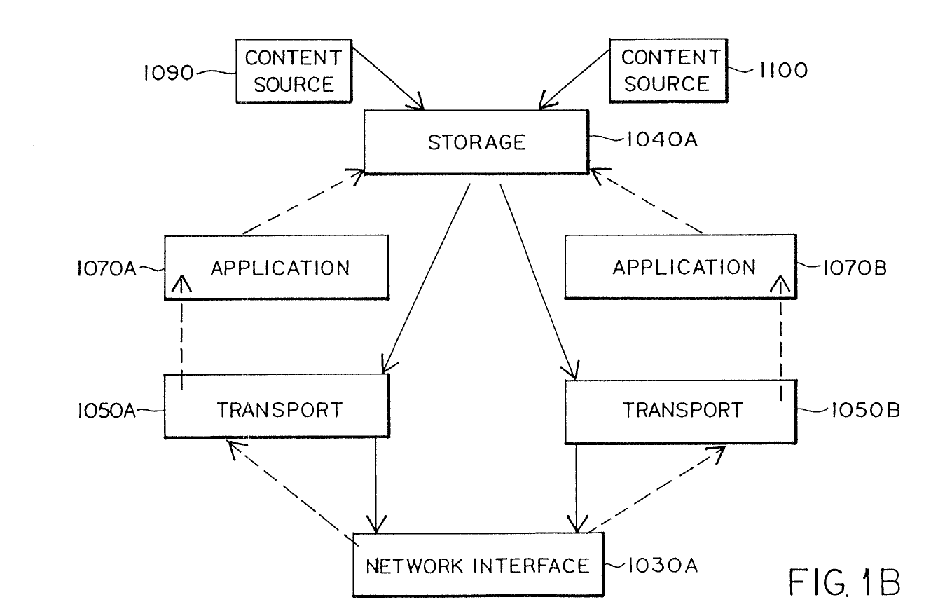

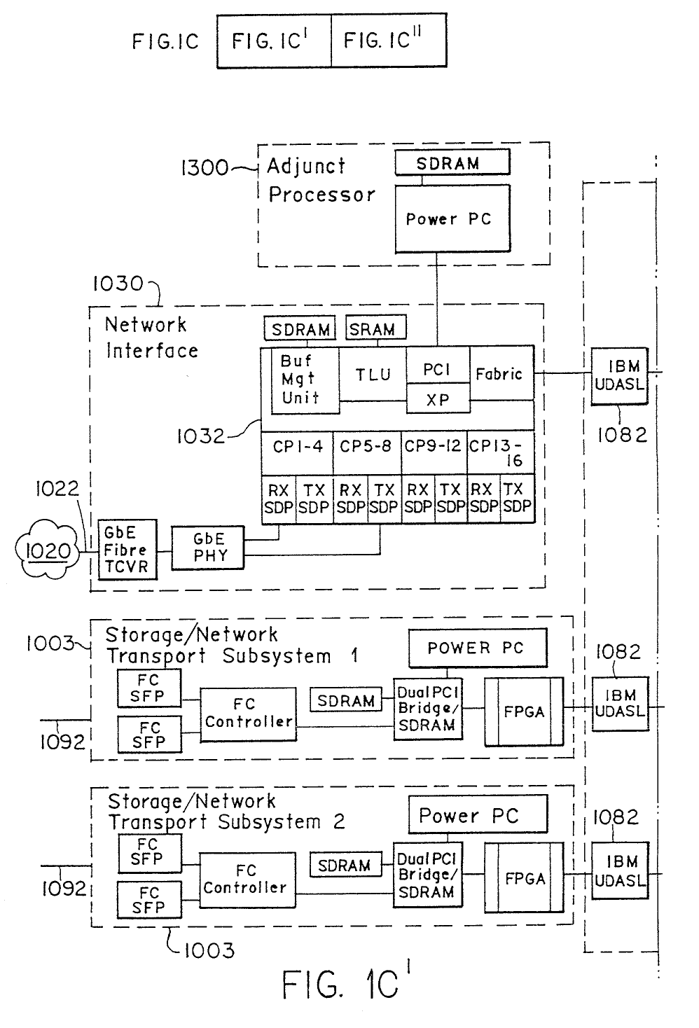

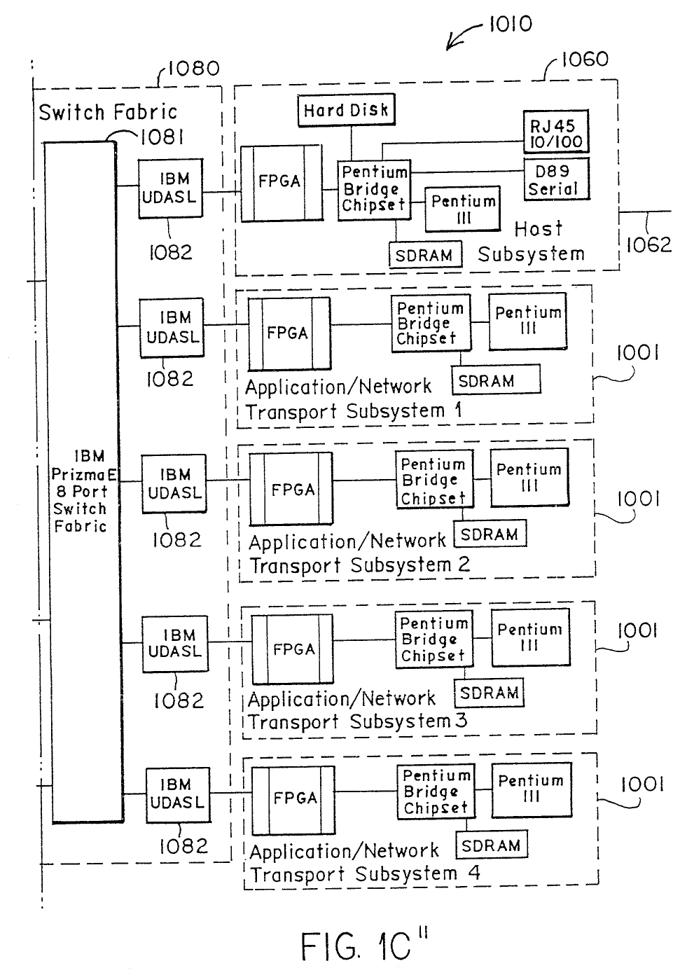

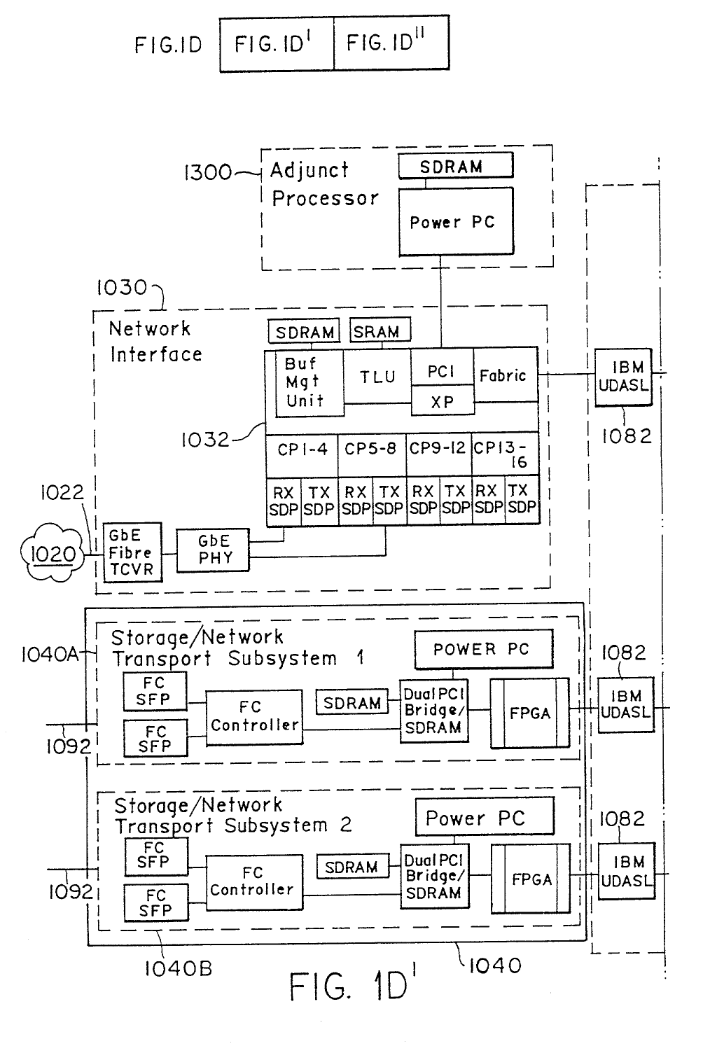

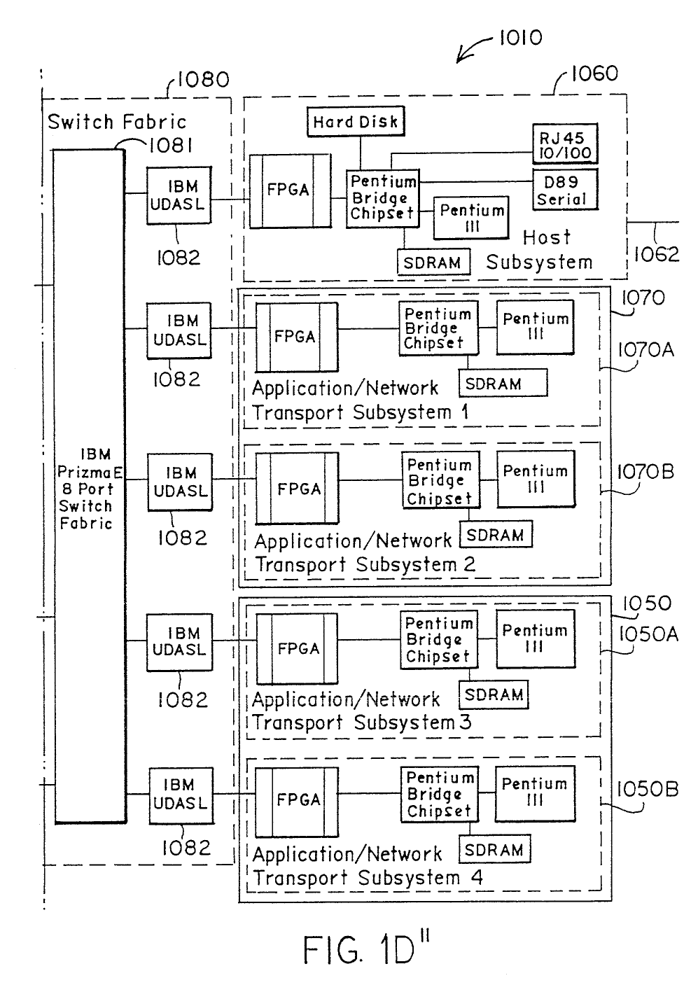

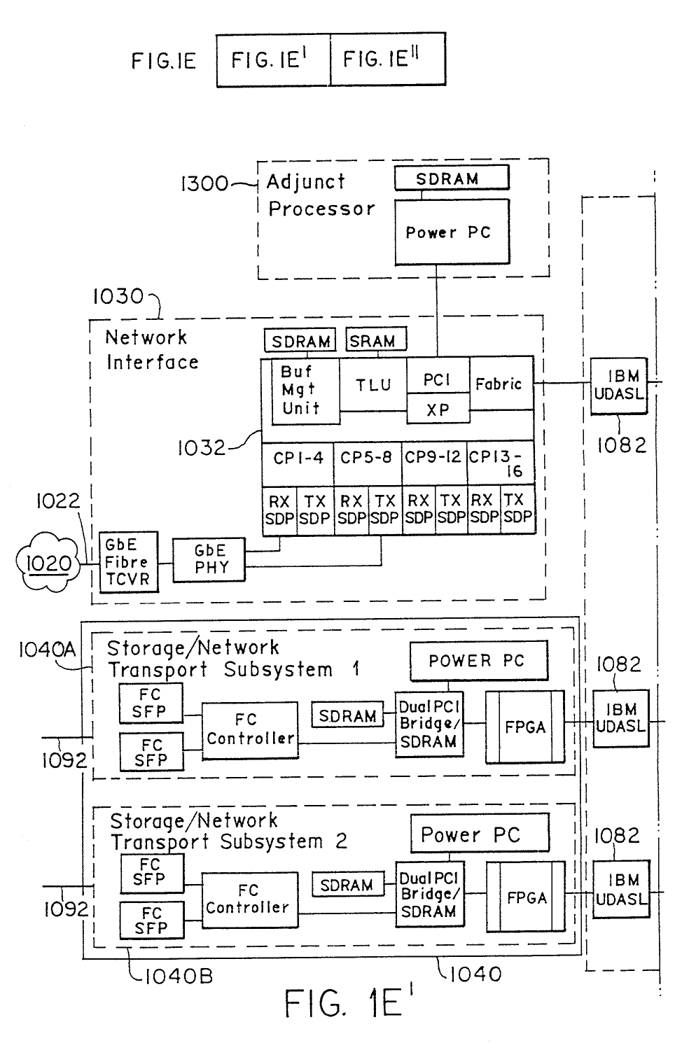

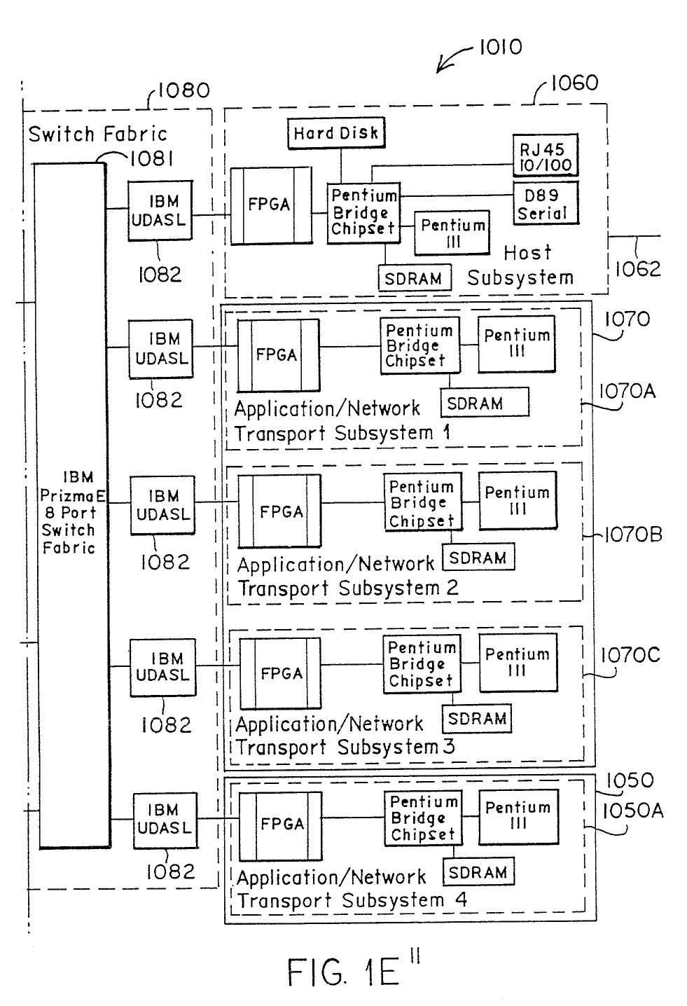

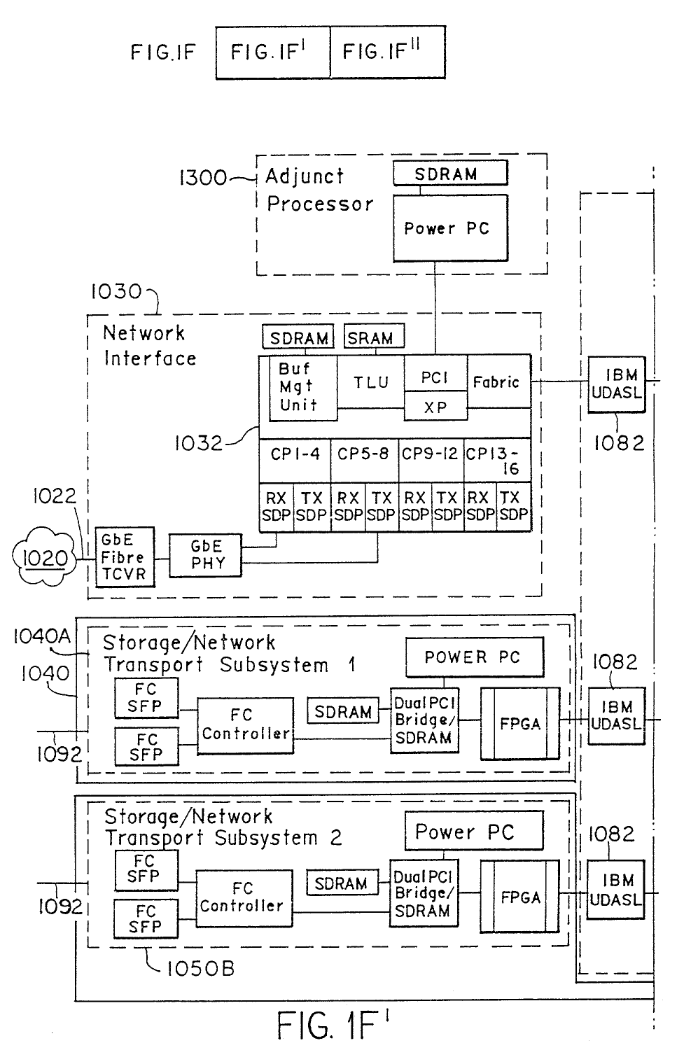

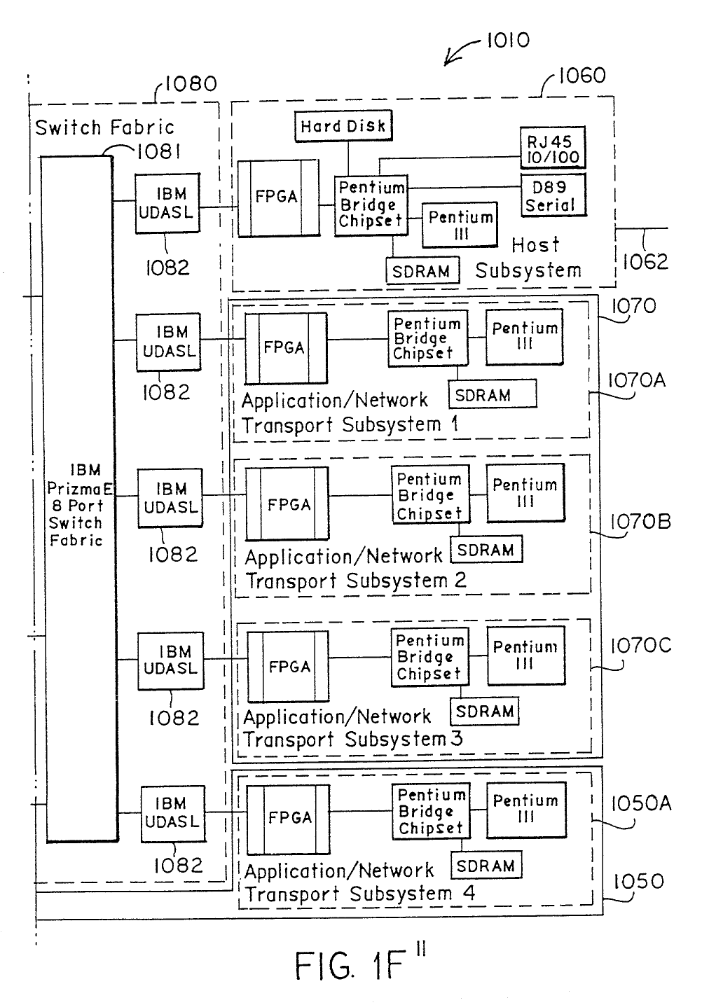

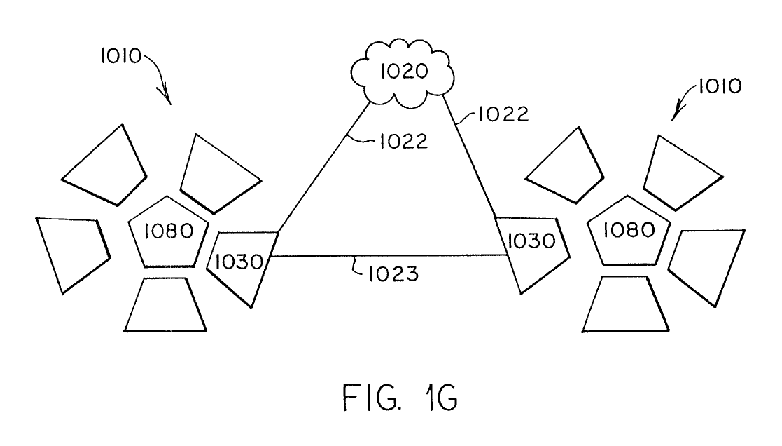

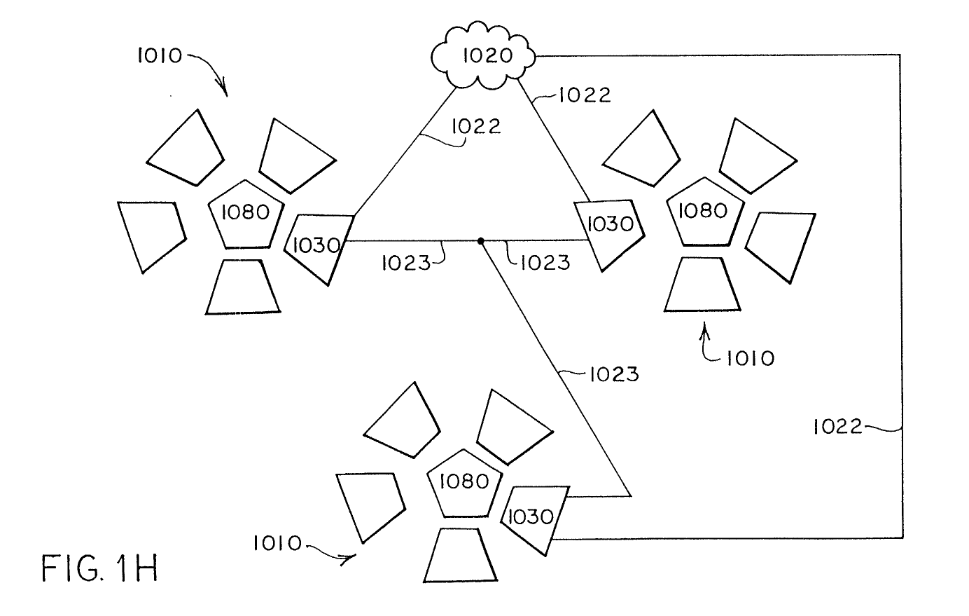

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such sub-tasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the x86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

DISTRIBUTIVE INTERCONNECT

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multi-server endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an as-needed basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

NETWORK INTERFACE PROCESSING ENGINE

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Internet Protocol (IP), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, offloading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following U.S. patent applications: Ser. No. 09/797,412, filed Mar. 1, 2001 and entitled “Network Transport Accelerator,” by Bailey et. al; Ser. No. 09/797,507 filed Mar. 1, 2001 and entitled “Single Chassis Network Endpoint System With Network Processor For Load Balancing,” by Richter et. al; and Ser. No. 09/797,411 filed Mar. 1, 2001 and entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in U.S. patent application Ser. No. 09/797,197, filed Mar. 1, 2001 and entitled “Methods and Systems For The Order Serialization Of Information In A Network Processing Environment,” by Richter et. al, the disclosure of which is incorporated herein by reference.

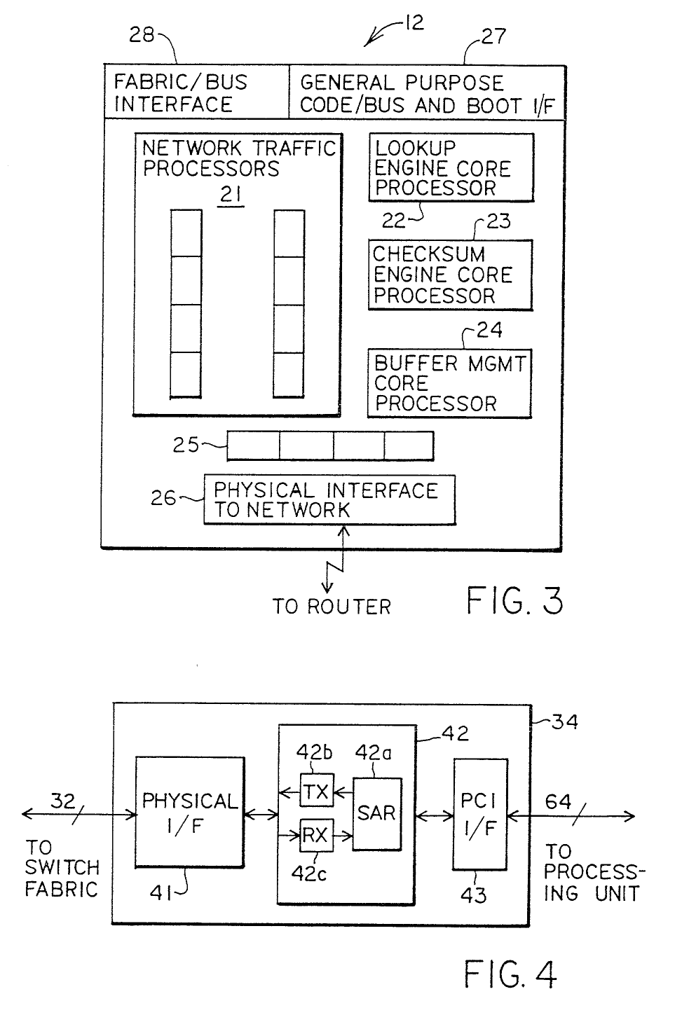

FIG. 3 illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five co-processors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection.

TRANSPORT/PROTOCOL PROCESSING ENGINE

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/UDP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, session management, data reordering and retransmission, data queuing and flow control, packet header generation, etc. off-loading these tasks from the application processing engine or the network interface processing engine. The transport processing engine 1050 may also handle error checking, likewise freeing up the resources of other processing engines.

NETWORK INTERFACE/TRANSPORT SPLIT PROTOCOL

The embodiment of FIG. 1 A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 2-5) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier label or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

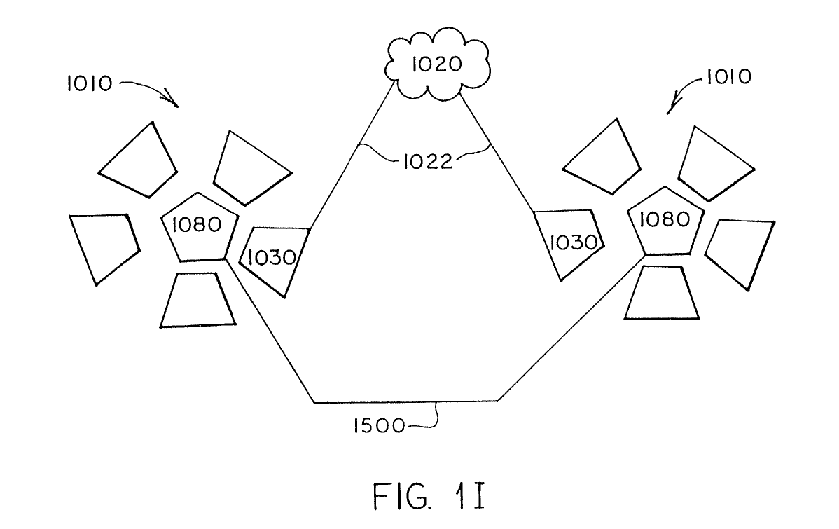

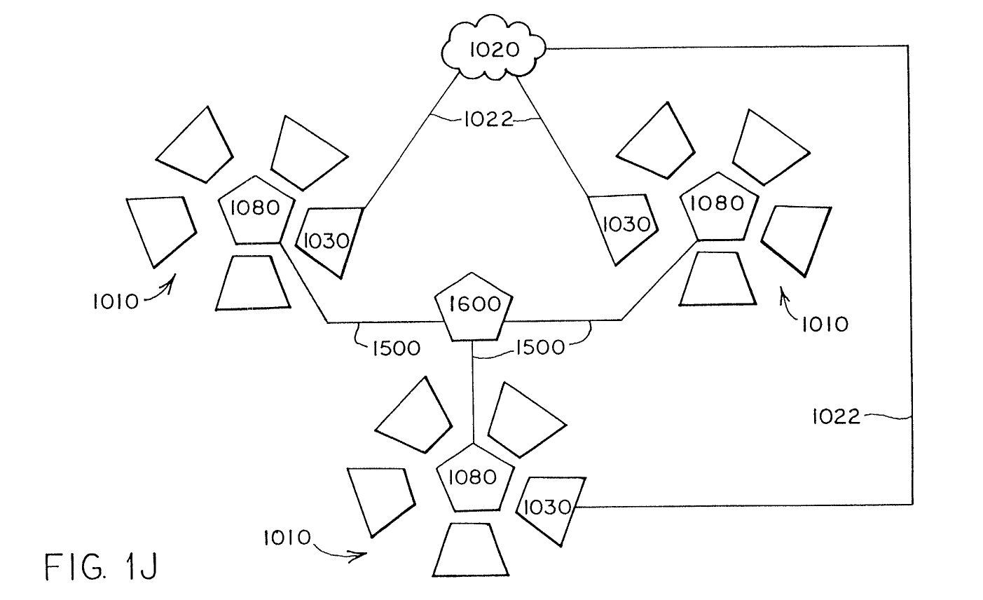

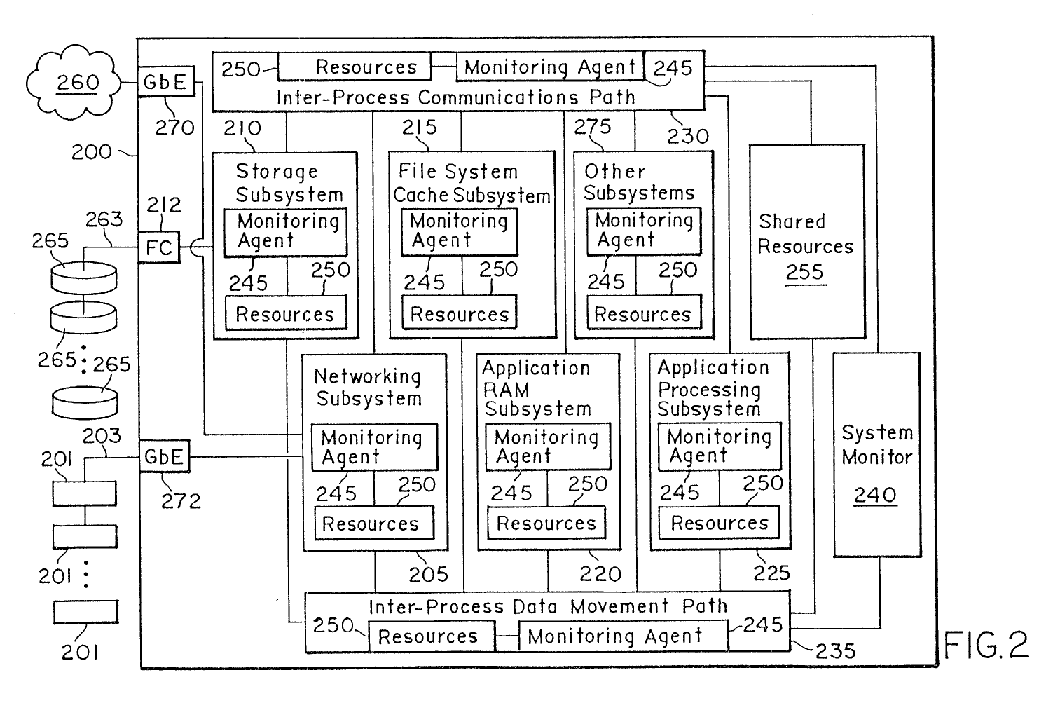

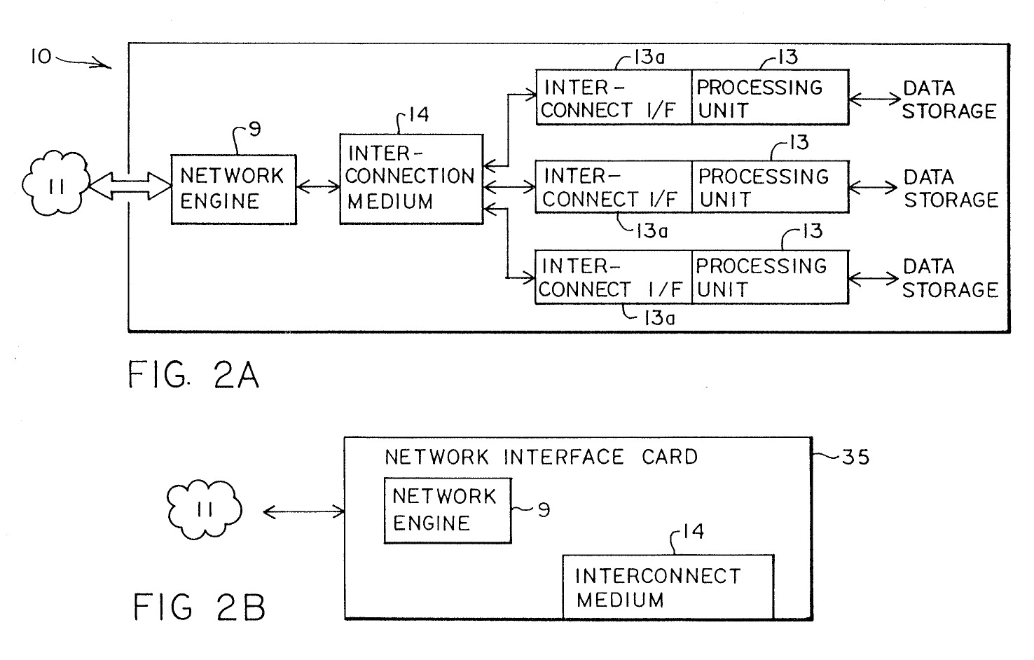

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

APPLICATION PROCESSING ENGINE

Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. In one embodiment application processing engine 1070 may be a dedicated application processing module based on an INTEL PENTIUM III processor running, for example, on standard x86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

STORAGE MANAGEMENT ENGINE

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in U.S. patent application Ser. No. 09/797,198, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in U.S. patent application Ser. No. 09/797,201, filed Mar. 1, 2001 and entitled “Systems and Methods for Management of Memory in Information Delivery Environments” by Qiu et. al, the disclosure of which is incorporated herein by reference.

SYSTEM MANAGEMENT ENGINE

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an x86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

MANAGEMENT PERFORMED BY THE NETWORK INTERFACE

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, full, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface offloads such functions from the other processing modules and improves system performance by limiting the consumption of system resources by the undesirable traffic. It will be recognized that the filtering example described herein is merely exemplary and many other filter criteria or policies may be provided.

MULTI-PROCESSOR MODULE DESIGN

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic failover spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1040a may be specially programmed for processing a first type of request received from a network. In the same system, application processing module 1070b and storage processing module 1040b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance. CLUSTERS OF SYSTEMS

The systems described herein may also be clustered together in groups of two or more to provide additional processing power, storage connections, bandwidth, etc. Communication between two individual systems each configured similar to content delivery system 1010 may be made through network interface 1022 and/or 1023. Thus, one content delivery system could communicate with another content delivery system through the network 1020 and/or 1024. For example, a storage unit in one content delivery system could send data to a network interface engine of another content delivery system. As an example, these communications could be via TCP/IP protocols. Alternatively, the distributed interconnects 1080 of two content delivery systems 1010 may communicate directly. For example, a connection may be made directly between two switch fabrics, each switch fabric being the distributed interconnect 1080 of separate content delivery systems 1010.

FIGS. 1G-1J illustrate four exemplary clusters of content delivery systems 1010. It will be recognized that many other cluster arrangements may be utilized including more or less content delivery systems. As shown in FIGS. 1G-1J, each content delivery system may be configured as described above and include a distributive interconnect 1080 and a network interface processing engine 1030. Interfaces 1022 may connect the systems to a network 1020. As shown in FIG. 1G, two content delivery systems may be coupled together through the interface 1023 that is connected to each system's network interface processing engine 1030. FIG. 1H shows three systems coupled together as in FIG. 1G. The interfaces 1023 of each system may be coupled directly together as shown, may be coupled together through a network or may be coupled through a distributed interconnect (for example a switch fabric).

FIG. 1I illustrates a cluster in which the distributed interconnects 1080 of two systems are directly coupled together through an interface 1500. Interface 1500 may be any communication connection, such as a copper connection, optical fiber, wireless connection, etc. Thus, the distributed interconnects of two or more systems may directly communicate without communication through the processor engines of the content delivery systems 1010. FIG. 1J illustrates the distributed interconnects of three systems directly communicating without first requiring communication through the processor engines of the content delivery systems 1010. As shown in FIG. 1J, the interfaces 1500 each communicate with each other through another distributed interconnect 1600. Distributed interconnect 1600 may be a switched fabric or any other distributed interconnect.

The clustering techniques described herein may also be implemented through the use of the management interface 1062. Thus, communication between multiple content delivery systems 1010 also may be achieved through the management interface 1062.

EXEMPLARY DATA AND COMMUNICATION FLOW PATHS

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, inter-processor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass network application processing modules 1070a and 1070b. The requested content may then be transferred via the network interface processing module 1030a to the external network 1020. Benefits of bypassing the application processing modules with the delivered content include accelerated delivery of the requested content and offloading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately re-broadcast over interface connection 1022 to the network 1020. Alternatively, content may be proceed through the network interface connection 1023 to the network transport engine 1050 prior to returning to the network interface engine 1030 for re-broadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 1100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1040 directly to the network interface processing engine 1030 as described with reference to FIG. 1B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Lightening I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

CONTENT DELIVERY ACCELERATION

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to freeze or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

EXEMPLARY HARDWARE EMBODIMENTS

FIGS. 1C-1F illustrate just a few of the many multiple network content delivery engine configurations possible with one exemplary hardware embodiment of content delivery system 1010. In each illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. 1C. These fabric interfaces provide a 64/66 Mhz PCI interface to the interface converter circuits 1082. FIG. 4 illustrates a functional block diagram of such a fabric interface 34. As explained below, the interface 34 provides an interface between the processor module bus and the UDASL switch interface converter circuit 1082. As shown in FIG. 4, at the switch fabric side, a physical connection interface 41 provides connectivity at the physical level to the switch fabric. An example of interface 41 is a parallel bus interface complying with the UTOPIA standard. In the example of FIG. 4, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 4, SAR (segmentation and reassembly) unit 42 has appropriate SAR logic 42a for performing segmentation and reassembly tasks for converting messages to fabric cells and vice-versa as well as message classification and message class-to-queue routing, using memory 42b and 42c for transmit and receive queues. This permits different classes of messages and permits the classes to have different priority. For example, control messages can be classified separately from data messages, and given a different priority. All fabric cells and the associated messages may be self routing, and no out of band signaling is required.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. IC, the network processor 1032 also may be coupled to the network 1020 by using a VITESSE GbE SERDES (serializer-deserializer) device (for example the VSC7123) and SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2GBaud fibre channel controller. The fibre channel controller enables communication with the fibre channel 1092 when the processor module 1003 is utilized as a storage processing engine 1040. Also illustrated in FIGS. 1C-1F is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIGS. 1C-1F, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

The processor modules 1001 and 1003 of FIG. 1C may be configured in alternative manners to implement the content delivery processing engines such as the network interface processing engine 1030, storage processing engine 1040, transport processing engine 1050, system management processing engine 1060, and application processing engine 1070. Exemplary configurations are shown in FIGS. 1D-1F, however, it will be recognized that other configurations may be utilized.

As shown in FIG. 1D, two Pentium III based processing modules may be utilized as network application processing modules 1070a and 1070b of network application processing engine 1070. The remaining two Pentium III-based processing modules are shown in FIG. 1D configured as network transport/protocol processing modules 1050a and 1050b of network transport/protocol processing engine 1050. The embodiment of FIG. 1D also includes two POWER PC-based processor modules, configured as storage management processing modules 1040a and 1040b of storage management processing engine 1040. A single MOTOROLA C-Port C-5 based network processor is shown employed as network interface processing engine 1030, and a single Pentium III-based processing module is shown employed as system management processing engine 1060.

In FIG. 1E, the same hardware embodiment of FIG. 1C is shown alternatively configured so that three Pentium III-based processing modules function as network application processing modules 1070a, 1070b and 1070c of network application processing engine 1070, and so that the sole remaining Pentium III-based processing module is configured as a network transport processing module 1050a of network transport processing engine 1050. As shown, the remaining processing modules are configured as in FIG. 1D.

In FIG. 1F, the same hardware embodiment of FIG. 1C is shown in yet another alternate configuration so that three Pentium III-based processing modules function as application processing modules 1070a, 1070b and 1070c of network application processing engine 1070. In addition, the network transport processing engine 1050 includes one Pentium III-based processing module that is configured as network transport processing module 1050a, and one POWER PC-based processing module that is configured as network transport processing module 1050b. The remaining POWER PC-based processor module is configured as storage management processing module 1040a of storage management processing engine 1040.

It will be understood with benefit of this disclosure that the hardware embodiment and multiple engine configurations thereof illustrated in FIGS. 1C-1F are exemplary only, and that other hardware embodiments and engine configurations thereof are also possible. It will further be understood that in addition to changing the assignments of individual processing modules to particular processing engines, distributive interconnect 1080 enables the various processing flow paths between individual modules employed in a particular engine configuration in a manner as described in relation to FIG. 1B. Thus, for any given hardware embodiment and processing engine configuration, a number of different processing flow paths may be employed so as to optimize system performance to suit the needs of particular system applications.

SINGLE CHASSIS DESIGN

As mentioned above, the content delivery system 1010 may be implemented within a single chassis, such as for example, a 2U chassis. The system may be expanded further while still remaining a single chassis system. In particular, utilizing a multiple processor module or blade arrangement connected through a distributive interconnect (for example a switch fabric) provides a system that is easily scalable. The chassis and interconnect may be configured with expansion slots provided for adding additional processor modules. Additional processor modules may be provided to implement additional applications within the same chassis. Alternatively, additional processor modules may be provided to scale the bandwidth of the network connection. Thus, though describe with respect to a 1 Gbps Ethernet connection to the external network, a 10 Gbps, 40 Gbps or more connection may be established by the system through the use of more network interface modules. Further, additional processor modules may be added to address a system's particular bottlenecks without having to expand all engines of the system. The additional modules may be added during a systems initial configuration, as an upgrade during system maintenance or even hot plugged during system operation.

ALTERNATIVE SYSTEMS CONFIGURATIONS

Further, the network endpoint system techniques disclosed herein may be implemented in a variety of alternative configurations that incorporate some, but not necessarily all, of the concepts disclosed herein. For example, FIGS. 2 and 2A disclose two exemplary alternative configurations. It will be recognized, however, that many other alternative configurations may be utilized while still gaining the benefits of the inventions disclosed herein.

FIG. 2 is a more generalized and functional representation of a content delivery system showing how such a system may be alternately configured to have one or more of the features of the content delivery system embodiments illustrated in FIGS. 1A-1F. FIG. 2 shows content delivery system 200 coupled to network 260 from which content requests are received and to which content is delivered. Content sources 265 are shown coupled to content delivery system 200 via a content delivery flow path 263 that may be, for example, a storage area network that links multiple content sources 265. A flow path 203 may be provided to network connection 272, for example, to couple content delivery system 200 with other network appliances, in this case one or more servers 201 as illustrated in FIG. 2.

In FIG. 2 content delivery system 200 is configured with multiple processing and memory modules that are distributively interconnected by inter-process communications path 230 and inter-process data movement path 235. Inter-process communications path 230 is provided for receiving and distributing inter-processor command communications between the modules and network 260, and interprocess data movement path 235 is provided for receiving and distributing inter-processor data among the separate modules. As illustrated in FIGS. 1A-1F, the functions of inter-process communications path 230 and inter-process data movement path 235 may be together handled by a single distributive interconnect 1080 (such as a switch fabric, for example), however, it is also possible to separate the communications and data paths as illustrated in FIG. 2, for example using other interconnect technology.

FIG. 2 illustrates a single networking subsystem processor module 205 that is provided to perform the combined functions of network interface processing engine 1030 and transport processing engine 1050 of FIG. 1A. Communication and content delivery between network 260 and networking subsystem processor module 205 are made through network connection 270. For certain applications, the functions of network interface processing engine 1030 and transport processing engine 1050 of FIG. 1A may be so combined into a single module 205 of FIG. 2 in order to reduce the level of communication and data traffic handled by communications path 230 and data movement path 235 (or single switch fabric), without adversely impacting the resources of application processing engine or subsystem module. If such a modification were made to the system of FIG. 1A, content requests may be passed directly from the combined interface/transport engine to network application processing engine 1070 via distributive interconnect 1080. Thus, as previously described the functions of two or more separate content delivery system engines may be combined as desired (e.g., in a single module or in multiple modules of a single processing blade), for example, to achieve advantages in efficiency or cost.

In the embodiment of FIG. 2, the function of network application processing engine 1070 of FIG. 1A is performed by application processing subsystem module 225 of FIG. 2 in conjunction with application RAM subsystem module 220 of FIG. 2. System monitor module 240 communicates with server/s 201 through flow path 203 and Gb Ethernet network interface connection 272 as also shown in FIG. 2. The system monitor module 240 may provide the function of the system management engine 1060 of FIG. 1A and/or other system policy/filter functions such as may also be implemented in the network interface processing engine 1030 as described above with reference to FIG. 1A.

Similarly, the function of network storage management engine 1040 is performed by storage subsystem module 210 in conjunction with file system cache subsystem module 215. Communication and content delivery between content sources 265 and storage subsystem module 210 are shown made directly through content delivery flowpath 263 through fibre channel interface connection 212. Shared resources subsystem module 255 is shown provided for access by each of the other subsystem modules and may include, for example, additional processing resources, additional memory resources such as RAM, etc.

Additional processing engine capability (e.g., additional system management processing capability, additional application processing capability, additional storage processing capability, encryption/decryption processing capability, compression/decompression processing capability, encoding/decoding capability, other processing capability, etc.) may be provided as desired and is represented by other subsystem module 275. Thus, as previously described the functions of a single network processing engine may be sub-divided between separate modules that are distributively interconnected. The sub-division of network processing engine tasks may also be made for reasons of efficiency or cost, and/or may be taken advantage of to allow resources (e.g., memory or processing) to be shared among separate modules. Further, additional shared resources may be made available to one or more separate modules as desired.

Also illustrated in FIG. 2 are optional monitoring agents 245 and resources 250. In the embodiment of FIG. 2, each monitoring agent 245 may be provided to monitor the resources 250 of its respective processing subsystem module, and may track utilization of these resources both within the overall system 200 and within its respective processing subsystem module. Examples of resources that may be so monitored and tracked include, but are not limited to, processing engine bandwidth, Fibre Channel bandwidth, number of available drives, IOPS (input/output operations per second) per drive and RAID (redundant array of inexpensive discs) levels of storage devices, memory available for caching blocks of data, table lookup engine bandwidth, availability of RAM for connection control structures and outbound network bandwidth availability, shared resources (such as RAM) used by streaming application on a per-stream basis as well as for use with connection control structures and buffers, bandwidth available for message passing between subsystems, bandwidth available for passing data between the various subsystems, etc.

Information gathered by monitoring agents 245 may be employed for a wide variety of purposes including for billing of individual content suppliers and/or users for pro-rata use of one or more resources, resource use analysis and optimization, resource health alarms, etc. In addition, monitoring agents may be employed to enable the deterministic delivery of content by system 200 as described further herein.

In operation, content delivery system 200 of FIG. 2 may be configured to wait for a request for content or services prior to initiating content delivery or performing a service. A request for content, such as a request for access to data, may include, for example, a request to start a video stream, a request for stored data, etc. A request for services may include, for example, a request for to run an application, to store a file, etc. A request for content or services may be received from a variety of sources. For example, if content delivery system 200 is employed as a stream server, a request for content may be received from a client system attached to a computer network or communication network such as the Internet. In a larger system environment, e.g., a data center, a request for content or services may be received from a separate subcomponent or a system management processing engine, that is responsible for performance of the overall system or from a sub-component that is unable to process the current request. Similarly, a request for content or services may be received by a variety of components of the receiving system. For example, if the receiving system is a stream server, networking subsystem processor module 205 might receive a content request. Alternatively, if the receiving system is a component of a larger system, e.g., a data center, system management processing engine may be employed to receive the request.

Upon receipt of a request for content or services, the request may be filtered by system monitor 240. Such filtering may serve as a screening agent to filter out requests that the receiving system is not capable of processing (e.g., requests for file writes from read-only system embodiments, unsupported protocols, content/services unavailable on system 200, etc.). Such requests may be rejected outright and the requestor notified, may be re-directed to a server 201 or other content delivery system 200 capable of handling the request, or may be disposed of any other desired manner.

Referring now in more detail to one embodiment of FIG. 2 as may be employed in a stream server configuration, networking processing subsystem module 205 may include the hardware and/or software used to run TCP/IP (Transmission Control Protocol/Internet Protocol), UDP/IP (User Datagram Protocol/Internet Protocol), RTP (Real-Time Transport Protocol), Internet Protocol (IP), Wireless Application Protocol (WAP) as well as other networking protocols. Network interface connections 270 and 272 may be considered part of networking subsystem processing module 205 or as separate components. Storage subsystem module 210 may include hardware and/or software for running the Fibre Channel (FC) protocol, the SCSI (Small Computer Systems Interface) protocol, iSCSI protocol as well as other storage networking protocols. FC interface 212 to content delivery flowpath 263 may be considered part of storage subsystem module 210 or as a separate component. File system cache subsystem module 215 may include, in addition to cache hardware, one or more cache management algorithms as well as other software routines.

Application RAM subsystem module 220 may function as a memory allocation subsystem and application processing subsystem module 225 may function as a stream-serving application processor bandwidth subsystem. Among other services, application RAM subsystem module 220 and application processing subsystem module 225 may be used to facilitate such services as the pulling of content from storage and/or cache, the formatting of content into RTSP (Real-Time Streaming Protocol) or another streaming protocol as well the passing of the formatted content to networking subsystem 205.

As previously described, system monitor module 240 may be included in content delivery system 200 to manage one or more of the subsystem processing modules, and may also be used to facilitate communication between the modules.

In part to allow communications between the various subsystem modules of content delivery system 200, inter-process communication path 230 may be included in content delivery system 200, and may be provided with its own monitoring agent 245. Inter-process communications path 230 may be a reliable protocol path employing a reliable IPC (Inter-process Communications) protocol. To allow data or information to be passed between the various subsystem modules of content delivery system 200, inter-process data movement path 235 may also be included in content delivery system 200, and may be provided with its own monitoring agent 245. As previously described, the functions of inter-process communications path 230 and inter-process data movement path 235 may be together handled by a single distributive interconnect 1080, that may be a switch fabric configured to support the bandwidth of content being served.

In one embodiment, access to content source 265 may be provided via a content delivery flow path 263 that is a fibre channel storage area network (SAN), a switched technology. In addition, network connectivity may be provided at network connection 270 (e.g., to a front end network) and/or at network connection 272 (e.g., to a back end network) via switched gigabit Ethernet in conjunction with the switch fabric internal communication system of content delivery system 200. As such, that the architecture illustrated in FIG. 2 may be generally characterized as equivalent to a networking system.

One or more shared resources subsystem modules 255 may also be included in a stream server embodiment of content delivery system 200, for sharing by one or more of the other subsystem modules. Shared resources subsystem module 255 may be monitored by the monitoring agents 245 of each subsystem sharing the resources. The monitoring agents 245 of each subsystem module may also be capable of tracking usage of shared resources 255. As previously described, shared resources may include RAM (Random Access Memory) as well as other types of shared resources.

Each monitoring agent 245 may be present to monitor one or more of the resources 250 of its subsystem processing module as well as the utilization of those resources both within the overall system and within the respective subsystem processing module. For example, monitoring agent 245 of storage subsystem module 210 may be configured to monitor and track usage of such resources as processing engine bandwidth, Fibre Channel bandwidth to content delivery flow path 263, number of storage drives attached, number of input/output operations per second (IOPS) per drive and RAID levels of storage devices that may be employed as content sources 265. Monitoring agent 245 of file system cache subsystem module 215 may be employed monitor and track usage of such resources as processing engine bandwidth and memory employed for caching blocks of data. Monitoring agent 245 of networking subsystem processing module 205 may be employed to monitor and track usage of such resources as processing engine bandwidth, table lookup engine bandwidth, RAM employed for connection control structures and outbound network bandwidth availability. Monitoring agent 245 of application processing subsystem module 225 may be employed to monitor and track usage of processing engine bandwidth. Monitoring agent 245 of application RAM subsystem module 220 may be employed to monitor and track usage of shared resource 255, such as RAM, which may be employed by a streaming application on a per-stream basis as well as for use with connection control structures and buffers. Monitoring agent 245 of inter-process communication path 230 may be employed to monitor and track usage of such resources as the bandwidth used for message passing between subsystems while monitoring agent 245 of inter-process data movement path 235 may be employed to monitor and track usage of bandwidth employed for passing data between the various subsystem modules.

The discussion concerning FIG. 2 above has generally been oriented towards a system designed to deliver streaming content to a network such as the Internet using, for example, Real Networks, Quick Time or Microsoft Windows Media streaming formats. However, the disclosed systems and methods may be deployed in any other type of system operable to deliver content, for example, in web serving or file serving system environments. In such environments, the principles may generally remain the same. However for application processing embodiments, some differences may exist in the protocols used to communicate and the method by which data delivery is metered (via streaming protocol, versus TCP/IP windowing).

FIG. 2A illustrates an even more generalized network endpoint computing system that may incorporate at least some of the concepts disclosed herein. As shown in FIG. 2A, a network endpoint system 10 may be coupled to an external network 11. The external network 11 may include a network switch or router coupled to the front end of the endpoint system 10. The endpoint system 10 may be alternatively coupled to some other intermediate network node of the external network. The system 10 may further include a network engine 9 coupled to an interconnect medium 14. The network engine 9 may include one or more network processors. The interconnect medium 14 may be coupled to a plurality of processor units 13 through interfaces 13a. Each processor unit 13 may optionally be couple to data storage (in the exemplary embodiment shown each unit is couple to data storage). More or less processor units 13 may be utilized than shown in FIG. 2A.

The network engine 9 may be a processor engine that performs all protocol stack processing in a single processor module or alternatively may be two processor modules (such as the network interface engine 1030 and transport engine 1050 described above) in which split protocol stack processing techniques are utilized. Thus, the functionality and benefits of the content delivery system 1010 described above may be obtained with the system 10. The interconnect medium 14 may be a distributive interconnection (for example a switch fabric) as described with reference to FIG. 1A. All of the various computing, processing, communication, and control techniques described above with reference to FIGS. 1A-1F and 2 may be implemented within the system 10. It will therefore be recognized that these techniques may be utilized with a wide variety of hardware and computing systems and the techniques are not limited to the particular embodiments disclosed herein.

The system 10 may consist of a variety of hardware configurations. In one configuration the network engine 9 may be a stand-alone device and each processing unit 13 may be a separate server. In another configuration the network engine 9 may be configured within the same chassis as the processing units 13 and each processing unit 13 may be a separate server card or other computing system. Thus, a network engine (for example an engine containing a network processor) may provide transport acceleration and be combined with multi-server functionality within the system 10. The system 10 may also include shared management and interface components. Alternatively, each processing unit 13 may be a processing engine such as the transport processing engine, application engine, storage engine, or system management engine of FIG. 1A. In yet another alternative, each processing unit may be a processor module (or processing blade) of the processor engines shown in the system of FIG. 1A.

FIG. 2B illustrates yet another use of a network engine 9. As shown in FIG. 2B, a network engine 9 may be added to a network interface card 35. The network interface card 35 may further include the interconnect medium 14 which may be similar to the distributed interconnect 1080 described above. The network interface card may be part of a larger computing system such as a server. The network interface card may couple to the larger system through the interconnect medium 14. In addition to the functions described above, the network engine 9 may perform all traditional functions of a network interface card.

It will be recognized that all the systems described above (FIGS. 1A, 2, 2A, and 2B) utilize a network engine between the external network and the other processor units that are appropriate for the function of the particular network node. The network engine may therefore offload tasks from the other processors. The network engine also may perform “look ahead processing” by performing processing on a request before the request reaches whatever processor is to perform whatever processing is appropriate for the network node. In this manner, the system operations may be accelerated and resources utilized more efficiently.

DETERMINISTIC INFORMATION MANAGEMENT

In certain embodiments, the disclosed methods and systems may be advantageously employed for the deterministic management of information (e.g., content, data, services, commands, communications, etc.) at any level (e.g., file level, bit level, etc.). Examples include those described in U.S. patent application Ser. No. 09/797,200, filed Mar. 1, 2001 and entitled “Systems And Methods For The Deterministic Management of Information,” by Johnson et al., the disclosure of which is incorporated herein by reference.

As used herein, “deterministic information management” includes the manipulation of information (e.g., delivery, routing or re-routing, serving, storage, caching, processing, etc.) in a manner that is based at least partially on the condition or value of one or more system or subsystem parameters. Examples of such parameters will be discussed further below and include, but are not limited to, system or subsystem resources such as available storage access, available application memory, available processor capacity, available network bandwidth, etc. Such parameters may be utilized in a number of ways to deterministically manage information. For example, requests for information delivery may be rejected or queued based on availability of necessary system or subsystem resources, and/or necessary resources may be allocated or reserved in advance of handling a particular information request, e.g., as part of an end-to-end resource reservation scheme. Managing information in a deterministic manner offers a number of advantages over traditional information management schemes, including increased hardware utilization efficiency, accelerated information throughput, and greater information handling predictability. Features of deterministic information management may also be employed to enhance capacity planning and to manage growth more easily.

Deterministic information management may be implemented in conjunction with any system or subsystem environment that is suitable for the manipulation of information, including network endpoint systems, intermediate node systems and endpoint/intermediate hybrid systems discussed elsewhere herein. Specific examples of such systems include, but are not limited to, storage networks, servers, switches, routers, web cache systems, etc. It will be understood that any of the information delivery system embodiments described elsewhere herein, including those described in relation to FIGS. 1A and 2, may be employed to manage information in a deterministic manner.

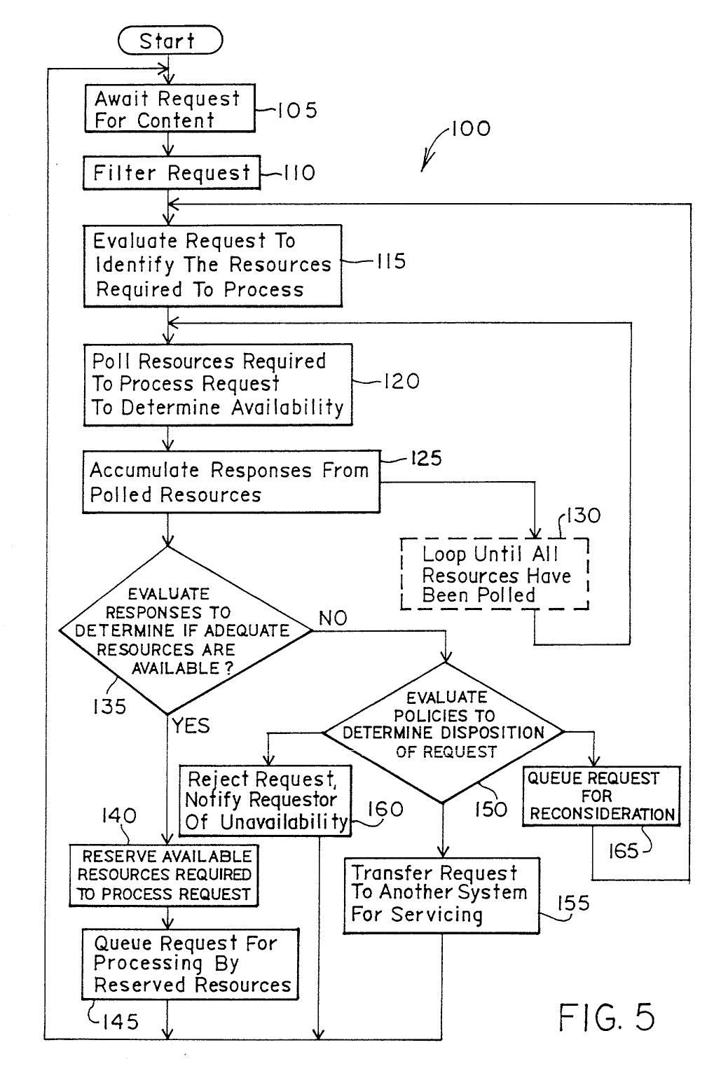

FIG. 5 is a flow diagram illustrating one embodiment of a method 100 for deterministic delivery of content in response to a request for the same. Although FIG. 5 is described in relation to content delivery, it will be understood with benefit of this disclosure that the deterministic methods and systems described herein may be used in a wide variety of information management scenarios, including application serving, and are therefore not limited to only processing requests for content. It will also be understood that the types of content that may be deterministically managed or delivered include any types of content described elsewhere herein, e.g., static content, dynamic content, etc.

With regard to deterministic content delivery methods such as that illustrated in FIG. 5, it will be understood that different types of content may be deterministically managed in different ways to achieved optimum efficiency. For example, when employed to deliver streaming content, such as video or audio streams, the disclosed methods may be advantageously employed to provide increased stability and predictability in stream delivery by, among other things, predicting the capacity of a content delivery system to deliver many long-lived streams. Each such stream requires a certain amount of resources, which may be identified at the time the stream is opened. For web page delivery, such as HTTP serving, requests may be handled as aggregates.

When employed with an information management system such as the content delivery system embodiment illustrated in FIG. 2, method 100 of FIG. 5 may be used to allow a system monitor, a plurality of subsystems and one or more shared resources of a system to effectively interact and provide deterministic delivery of data and services. However, it will be understood that method 100 may be implemented with a variety of other information management system configurations to allow deterministic interaction between system components, for example, between the multiple content delivery engines described in relation to FIG. 1A. Furthermore, FIG. 5 represents just one exemplary set of method steps that may be employed to implement deterministic interaction between system components, with it being understood that any other number, type and/or sequence of method steps suitable for enabling deterministic interaction between two or more components of an information management system may be employed. Selection of suitable steps may be made based on a variety of individual system characteristics, for example, system hardware, system function and environment, system cost and capabilities, etc.

Method 100 of FIG. 5 generally begins at step 105 where a request for content, is awaited. A request for content, as is the case with a request for other information (e.g., data, services, etc.), may be received from a variety of sources. For example, if the system is employed in a stream server environment, the request for content may be received from a client system attached to a computer network or communication network such as the Internet, or any of the other sources of requests described elsewhere herein, including from an overloaded subcomponent of the system which is presently unable to process the current request for content.

Upon receipt of a request for content at step 105, the request for content may be filtered at step 110 by, for example, one or more processing engines or modules that perform the function of a system monitor. Filtering the request for content may serve a variety of purposes. For example, the filtering performed at step 110 may serve as a screening agent to reject requests for content that the receiving system is not capable of processing. Step 110 may also be employed as a first parsing of the received requests for content such that a subsequent level of filtering is employed to further direct the work or requests for content to an appropriate subsystem or system area for processing. It will be understood that other filtering techniques and purposes may also be employed in conjunction with the disclosed systems and methods.

Once the request for content has been filtered, method 100 proceeds to step 115 where the filtered request for content is evaluated. Evaluation of the request for content may be performed by, for example, a system monitor or another subsystem or combination of subsystems capable of evaluating a request for content. With regard to step 115, a request for content may be evaluated in a number of different ways in relation to one or more system or subsystem parameters. For example, a request for content may be evaluated in relation to the requirements for fulfilling the request, e.g., the identified resources that are going to be required to process the particular request for content. As an illustration, a request for access to a streaming video file may be evaluated in relation to one or more of the following requirements: a need for access to storage, a need for processor usage, a need for network bandwidth to enable the data to be streamed from storage, as well as a need for other resources. Evaluation of a request in this manner may be used to enable a system monitor to determine the availability of the required resources, by first identifying what resources will be required to process the request for content. Additional details regarding evaluation of a request for content will be discussed below.

After the resources required to process the current request for content have been identified at step 115, method 100 proceeds to step 120. At step 120, the required resources identified in step 115 may be polled to determine whether the current workload of the required resources is such that the required resources will be available to process the current request for content upon its acceptance. Available resources may be defined, for example, as those required resources that are immediately available to process a request for content, or those resources that will be available within a predefined amount of time. Polling of each of the required resources may occur in parallel or serial manner.

Using the embodiment of FIG. 2 to illustrate, a system operable to process a request for content may include a system monitor 240, a plurality of subsystems (e.g., 210, 215, etc.) and one or more shared resources 255. Each subsystem may include one or more resources 250 that enable that subsystem to perform its respective tasks, and a monitoring agent 245 that is configured to monitor, control, reserve and otherwise manage those resources. In this embodiment, the polling at step 120 may involve the system monitor 240 communicating its resource needs to the monitoring agent 245 of the subsystem having the required resources to process the current request for content. Upon receipt of such communication, the monitoring agent 245 evaluates the workload of the resources 250 for which it is responsible to determine whether there is or there will be enough available resources to process the request for content under consideration.

For example, if the system monitor 240 has indicated that it needs four 4 (four) MB (megabytes) of memory from an application RAM (Random Access Memory) subsystem and the monitoring agent 245 of the application RAM subsystem 220 determines that only 1 MB of memory is available, the system monitor 240 will be notified by the monitoring agent 245 of the unavailability of the application RAM subsystem 220. As a result of the polling of the required resources, a response indicative of the availability of the required resources may be generated by the monitoring agent 245, and transferred to the polling unit, i.e., the system monitor 240. It will be understood that similar interaction between system monitor 240 and respective monitoring agents 245 of other subsystems may occur as appropriate for a given system configuration and a given information request.

In an alternate embodiment, instead of polling the subsystems, a system monitor may receive notifications generated by and transmitted from one or more of the various subsystems. Such notifications may be indicative of the availability of the resources of the various subsystems. For example, if RAM subsystem 220 of FIG. 2 has no available memory, RAM subsystem 220 may automatically notify the system monitor 240 that it is out of memory and therefore unable to take on additional requests for processing. When RAM subsystem resources become or are becoming available, RAM subsystem 220 may automatically generate and transmit a notification to the system monitor 240 indicative of the fact that the RAM subsystem is now or is becoming available to take on additional requests for processing.

Using the above-described automatic notification scheme, a given subsystem may inform a system monitor that the subsystem has reached a threshold of utilization and that the system monitor should slow down on accepting requests. Once a subsystem frees up some of its resources, the given subsystem may then notify the system monitor that it is available or is becoming available and that the system monitor may resume normal operation. Such an implementation allows the system monitor to maintain an awareness of the availability of the subsystems and their resources without requiring the system monitor to poll the subsystems, although it will be understood that both polling and notification functions may be employed together in a given system embodiment. Thus, it will be understood that the various methods and systems disclosed herein may be implemented in various ways to accomplish communication of the status of subsystem resource availability in any manner suitable for accomplishing the deterministic management of information disclosed herein.

At step 125 of method 100, the system monitor accumulates the responses to the resource polls or resource notifications for later evaluation. In one embodiment of method 100, optional step 130 may also be included. At step 130, method 100 loops until all responses or notifications have been received from concerning the identified required resources before allowing method 100 to proceed to step 135.

At step 135, the responses to the resource polls or resource notifications are evaluated, for example, by a system monitor. Evaluation of the resource responses or notifications may involve evaluation of any one or more desired characteristics of the resources including, but not limited to, current availability or estimated time until availability of adequate resources, capability of available resources in relation to a particular request, etc. In one embodiment, evaluation may involve determining whether adequate resources are available, or will be available within a specific time, to process the request for content under consideration. For example, method 100 may require that all of the resources required to process a request for content be immediately available, prior to proceeding toward acceptance of a content request.

Alternatively, evaluation of the responses from the polled resources may entail ensuring that a defined minimum portion of the required resources are immediately available or will become available in a specified amount of time. Such a specified amount of time may be defined on a system-level basis, automatically set by policy on a system-level basis, and/or automatically set by policy on a request-by-request basis. For example, a policy may be implemented to set a maximum allowable time frame for delivery of content based on one or more parameters including, but not limited to, type of request, type of file or service requested, origin of request, identification of the requesting user, priority information (e.g., QoS, Service Level Agreement (“SLA”), etc.) associated with a particular request, etc. A specified maximum allowable time frame may also be set by policy on a system level basis based on one or more parameters including, but not limited to, workload of the present system, resource availability or workload of other linked systems, etc. It will be understood that other guidelines or definitions for acceptable resource availability may be employed.

If, at step 135, the required resources are determined to be available within the guidelines specified for method 100 by one or more system policies, method 100 may proceed to step 140. At step 140, the resources required to process the request for content under consideration may be reserved. For example, using FIG. 2 as an illustration again, reservation of identified required resources 250 may be accomplished by the system monitor 240 or, alternatively, by a combination of the system monitor 240 and the appropriate monitoring agents 245 responsible for each of the identified required resources 250. In one embodiment, reservation of resources includes setting aside that portion of the available resources, or of the resources that will become available within a given time, that has been determined to be required to process the request for content, e.g., a block of memory, a portion of processor power, a portion of network and storage access bandwidth, etc. Reservation of the required resources may be employed to ensure that the current request for content will be readily processed.

Once the required resources have been reserved at step 140, method 100 proceeds to step 145. At step 145, the request for content may be queued for processing by the reserved resources. Upon queuing the request for content at step 145, method 100 returns to step 105 where receipt of a subsequent request for content is awaited by the system.

If, at step 135, it is determined that the required resources are not available to process the request for content, method 100 may proceed to step 150. At step 150, one or more handling policies may be evaluated to determine the proper disposition of the request for content. In this regard, a variety of handling policies (e.g., steps 155, 160 and 165 of FIG. 5) may be made available to properly dispose of requests for content for which the identified resources required to process a request are not available. A given handling policy may be implemented according to one or more system or subsystem parameters in any manner appropriate for the given system environment.

Examples of possible parameters that may be evaluated at step 150 to determine the appropriate handling policy for a given request include, but are not limited to, resource availability and capability of other content delivery systems (e.g., one or more other clustered systems), capability and/or anticipated time until availability of resources in the present content delivery system, the source of the request, the request priority (e.g., SLA, QoS bit set), etc.

In one exemplary embodiment, it is possible at step 150 to select a given policy (e.g., 155, 160 or 165) on a request-by-request or user-by-user basis, for example, based on a specified maximum allowable content delivery time frame that may vary for each request according to one or more parameters such as type of request, type of file or service requested, origin of request, identification of the requesting user, priority information (e.g., QoS, Service Level Agreement (“SLA”), etc.) associated with a particular request, etc. For example, requests from different users and/or requests having different priority codes may be individually associated with different maximum time frame values for delivery of content. When it is determined at step 135 that system resources for the current system won't be available for a given period of time, this given period of time may be compared with the maximum allowable content delivery time frame associated with each request to determine disposition of that request on an individualized basis. Thus, depending on the maximum allowable time frame associated with each request, it is possible that individual requests may be disposed of at step 150 via different policies even when the resource availability time determined at step 135 is the same for each request, e.g., some requests may be immediately transferred to another system via step 155, some requests may be rejected via step 160 and/or some requests may be re-considered via step 165. It will be understood that combinations of different policies and/or maximum content delivery time frames may be implemented in a variety of ways as necessary to achieve desired disposition of different requests.

As illustrated in FIG. 5, evaluation of the handling policies may lead to step 155 where disposal of the requests for content entails transferring the request to another system for processing when identified required resources of the present system are not immediately available or will not become available within a specified period of time. For example, the request for content may be transferred, i.e., by the system monitor, to a separate content delivery system that is known to have resources immediately available or available within a specified period of time. Alternatively, the request for content may be transferred to the next sequential system in a chain of content delivery systems, and where the next system proceeds through a method similar to method 100 to determine its ability to process the request for content.

Upon transferring the request for content to another system at step 155, method 100 of the system returns to step 105 where a subsequent request for content is awaited. It will be understood that a request for content may be transferred to another system that is similarly configured as the present system (e.g., as in a cluster of similar content delivery systems), or to another type of system that is configured differently (e.g., with differing resource types and/or capabilities). In the case of clustered systems, system monitors (or other appropriate subsystem modules) of the individual systems of a cluster may be configured to communicate with each other for purposes of sharing system capability and/or resource availability information with other systems to facilitate efficient transference and handling of requests within a system cluster.

It will also be understood that inter-system transfer of information (e.g., data, content, requests for content, commands, resource status information, etc.) between two or more clustered systems may be managed in a deterministic fashion in a manner similar to that described herein for the intra-system transfer of information between individual processing engines within a single information management system. Deterministic management of inter-system information transfer may be enhanced by distributive interconnection of multiple clustered systems, either internally (e.g., by distributive interconnection of individual distributed interconnects as shown in FIG. 1J) or externally (e.g., by distributive interconnection of individual system network interface processing engines as shown in FIG. 1H). In either case, deterministic transfer of information between individual systems may be managed in a deterministic fashion using any suitable management processing configuration, for example, by using a separate dedicated inter-system management processing module or by using one or more of the existing system monitor processing modules of the individual clustered systems. Individual clusters of systems may in turn be distributively interconnected and information transfer therebetween deterministically managed in a similar fashion, with the number of superimposed levels of deterministic information management being virtually unlimited. Thus, the disclosed methods and systems for deterministic management of information may be advantageously implemented on a variety of scales and/or at multiple system levels as so desired.

Another exemplary policy that may be implemented to address situations in which the current system is unable to process a request for content is illustrated at step 160 where the request for content may be rejected. Similar to step 155, a request for content may be so rejected when the identified required resources of the present system are not immediately available or will not be available within a specified period of time. Such a policy may be implemented, for example, where no other separate clustered system is known to be capable of handling the request, and/or is known to have the necessary resources immediately available or available within a specified period of time. In addition to rejecting the request for content, step 155 may also include notifying the source of the request for content of the rejection and of the inability of the present system to process the request for content. Once the request for content has been rejected at step 160, method 100 returns to step 105 where a subsequent request for content is awaited.

Yet another exemplary policy that may be implemented based on the evaluation step 150 is indicated generally at step 165. At step 165, a request for content may be re-queued for reconsideration by the present system. Re-queuing of a request may include returning to step 115 where the request for content is re-evaluated to identify the resources required for its processing. Such a re-queue may be desirable, for example, when the identified required resources of the present system and of other systems are not immediately available or will not be available within a specified period of time, but when such resources are anticipated to become available at some point in the future. Furthermore, selected types of requests may also be targeted for re-queue rather than rejection when resources are not available. For example, higher priority requests (e.g., based on SLA or QoS bit set) may be re-queued for expedited processing, while similar but lower priority requests are rejected.

It will be understood with benefit of this disclosure that the three handling policies described above in relation to step 150 are exemplary only, and that not all three need be present at step 150. Further, it will be understood that other types of handling policies may be implemented at step 150 as desired to fit the needs of a particular application environment, including additional or alternative policies for treatment of requests other than those described above, and policies that consider alternate or additional system or subsystem parameters.

Turning now to FIG. 2 in greater detail, it will be understood in view of the above discussion that the subsystems of content delivery system 200 may be configured to interact in a deterministic manner if so desired. The ability to manage information in a deterministic fashion may be made possible by virtue of the fact that each subsystem module has a monitoring agent 245 that is aware of one or more subsystem module resources 250 and the utilization of those resources within the respective subsystem and/or overall system 200.

As mentioned above, monitoring agents 245 of each subsystem may be configured to be capable of evaluating the current workload of the resources 250 of the respective subsystem and of reporting the availability of such resources to system monitor 240, either automatically or upon a polling by system monitor 240. Upon receipt of a request, system monitor 240 and one or more individual monitoring agents 245 may individually or together function to either accept the request and reserve the required resources 250 for the request if the resources are available, or to reject the request if one or more subsystem resources 250 required to process the request are not available.

In one embodiment, content delivery system 200 of FIG. 2 may be configured to deterministically deliver content (e.g., one or more video streams) by employing individual monitoring agents 245 in the following roles. Monitoring agent 245 of storage subsystem module 210 may be configured to monitor and reserve such resources as processing engine bandwidth, Fiber Channel bandwidth to content delivery flow path 263, number of available storage devices 265, number of IOPS available per device, and taking into account RAID levels (hardware or software). Monitoring agent 245 of file system caching subsystem module 215 may be configured to monitor and reserve such resources as processing engine bandwidth and memory available for caching blocks of data. Monitoring agent 245 of networking subsystem processing module 205 may be configured to monitor and reserve such resources as processing engine bandwidth, table lookup engine bandwidth, availability of RAM for connection control structures and outbound network bandwidth availability. Monitoring agent 245 of application processing subsystem module 225 may be configured to monitor and reserve processing engine bandwidth. Monitoring agent 245 of other subsystem module 275 may be configured to monitor and reserve resources appropriate to the processing engine features provided therein.

With regard to shared resources 255 of FIG. 2, it will be understood that in a deterministic content delivery embodiment, shared resources 255 may be provided and controlled by individual monitoring agents 245 of each subsystem module sharing the resources 255. Specifically, monitoring agents 245 of each subsystem may be configured to be capable of determining the workload of shared resources 255, and of reserving at least a portion of shared resources 255 that is to be employed by the reserving subsystem to process a request for content. For example, monitoring agent 245 of application RAM subsystem module 220 may be configured to monitor and reserve shared resource 255, such as RAM, for use by streaming application on a per-stream basis as well as for use with connection control structures and buffers.

In addition to deterministic interaction between individual subsystem modules of FIG. 2, communications (e.g., IPC protocol) and data movement between the modules may also be deterministic. In this regard, control messaging and data movement between subsystems may be configured to exhibit deterministic characteristics, for example, by employing one or more distributive interconnects (e.g., switch fabrics) to support deterministic data delivery and communication across the range of delivered loads. In one embodiment, separate distributive interconnects may be employed, for example, to deterministically perform the separate respective functions of inter-process communications path 230 and inter-process data movement path 235 of FIG. 2. In another embodiment, these separate functions may be combined and together deterministically performed by a single distributive interconnect, such as a single distributive interconnect 1080 of FIG. 1A. In either case, a distributive interconnect may be configured to support the bandwidth of communications and/or data (e.g., content) being transmitted or served so that added latency is not incurred.

As shown in FIG. 2, a separate monitoring agent 245 may be employed for each distributive interconnect present in a given system, with each interconnect being treated as a separate subsystem module. For example, in the exemplary embodiment of FIG. 2, monitoring agent 245 of inter-process communication path 230 may be configured to monitor and reserve such resources as the bandwidth available for message passing between subsystems while monitoring agent 245 of inter-process data movement path 235 may be configured to monitor and reserve the bandwidth available for passing data between the various subsystems. In another example, multiple distributive interconnects may be provided with monitoring agents to monitor and reserve either communication or data movement flow paths on an assigned or as-needed basis between subsystem modules, or between other distributive interconnects (e.g., in the case of internally clustered systems). Alternatively, a monitoring agent of a single distributive interconnect may be configured to monitor and reserve message-passing and data-passing bandwidth when these functions are handled by a single distributive interconnect, such as a single switch fabric.

Still referring to FIG. 2, method 100 of FIG. 5 may be implemented by system 200 as follows. System 200 begins by waiting for a request at step 105. In this regard, networking subsystem module 205 or some other subsystem module of system 200 may receive a request for content or a request for services from source 260, or from any of the other possible sources previously mentioned. As previously described, a request for content may include such requests as a request to start a video stream, a request for stored data, etc. A request for services may include, for example, a request for a database query, a request for a process to start, a request for an application to be run, etc.

At step 110, system monitor 240 filters the request for content as previously described. In this capacity, system monitor 240 may be configured to coordinate deterministic actions of system 200 by acting as a central clearing house or evaluator of content requests, and by directing the disposition of same. Although described in relation to system monitor 240, it will be understood that coordination of deterministic tasks may be performed by any subsystem module or combination of subsystem modules suitable for performing one or more of the tasks described herein as being performed by system monitor 240. For example, filtering tasks may be performed in whole or in part by application processing subsystem module 225. Furthermore, it will also be understood that one or more deterministic coordination tasks may be performed by processors or combinations of processors that are integral and/or external to a given system 200. For example, a processing module (e.g., system monitor 240) integral to a single system 200 may perform the deterministic coordination tasks for a cluster of linked systems. In an alternate example, a separate dedicated external processing module may be employed to perform the deterministic coordination tasks for a single system 200, or a cluster of such systems.

Once a request has been filtered at step 110 and the resources 250 required to process the request have been identified at step 115, system monitor 240 proceeds to step 120 and polls all of the monitoring agents 245 of the subsystem modules having the resources 250 that have been identified as being required to interact to process the given request, and accumulates responses from monitoring agents 245 at step 125. In response to this polling, a given subsystem module may be configured to refuse to take on additional requests unless it currently has, or will have within a specified period of time, the resources 250 available to process the new request without degradation to requests that it is already processing.

The monitoring tasks of monitoring agents 245 may be performed by any processor or combination of processors suitable for performing one or more of the monitoring tasks as described elsewhere herein. In this regard, monitoring tasks may be performed by one or more processors integral to a given monitored subsystem module as illustrated in FIG. 2, or may alternatively be performed by one or more processors external to the given subsystem module, or even external to system 200 itself. Furthermore, it is possible that a combination of monitoring tasks and deterministic coordination tasks may be performed by the same individual processor (e.g., both functions performed by system monitor 240), or by a combination of processors. Thus, it will be understood that the disclosed methods and systems may be implemented using a wide variety of hardware and/or logical configurations suitable for achieving the deterministic management of information as described herein.

After the responses from monitoring agents 245 are accumulated in step 125, system monitor 240 evaluates the responses at step 135 to determine if adequate resources are available as previously described, although evaluation may be accomplished in any other suitable manner, such as by using a different processing module or a combination of processing modules. For example, application processing subsystem module 225 may communicate with system monitor 240 and evaluate responses based on the resource responses or notifications that have been accumulated by system monitor 240 in step 125.

As previously mentioned, system monitor 240 may then participate in reserving and queuing the resources of each subsystem at steps 140 and 145 if the monitoring agents 245 of the appropriate subsystems have indicated that they have the identified resources 250 available that are required to process the request. Alternatively, individual monitoring agents 245 may reserve the required resources based upon requirements communicated to monitoring agents 245 by system monitor 240 or other processing module/s. An individual processing queue for each subsystem module may be maintained by its appropriate monitoring agent, and/or a centralized processing queue may be maintained for one or more modules by the system monitor.

As previously mentioned with respect to step 150, disposition of requests that a information management system is immediately unable to process or will not be able to process within a specified period of time may be determined by consulting one or more handling policies. For example, a request for content may be rejected in step 160, re-directed to another server 201 with capacity to spare in step 155, or queued for later processing in step 165. As with other exemplary steps of method 100, handling policy evaluation step 150 may be performed by system monitor 240, and/or other suitable processing module/s (e.g., application processing subsystem module 225).

The disclosed methods of deterministic information management may be accomplished using a variety of control schemes. For example, in one embodiment an application itself (e.g., video streaming) may be configured to have intimate knowledge of the underlying hardware/resources it intends to employ so as to enable identification, evaluation and reservation of required hardware/resources. However, in another embodiment the operating system employed by an information management system may advantageously be configured to maintain the necessary knowledge of the information management system hardware and hide such details from the application. In one possible embodiment, such an approach may be implemented for more general deployment in the following manner. An operating system vendor or a standards body may define a set of utilization metrics that subsystem vendors would be required to support. Monitoring and reservation of these resources could then be ‘built-in’ to the operating system for application developers to use. As one specific example, network interface card vendors might be required to maintain percent utilization of inbound and outbound bandwidth. Thus, if a request is received by a content delivery system for delivery of an additional 300 kb/s (kilobit per second) video stream, and the outbound networking path is already 99% utilized, such a request for content may be rejected.

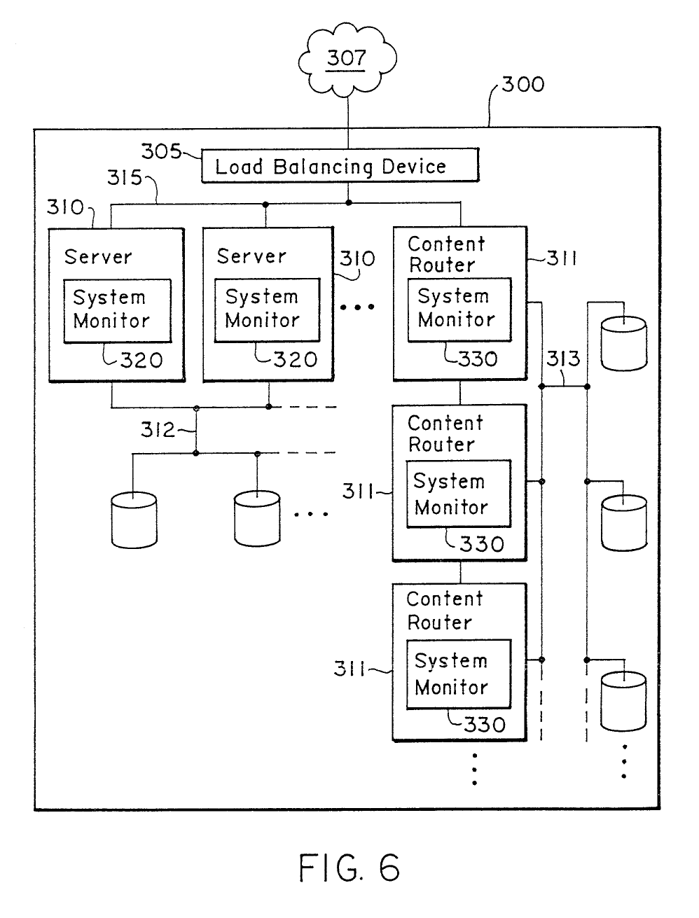

Deterministic management of information has been described herein in relation to particular system embodiments implemented with multiple subsystem modules distributively interconnected in a single chassis system, or in relation to embodiments including a cluster of such systems. However, it will be understood that information may be deterministically managed using a variety of different hardware and/or software types and may be implemented on a variety of different scales. FIG. 6 illustrates just one example of such an alternate embodiment in which the concept of a series of distributively interconnected subsystems may be extrapolated from optimization of resources within a single chassis information management system (e.g., server, router, etc.) to optimization of server resources in a data center 300. Such an implementation may involve deterministically managing communications and information flow between a number of separate devices within data center 300, although it may also be implemented to deterministically manage communication and information flow between similar-type devices integrated into the same chassis.

As shown in FIG. 6, data center 300 may include a device or blade, such as load balancing device 305, that is responsible for load-balancing traffic requests received from network 307 across a number of servers 310 and/or content routers 311 (e.g., within the same chassis or a number of chassis), and in which load-balancing device 305 communicates with servers 310 and/or content routers 311 over a distributively interconnected control/data path 315. In such an embodiment, load balancing device 305 may communicate with system monitors 320 and 330 of respective servers 310 and content routers 311 to determine whether servers 310 or content routers 311 have resources available. Such resources may include, for example, available bandwidth of storage area networks 312 and/or 313 to handle additional requests. In this regard, load balancing device 305 may filter and evaluate requests, poll data center 300 resources, evaluate the responses and dispose of the requests in a deterministic manner similar to that described elsewhere herein, e.g., for system monitor 240 of FIG. 2.

In a further possible embodiment, one or more of servers 310 and/or content routers 311 may be internally configured with subsystem modules that are distributively interconnected and deterministically managed, for example, in a manner as described in relation to FIGS. 1A and 2. In such an implementation, each server 310 and content router 311 itself (in terms of delivering streams or pages) is capable of monitoring its resources and interacting with an external agent in a way that is analogous to the way that the internal subsystems of individual servers 310 and/or content routers 311 are interacting.

In other further embodiments, the disclosed deterministic information management concept may be applied to many different technologies where the concept of a server may be generalized. For example, implementation of the present invention may apply to a device that routes data between a gigabit Ethernet connection to a Fiber Channel connection. In such an implementation, the subsystems may be a networking subsystem, a Fiber Channel subsystem and a routing subsystem. An incoming request for a SCSI (Small Computer System Interface) block would appear at the networking subsystem. The system monitor would then poll the system devices to determine if resources are available to process the request. If not, the request is rejected, or else the necessary resources are reserved and the request is subsequently processed.

Finally, although various embodiments described herein disclose monitoring each individual processing engine of an information management system, such as each subsystem module of content delivery system 200 of FIG. 2, such extensive monitoring may not be necessary in particular application environments. For example, if one or more processing engines has sufficient resources to handle virtually any workload that the information management system is able to provide, it may be unnecessary to track the availability of those resources. In such an implementation, the processing power that may have been utilized to monitor, poll, track, etc. the resources of such a processing engine may be conserved or eliminated. Such a reduction in monitoring and processing power may reduce the overall system cost as well as reduce system design costs.

DIFFERENTIATED SERVICES

The disclosed systems and methods may be advantageously employed to provide one or more differentiated services in an information management environment, for example, a network environment. In this regard, examples of network environments in which the disclosed systems and methods may be implemented or deployed include as part of any node, functionality or combination of two or more such network nodes or functionalities that may exist between a source of information (e.g., content source, application processing source, etc.) and a user/subscriber, including at an information source node itself (e.g., implemented at the block level source) and/or up to a subscriber node itself. As used herein, the term “differentiated service” includes differentiated information management/manipulation services, functions or tasks (i.e., “differentiated information service”) that may be implemented at the system and/or processing level, as well as “differentiated business service” that may be implemented, for example, to differentiate information exchange between different network entities such as different network provider entities, different network user entities, etc.. These two types of differentiated service are described in further detail below. In one embodiment, either or both types of differentiated service may be further characterized as being network transport independent, meaning that they may be implemented in a manner that is not dependent on a particular network transport medium or protocol (e.g., Ethernet, TCP/IP, Infiniband, etc.), but instead in a manner that is compatible with a variety of such network transport mediums or protocols.

As will be described further herein, in one embodiment the disclosed systems and methods may be implemented to make possible session-aware differentiated service. Session-aware differentiated service may be characterized as the differentiation of information management/manipulation services, functions or tasks at a level that is higher than the individual packet level, and that is higher than the individual packet vs. individual packet level. For example, the disclosed systems and methods may be implemented to differentiate information based on status of one or more parameters associated with an information manipulation task itself, status of one or more parameters associated with a request for such an information manipulation task, status of one or more parameters associated with a user requesting such an information manipulation task, status of one or more parameters associated with service provisioning information, status of one or more parameters associated with system performance information, combinations thereof, etc. Specific examples of such parameters include class identification parameters, system performance parameters, and system service parameters described further herein. In one embodiment, session-aware differentiated service includes differentiated service that may be characterized as resource-aware (e.g., content delivery resource-aware, etc.) and, in addition to resource monitoring, the disclosed systems and methods may be additionally or alternatively implemented to be capable of dynamic resource allocation (e.g., per application, per tenant, per class, per subscriber, etc.) in a manner as described further herein.

Deterministic capabilities of the disclosed systems and methods may be employed to provide “differentiated information service” in a network environment, for example, to allow one or more tasks associated with particular requests for information processing to be provisioned, monitored, managed and/or reported differentially relative to other information processing tasks. The term “differentiated information service” includes any information management service, function or separate information manipulation task/s that is performed in a differential manner, or performed in a manner that is differentiated relative to other information management services, functions or information manipulation tasks, for example, based on one or more parameters associated with the individual service/function/task or with a request generating such service/function/task. Included within the definition of “differentiated information service” are, for example, provisioning, monitoring, management and reporting functions and tasks as described elsewhere herein. Specific examples include, but are not limited to, prioritization of data traffic flows, provisioning of resources (e.g., disk IOPs and CPU processing resources), etc.

As previously mentioned, business services (e.g., between network entities) may also be offered in a differentiated manner. In this regard, a “differentiated business service” includes any information management service or package of information management services that may be provided by one network entity to another network entity (e.g., as may be provided by a host service provider to a tenant and/or to an individual subscriber/user), and that is provided in a differential manner or manner that is differentiated between at least two network entities. In this regard, a network entity includes any network presence that is or that is capable of transmitting, receiving or exchanging information or data over a network (e.g., communicating, conducting transactions, requesting services, delivering services, providing information, etc.) that is represented or appears to the network as a networking entity including, but not limited to, separate business entities, different business entities, separate or different network business accounts held by a single business entity, separate or different network business accounts held by two or more business entities, separate or different network ID's or addresses individually held by one or more network users/providers, combinations thereof, etc. A business entity includes any entity or group of entities that is or that is capable of delivering or receiving information management services over a network including, but not limited to, host service providers, managed service providers, network service providers, tenants, subscribers, users, customers, etc.

A differentiated business service may be implemented to vertically differentiate between network entities (e.g., to differentiate between two or more tenants or subscribers of the same host service provider/ISP, such as between a subscriber to a high cost/high quality content delivery plan and a subscriber to a low cost/relatively lower quality content delivery plan), or may be implemented to horizontally differentiate between network entities (e.g., as between two or more host service providers/ISPs, such as between a high cost/high quality service provider and a low cost/relatively lower quality service provider). Included within the definition of “differentiated business service” are, for example, differentiated classes of service that may be offered to multiple subscribers. Although differentiated business services may be implemented using one or more deterministic and/or differentiated information service functions/tasks as described elsewhere herein, it will be understood that differentiated business services may be provided using any other methodology and/or system configuration suitable for enabling information management or business services to be provided to or between different network entities in a differentiated manner.

As described herein above, the disclosed methods and systems may be implemented to deterministically manage information based at least in part on parameters associated with particular processed information, or with a particular request for information such as a request for content or request for an information service. Examples of such parameters include, but are not limited to, priority level or code, identity of the requesting user, type of request, anticipated resources required to process the request, etc. As will be further described herein below, in one embodiment these deterministic features may be implemented to provide differentiated information service, for example, in the provisioning of resources and/or prioritization of resources for the processing of particular requests or for performing other tasks associated with management of information. In such an implementation, deterministic management may be configured to be user programmable and/or may be implemented at many system levels, for example, below the operating system level, at the application level, etc. Such deterministic features may be advantageously implemented, for example, to bring single or multi subscriber class of service and/or single or multi content class of service capability to both single and multi-tenant (e.g., shared chassis or data center) environments.

In one differentiated information service embodiment disclosed herein, differentially managing an individual information processing request relative to other such requests allows provisioning of shared resources on a request-by-request, user-by-user, subscriber-by-subscriber or tenant-by-tenant basis based on SLA terms or other priority level information. Differentially monitoring or tracking resource usage for a particular request or particular user/customer allows reporting and verification of actual system performance relative to SLA terms or other standards set for the particular user or customer, and/or allows billing for shared resource usage to be based on the differential use of such resources by a particular user/customer relative to other users/customers. Thus, differentiation between information requests may be advantageously employed to increase efficiency of information management by allowing processing of a particular request to be prioritized and/or billed according to its value relative to other requests that may be simultaneously competing for the same resources. By providing the capability to differentiate between individual information management/manipulation tasks, maximum use of shared resources may be ensured, increasing profitability for the information management system operator and providing users with information management services that are predictable and prioritized, for example, based on the user's desired service level for a given request. In this way, deterministic information management may be employed to enable service providers to differentiate and optimize customer service levels (i.e., the customer experience) by allocating content delivery resources based on business objectives, such as bandwidth per connection, duration of event, quality of experience, shared system resource consumption, etc.

The ability to differentiate between information requests may be especially advantageous during periods of high demand, during which it is desirable that an e-business protect its most valuable customers from unpredictable or unacceptable service levels. As described elsewhere herein, system resources (bandwidth, storage processing, application processing, network protocol stack processing, host management processing, memory or storage capacity, etc.) may be adaptively or dynamically allocated or re-allocated according to service level objectives, enabling proactive SLA management by preserving or allocating more resources for a given customer when service levels are approaching SLA thresholds or when system resource utilization is approaching threshold levels, thus assuring SLA performance and generating substantial savings in SLA violation penalties.

Capability to deliver differentiated information service may be implemented using any suitable system architectures, such as one or more of the system architecture embodiments described herein, for example, asymmetrical processing engine configuration, peer-to-peer communication between processing engines, distributed interconnection between multiple processing engines, etc. For example, when implemented in an embodiment employing asymmetrical multi-processors that are distributively interconnected, differentiated management and tracking of resource usage may be enabled to deliver predictable performance without requiring excessive processing time. Furthermore, management and tracking may be performed in real-time with changing resource and/or system load conditions, and the functions of management and tracking may be integrated so that, for example, real time management of a given information request may be based on real time resource usage tracking data.

The disclosed differentiated service capability may be implemented in any system/subsystem network environment node that is suitable for the manipulation of information, including network endpoint systems, intermediate node systems and endpoint/intermediate hybrid systems discussed elsewhere herein. Such capability may also be implemented, for example, in single or multiple application environments, single or multi CoS environments, etc. It will also be understood that differentiated service capability may be implemented across any given one or more separate system nodes and/or across any given separate components of such system nodes, for example, to differentially provision, monitor, manage and/or report information flow therebetween. For example, the disclosed systems and methods may be implemented as a single node/functionality of a multi-node/functionality networking scheme, may be implemented to function across any two or more multiple nodes/functionalities of a multi-node/functionality networking scheme, or may be implemented to function as a single node/functionality that spans the entire network, from information source to an information user/subscriber.

As will be further described herein, the disclosed differentiated services may be advantageously provided at one or more nodes (e.g., endpoint nodes, intermediate nodes, etc.) present outside a network core (e.g., Internet core, etc.). Examples of intermediate nodes positioned outside a network core include, but are not limited to cache devices, edge serving devices, traffic management devices, etc. In one embodiment such nodes may be described as being coupled to a network at “non-packet forwarding” or alternatively at “non-exclusively packet forwarding” functional locations, e.g., nodes having functional characteristics that do not include packet forwarding functions, or alternatively that do not solely include packet forwarding functions, but that include some other form of information manipulation and/or management as those terms are described elsewhere herein.

Examples of particular network environment nodes at which differentiated services (i.e., differentiated business services and/or differentiated information services) may be provided by the disclosed systems and methods include, but are not limited to, traffic sourcing nodes, intermediate nodes, combinations thereof, etc. Specific examples of nodes at which differentiated service may be provided include, but are not limited to, switches, routers, servers, load balancers, web-cache nodes, policy management nodes, traffic management nodes, storage virtualization nodes, node between server and switch, storage networking nodes, application networking nodes, data communication networking nodes, combinations thereof, etc. Specific examples of such systems include, but are not limited to, any of the information delivery system embodiments described elsewhere herein, including those described in relation to FIGS. 1A and 2. Further examples include, but are not limited to, clustered system embodiments such as those illustrated in FIGS. 1G through 1J. Such clustered systems may be implemented, for example, with content delivery management (“CDM”) in a storage virtualization node to advantageously provide differentiated service at the origin and/or edge, e.g., between disk and a client-side device such as a server or other node.

Advantageously, the disclosed systems and methods may be implemented in one embodiment to provide session-aware differentiated information service (e.g., that is content-aware, user-aware, request-aware, resource-aware, application aware, combinations thereof, etc.) in a manner that is network transport independent. For example, differentiated information service may be implemented at any given system level or across any given number of system levels or nodes (e.g., across any given number of desired system components or subsystem components) including, but not limited to, from the storage side (spindle) up to the WAN edge router level, from the storage side up to the service router level, from the storage side up to the core router level, from server to router level (e.g., service router, edge router, core router), etc. Furthermore, the disclosed systems and methods may be implemented to provide differentiated information service in such environments on a bi-directional information flow basis (e.g., they are capable of differentially managing both an incoming request for content as well as the outgoing delivery of the requested content), although unidirectional differentiated information service in either direction is also possible if so desired. The disclosed differentiated services not only may be provided at any given system level or across any given number of system levels or nodes as described above, but as described further herein also may be implemented to provide functions not possible with conventional standards or protocols, such as Ethernet priority bits, Diffserv, RSVP, TOS bits, etc. TCP/IP and Ethernet are conventional communication protocols that make use of priority bits included in the packet, e.g., Ethernet has priority bits in the 802.1p/q header, and TCP/IP has TOS bits.

In one specific implementation, a serving endpoint may be provided with the ability to not only distinguish between a number of service classes of traffic/application/service, but also to make admission-control and other decisions based on this information. In such a case, policies may be employed to direct the operational behavior of the server endpoint.

In another specific implementation, statistical data gathering and logging may be employed to track resource provisioning and/or shared resource usage associated with particular information manipulation tasks such as may be associated with processing of particular requests for information. Data collected on resource provisioning and shared resource usage may in turn be employed for a number of purposes, including for purposes of billing individual users or suppliers according to relative use of shared resources; tracking actual system performance relative to SLA service guarantees; capacity planning; activity monitoring at the platform, platform subsystem, and/or application levels; real time assignment or reassignment of information manipulation tasks among multiple sub-systems and/or between clustered or linked systems; fail-over subsystem and/or system reassignments; etc. Such features may be implemented in accordance with business objectives, such as bandwidth per subscriber protection, other system resource subscriber protection, chargeable time for resource consumption above a sustained rate, admission control policies, etc.

It will be understood that differentiated information service functions, such as resource management and other such functions described herein, may be performed at any system level or combination of system levels suitable for implementing one or more of such functions. Examples of levels at which differentiated information service functions may be implemented include, but are not limited to, at the system BIOS level, at the operating system level, service manager infrastructure interface level. Furthermore, differentiated information service capability may be implemented within a single system or across a plurality of systems or separate components.

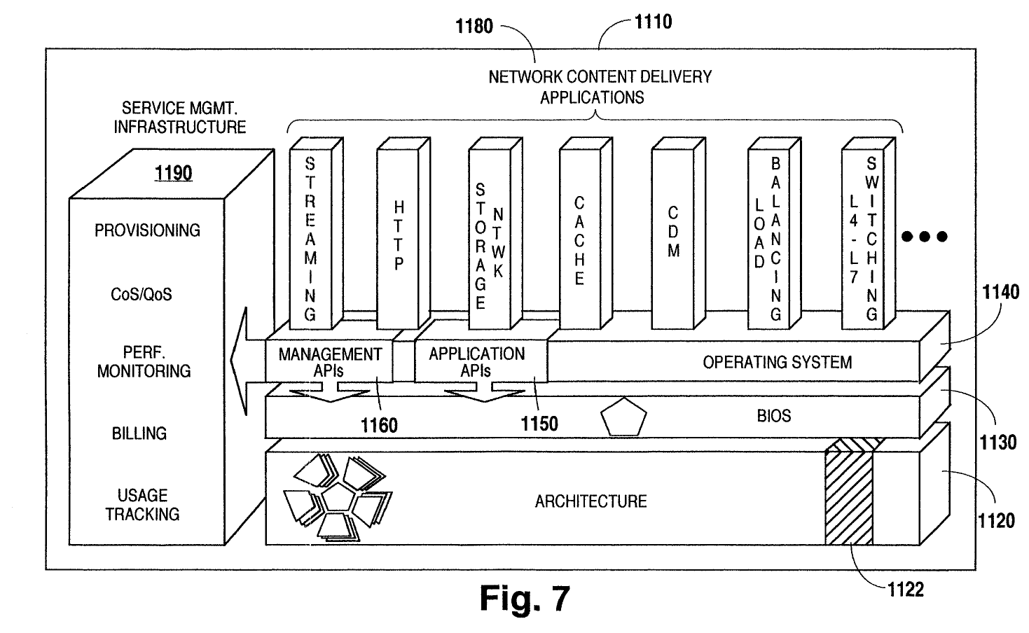

A simplified representation showing the functional components of one exemplary embodiment of an information management system 1110 capable of delivering differentiated information service is shown in FIG. 7. Functional components of system 1110 include hardware system architecture 1120, system BIOS 1130, operating system 1140, management application program interface API 1160, application API 1150, network content delivery applications 1180, and differentiated service management infrastructure 1190. System architecture 1120 may be any information system architecture having deterministic and/or asymmetric processing capabilities, for example, as described elsewhere herein.

In one embodiment, system architecture 1120 may include multiple system engines that are distributively interconnected, for example, in a manner as illustrated and described relation to FIG. 1A or FIG. 2. System architecture 1120 may also include system software that has state knowledge of resource utilization within the architecture and that is capable of imparting deterministic capabilities (e.g., instructions) to system architecture 1120, for example, by deterministically controlling interaction between distributively interconnected system engines of system architecture 1120. As described in relation to FIG. 2, monitoring agents 245 may be provided within each subsystem module and the system architecture 1120 may include a system monitor 240 that performs system management functions, such as maintaining service policies, collecting real-time utilization data from all subsystem modules, etc. System architecture 1120 may be capable of supporting a discrete family of applications or multiple concurrent applications (e.g., streaming applications such as QuickTime, RealNetwork and/or Microsoft Media, edge cache-related, NAS-related, etc.).

System calls may be employed to OS-extensions to determine characteristics of one or more parameters associated with processing engines/resources of a system architecture 1120 (e.g., as in FIGS. 1A and 2) so as to enable deterministic information management and/or to provide differentiated information service functions in a manner described elsewhere herein. In one embodiment, calls to OS-extensions may be made to implement necessary system resource utilization and user priority information. As an example, referring back to FIG. 2, monitoring agent 245 of storage subsystem module 210 may be employed to monitor the workload on each content source 265, as well as the status of other resources 250 of module 210 such as workload on the system CPU doing the caching and block operations, as well as the available memory for caching. Monitoring of this information makes possible calls to storage processing subsystem module 210, for example, to determine availability of IOPs on the drive(s) upon which a requested content stream resides. Similarly, calls may be made to networking subsystem processor module 205 having its own monitoring agent 245 to determine how much bandwidth on the outbound connection is already being used, as well as to determine if sufficient additional resources are available to add another connection. A call may also be made to determine whether sufficient RAM is available in file system cache subsystem module 215 to support this operation, which is also provided with a monitoring agent 245.

As will be described in further detail below, system calls may also be employed to understand parameters, such as priority, associated with individual connections, requests for information, or specific content sets. Examples of such parameters include, but are not limited to, those associated with classes based on content, classes based on application, classes based on incoming packet priority (e.g., utilizing Ethernet priority bits, TCP/IP TOS bits, RSVP, MPLS, etc.), classes based on user, etc. It will be understood that the possible system calls described above are exemplary only, and that many other types of calls or combinations thereof may be employed to deterministically manage information and/or to provide differentiated information service capability in a manner as described elsewhere herein. It will also be understood that where a system monitor 240 collects and maintains monitored subsystem module information, system calls may be handled by system monitor 240 rather than by the individual subsystem modules as described above.

Thus, the capability of monitoring individual subsystem or processing engine resources provided by the disclosed deterministic information management systems may be advantageously implemented in one embodiment to make possible policy-based management of service classes and guarantees in a differentiated manner from a server endpoint. One possible implementation of such an embodiment may be characterized as having the following features. All subsystems that represent a potential bottleneck to complete the requested information management are configured to support prioritized transactions. Any given transaction (e.g., video stream, FTP transfer, etc.) is provided a unique ID that is maintained in the OS or in the application, which includes a priority indicator (or other class of service indicator). OS extensions or other API's are provided for applications to access this information, and an I/O architecture configured to support prioritized transactions.

As further illustrated in FIG. 7, optional system BIOS 1130 may be present to manage system calls made to processing engines of architecture 1120 from applications 1180 through optional APIs 1160 and/or 1150 and through operating system 1140. In this regard system BIOS 1130 enables applications 1180 to utilize architecture 1120 in a deterministic manner by providing access to data presented by individual engines or subsystem modules of architecture 1120, and by ensuring calls are made properly to individual engines or subsystem modules of architecture 1120 in a manner as described above. System BIOS 1130 may make this possible, for example, by responding to application requests for resources with availability information, rerouting information, or SLA choice information. System BIOS 1130 may be implemented as hardware, software or a combination thereof, and may include the IPC.

In one embodiment, operating system 1140 may be a conventional operating system (e.g., Linux-based operating system), to which applications 1180 may be directly ported or may be ported through optional application APIs 1150 and/or 1160 as described below. In this regard, optional APIs 1150 may be provided to enhance performance of one or more applications on system 1110, including, but not limited to, network content delivery applications 1180 as illustrated in FIG. 7. As shown, examples of network content delivery applications include, but are not limited to, applications related to HTTP, streaming content, storage networking, caching, protocol software level switching (e.g., Layer 3 through Layer 7), load balancing, content delivery management (CDM), etc. It will be understood that these listed applications are exemplary only, and that other applications or other combinations of applications (e.g., greater or lesser number, and/or combinations of different applications and/or types of applications, etc.) are also possible. Just a few example of other possible network content delivery applications or internet applications include, but are not limited to, applications related to database, FTP, origin, proxy, other continuous content, etc

Although some performance advantages are possible when conventional applications 1180 are directly ported to conventional operating system 1140, application and operating system functions are thus executed in a manner that is essentially unaware of the asymmetric and deterministic capabilities of architecture 1120. Thus, optional application APIs 1150 may be configured as system and/or subsystem-aware functional components that when present at the application/operating system interface may provide significant enhancement and accelerated system performance by streamlining communication and data flow between the application level and the other levels of system 1110 in a manner as described elsewhere herein. Optional management APIs 1160 may also be present to perform a similar function at the operating system/BIOS interface. Although illustrated in FIG. 7 as separate functional components from conventional operating system 1140, it will be understood that functionality of BIOS 1130, API 1160 and/or API 1150 may be built-into or resident within an operating system.

In yet another embodiment, one or more of applications 1180 may be written as system and/or subsystem-aware components themselves, further enhancing and accelerating system performance. For example, code may be included in a selected application that not only utilizes calls into operating system 1140 that indicate the relative priority of each connection or request, but that also utilizes calls indicating the availability of necessary resources or subsystems in architecture 1120 to support each stream. In this manner, the application is enabled to make smart decisions about how to handle various classes of customers in times of system congestion.

Although not illustrated, an operating system may be configured to enable deterministic/differential system performance through a direct interface between applications 1180 and system architecture 1120, e.g., without the need for BIOS 1130. In such a case, system calls may be implemented and managed in the operating system itself. Advantageously, the unique deterministic nature of the system architectures disclosed herein (e.g., FIGS. 1A and 2) make possible such operating system features by enabling monitoring on the subsystem level without excessive processing overhead.

Still referring to FIG. 7, differentiated service management infrastructure 1190 may be provided to enable differentiated service functions or tasks including, but not limited to, service provisioning, service level agreement protocols, QoS and CoS policies, performance monitoring, reporting/billing, usage tracking, etc. These particular management functions will be described in further detail herein, however it will be understood that any other information management function/s that act in a way to differentiate service and/or flow of information may also be implemented using the disclosed systems and methods.

Individual differentiated information service functions of service management infrastructure 1190 may be performed within system 1110 (e.g., by a system management processing engine 1060 described elsewhere herein) and/or may be performed a separate network-connected management system/s (e.g., via interface support to an external data center for service management), such as a separate system running IBM Tivoli, HP Open View, etc. For example, in one embodiment service provisioning, QoS, and performance monitoring functions may be performed by a host processing unit 1122 (e.g., a system management processing engine 1060 as described elsewhere herein) within architecture 1120, while billing and usage tracking functions may be performed by a separate externally connected network component/system based on performance monitoring data supplied by system 1110 (e.g., via a management interface 1062). When information is so provided to an external system for further processing, such information may be output (e.g., such as flat file, SNMP, web-based, CLI, etc.), or selected management APIs 1160 may be present to interface and enhance communications between system 1110 and the external system by providing performance monitoring/usage data in an optimized format for the particular application type/s running on the external system.

It will be understood that FIG. 7 illustrates only one exemplary functional representation of an information management system capable of delivering differentiated service, and that differentiated service capability may be implemented in a variety of other ways, using other combinations of the functional components illustrated in FIG. 7, and/or using different functional components and various combinations thereof. For example, operating system 1140 and/or BIOS 1130 may be extended beyond the boundary of system 1110 to deterministically interface with systems, subsystems or components that are external to system 1110, including systems, subsystems or components that are physically remote from system 1110 (e.g., located in separate chassis, located in separate buildings, located in separate cities/countries etc.) and/or that are not directly coupled to system 1110 through a common distributed interconnect. Examples of such external systems, subsystems or components include, but are not limited to, clustered arrangements of geographically remote or dispersed systems, subsystems or components.

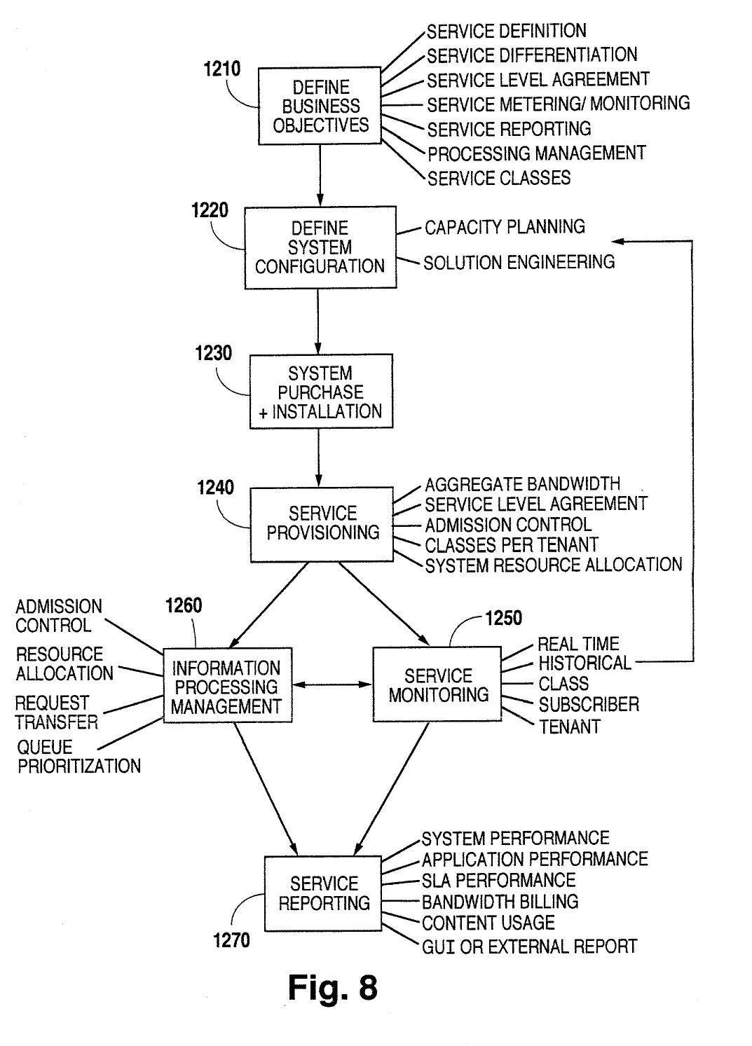

FIG. 8 illustrates one embodiment of a method for implementing differentiated service capability based on defined business objectives, for example, in a competitive service differentiation implementation. As shown, the method includes defining business objectives in step 1210, defining a system configuration in step 1220, purchasing and installing the configured system in step 1230, provisioning service in step 1240, monitoring/tracking service in step 1250, managing information processing in step 1260 and/or reporting service information in step 1270. It will be understood that the method steps of FIG. 8 are exemplary only, and that embodiments of the disclosed systems and methods may be implemented with any one of the steps, or with any combination of two or more of the steps illustrated in FIG. 8. It will be further understood that the disclosed methods and systems may be implemented with other steps not illustrated in FIG. 8, or with combinations of such other steps with any one or more of the steps illustrated in FIG. 8.

The embodiment of FIG. 8 may be implemented, for example, to allow a host service provider (“HSP”) to use the disclosed methods and systems to provide one or more differentiated business services for one or more tenants, who in turn may provide services to subscribers. Examples of HSP's include, but are not limited to, a data center owner who provides co-located or managed services to one or more tenants. Examples of tenants include, but are not limited to, xSPs (such as ISP, ASP, CDSP, SSP, CP or Portal), Enterprise providers providing service to employees, suppliers, customers, investors, etc. A tenant may be co-located or under HSP Managed Service. Subscribers include, for example, residential and/or business customers who access a network content delivery system to play audio/video streams, read web pages, access data files, etc. It will be understood that these examples are exemplary only, and that the embodiment of FIG. 8 may be implemented to allow entities other than an HSP to provide differentiated business services using the disclosed methods and systems.

Referring now to FIG. 8 in more detail, business objectives may be defined in step 1210 and may include objectives such as service definition objectives (e.g., delivery of continuous broadcast, non-continuous and/or stored information, management of unique/non-unique information, anticipated number of simultaneous subscribers and/or simultaneous streams, event (e.g., stream) duration, system resources (e.g. bandwidth) per subscriber, etc.), service differentiation objectives (e.g., horizontal and/or vertical differentiation between different entities, differentiation based on quality/cost plan, differentiation based on type of information request, differentiation based on user/subscriber and/or user/subscriber characteristics, etc.), service level agreement objectives (e.g., CoS priority, QoS etc.), service metering objectives and/or service monitoring objectives (e.g., subscriber flow performance, tenant class performance or individual tenant performance, aggregate system performance, individual subsystem performance, etc.), service reporting objectives (e.g., billing log generation, tracking adherence to SLA, tracking utilization of system and/or subsystems, tracking subscriber and/or content activity, etc.), information processing management objectives (e.g., admission and/or prioritization of requests based on tenant class or individual tenant identity, overflow treatment, etc.), and/or service classes (e.g., desired number and/or types of service classes, etc.). Such objectives may be defined in any manner suitable for communicating the same, for example, from a system purchaser/user to an information management system supplier. Types of objectives that may be defined include one or more pre-defined types of variables, and/or may include one or more custom objective aspects.

Still referring to FIG. 8, a system configuration may be defined in step 1220 based at least partly on business objectives defined in step 1210, for example, by a system manufacturer based on system objectives provided by a purchaser in step 1210. In this regard step 1220 may include, but is not limited to, planning a system configuration to meet objectives such as anticipated capacity, and engineering system characteristics to implement the defined configuration, etc. For example, a system configuration may be planned to meet capacity objectives including, but not limited to, anticipated system throughput objectives, service level protection objectives, maximum number of customer objectives, etc. Examples of solution engineering parameters include, but are not limited to, implementing the system configuration by engineering types and number of system and subsystem hardware components, quality of service objectives, billing and metering objectives, etc. In one exemplary embodiment, specific examples of information system characteristics that may be so configured for a content delivery system include, but are not limited to, storage characteristics (e.g., storage capacity, mirroring, bandwidth attach rate, protocol, etc.); compute characteristics (e.g., CPU speed, management responsibility, application processing capability, etc.); and network characteristics (e.g., admission control, policy management, number of classes, etc.), combinations thereof, etc.

Advantageously, embodiments of the disclosed systems may be configured in consideration of many factors (e.g., quality of service capability, desired SLA policies, billing, metering, admission control, rerouting and other factors reflective of business objectives) that go beyond the simple capacity-oriented factors considered in traditional server design (e.g., anticipated number of requests per hour, duration of stream event, etc.). An information management system may be so configured in this manner based on verbal or written communication of such factors to a system supplier and system configuration accomplished by the supplier based thereupon, and/or a system may be configured using an automated software program that allows entry of such factors and that is, for example, running locally on a supplier's or customer's computer or that is accessible to a customer via the Internet.

In one exemplary embodiment, possible system configurations that may be provided in step 1220 based on business objectives or other defined variables include, but are not limited to, configuration of subsystem components within a single box or chassis (e.g., using subsystem modules that are pluggable into a distributed interconnect backplane), configuration of a cluster of systems in a box to box manner (e.g., internally or externally clustered systems), configuration of data system components using distributively interconnected data center components, etc. Possible system configurations include, but are not limited to, data center system configurations or other content points of presence (“POPs”) suitable for providing delivery traffic management policies and/or for implementing SLA policies to multiple components of a data center concurrently (e.g., switch, storage, application server, router, etc.), and to any selected point/s therebetween. Examples of such content POPs include, but are not limited to, telephone central offices, cable head-ends, wireless head-ends, etc. Thus a system such as shown in FIGS. 1A or 2 may be configured with an optimization of the allocation of resources between processor engines, the types and quantity of processor modules per engine, etc.

As further shown in FIG. 8, system configuration may be defined or modified in step 1220 based at least partly on service monitoring information obtained in step 1250. For example, an existing system configuration may be modified at least partly on service monitoring information obtained for that same system while in actual operation. A new system may be configured based on service monitoring information obtained for one or more existing system/s while in actual operation (e.g., for existing systems similar to the new system and/or for systems operating under network conditions similar to the anticipated network conditions for the new system). Service monitoring step 1250 is described in further detail below, and includes, but is not limited to, historical tracking of system performance parameters such as resource availability and/or usage, adherence to provisioned SLA policies, content usage patterns, time of day access patterns, etc. In this regard step 1220 may include, but is not limited to, capacity planning and/or solution engineering based on historically monitored system throughput, service level adherence, maximum number of concurrent subscribers, etc.

It will be understood that a system configuration definition may be based on any desired combination of business objective information and service monitoring information. In this regard, one or more individual monitored performance parameters (e.g., resource availability and/or usage, adherence to provisioned SLA policies, content usage patterns, time of day access patterns, or other parameters anticipated to be similar for the new system) may be combined with one or more individual business objectives (e.g., objectives reflecting performance parameters expected to differ for the new system, new service differentiation objectives, new service level agreement objectives, new service metering objectives, new service monitoring objectives, new service reporting objectives new information processing management objectives, and/or new service class information, etc.). Further, it will be understood that such service monitoring information and/or business objective information may be varied and/or combined in many ways, for example, to “trial and error” model different implementation scenarios, e.g., for the optimization of the final configuration.

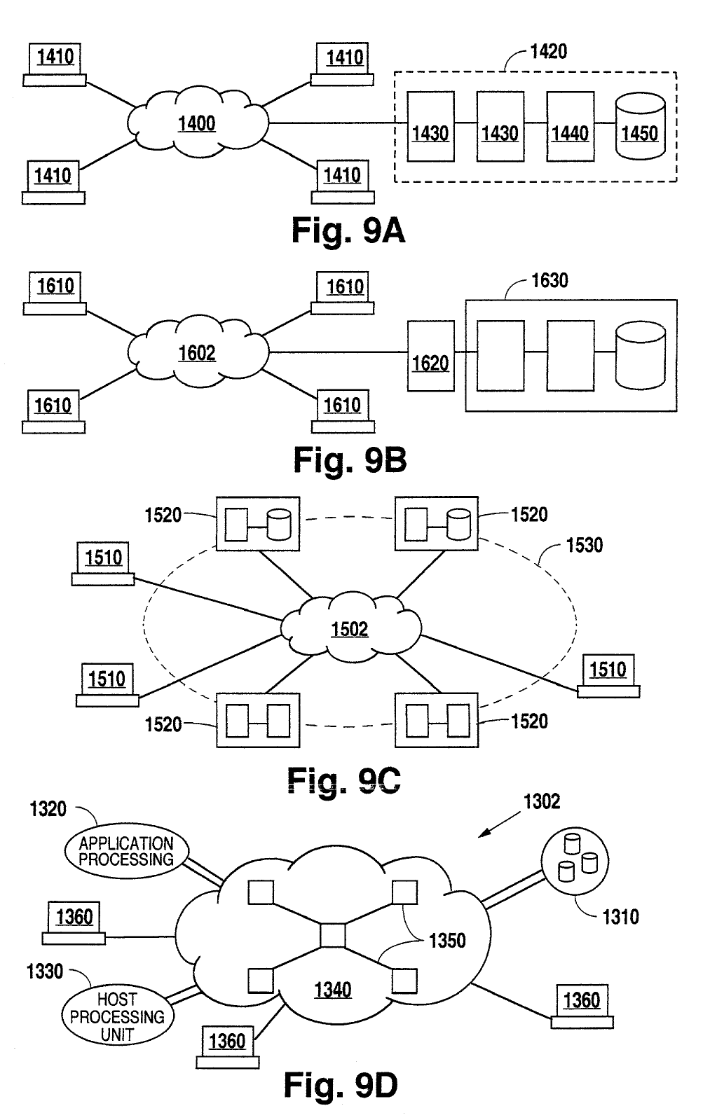

Turning temporarily from FIG. 8 to FIGS. 9A-9D, illustrated are exemplary embodiments of information management configurations of the many different configurations that are possible using the disclosed systems and methods. These exemplary embodiments serve to illustrated just a few of the many configurations in which the disclosed systems and methods may be employed to provide deterministic information management and/or delivery of differentiated services, such as differentiated information services or differentiated business services. In addition to the illustrated embodiments, It will be understood that the disclosed methods and systems described herein (e.g., including the embodiments of FIGS. 9A-9D) may be employed in a variety of network and/or information management environments including, but not limited to, in edge network environments, direct broadcast network environments, etc. For example, the disclosed methods and systems may be implemented in endpoint, intermediate and/or edge node devices that are interconnected to or form a part of an edge network, as well as in one or more nodes within an edge node backbone. In this regard, an edge network may be wired, wireless, satellite-based, etc.

As an example, FIG. 9A illustrates multiple users 1410 that are connected to a network 1400, which may be a LAN or a WAN such as the Internet. An endpoint information management node 1440 (e.g., network endpoint content delivery system) is shown connected to network 1400 via intermediate nodes 1430 that may be, for example, routers, load balancers, web switches, etc. Optional content source 1450 is also shown connected to endpoint information management node 1440. In the embodiment of FIG. 9A, differentiated information services and/or differentiated business services may be delivered to one or more of users 1410 from an origin serving point (e.g., endpoint information management node 1440), for example, when system 1440 is configured as a deterministic system such as that described in relation to FIGS. 1A and 2. In such an embodiment, endpoint information management node controls the information source and may be configured to be capable of handling incoming packets and/or outgoing traffic generated by the incoming packets in a differentiated manner based on parameters or classifications associated with the packets. Such an endpoint information management node may also be capable of marking or tagging outgoing packets with classification information for use by other intermediate or core network nodes.

In an alternate embodiment of FIG. 9A, nodes 1430, 1440 and 1450 of FIG. 9A may be components of an information management data center 1420 or other system capable of performing one or more of the indicated functions in a deterministic manner, for example, as described in relation to FIG. 6. In such a case, differentiated information services and/or differentiated business services may be provided through the data center and delivered to the network core with no other intermediate equipment. Both of the described embodiments of FIG. 9A (i.e., endpoint information management node 1440 or information management data center node 1420) may be configured to manage information (e.g., control system behavior, and serve and deliver content) in a differentiated fashion. Thus, as FIG. 9A indicates, the disclosed systems and methods may be implemented, for example, to provide differentiated service in a content delivery system/server role, or in a device that converges from the content source (e.g., storage disk) to the network.

FIG. 9B illustrates multiple users 1610 that are connected to a network 1602, which may be a LAN or a WAN such as the Internet. Also shown is an intermediate traffic management node 1620 that is present between a conventional data center/content server 1630 and the core of network 1602, and which may be configured to have one more distributive and/or deterministic features of an information management system as described elsewhere herein (e.g., network interface processing engine, etc.). In this embodiment, traffic management node 1620 does not control the information source (e.g., content source) but may be configured as a “gate keeper” to perform such session-aware differentiated service functions or tasks as session-aware service level management, session-aware classification and logging of traffic between the network core and conventional data center/content server 1630. Specific examples of differentiated service functions or tasks that may be performed by such a traffic management node include, but are not limited to, redirection decisions, packet classification, tracking and billing functions relative to traffic flow through traffic management node 1620, policy-equipped router, policy-based switch, etc. Although not shown, it will be understood that other optional intermediate nodes (e.g., edge routers, etc.) may be present between traffic management node 1620 and network 1602 if so desired, that traffic management node 1620 may be subsystem component of a router, etc.

FIG. 9C illustrates multiple edge information management nodes 1520 that are connected to a network 1502, which may be a LAN or a WAN such as the Internet. Also shown are multiple users 1510 that may be connected to network 1502 in a manner similar to that shown in FIGS. 9A and 9B. Edge information management nodes 1520 may be of any system configuration suitable for performing information management functions/tasks, for example, as described elsewhere herein. Specific examples of types of edge information management nodes that are possible include, but are not limited to, edge content delivery nodes, edge application processing nodes, content delivery and/or application processing nodes associated with an edge network, edge content cache and/or replication nodes, etc. As shown, an edge information management node may be configured to interface with network 1502 to receive and fulfill requests for information management, such as content delivery or application processing. In this regard, an edge content delivery node may be configured to have a content source, as well as other processing engines, such as those described in relation to FIGS. 1A and 2, and/or may be configured to perform differentiated service functions or tasks as described elsewhere herein.

In FIG. 9C, multiple edge information management nodes 1520 are shown interconnected with an intelligent signal path or network IPC 1530 that links nodes 1520 in a clustered configuration, for example, in a manner to achieve the benefits and functionalities of clustered configurations described elsewhere herein. In this regard, signal path 1530 represents any communication device or method that is suitable for linking multiple nodes 1520 including, but not limited to, wired connection path, wireless communication path, virtual connection path across network 1502, standards-based signaling techniques, proprietary signaling techniques, combinations thereof, etc. Signal path 1530 may be present as shown to enable deterministic and intelligent communication between the clustered nodes 1520 of FIG. 9C, thus enabling differentiated information services and differentiated business services to be delivered from edge endpoint to the core of network 1502 without the need for intermediate nodes such as routers, load balancers, servers, etc.

It will be understood that two or more nodes 1520 may be physically remote components located in a common facility, such as phone or communication system office with access to various forms of communication, e.g., DSL, wireless, etc. Alternatively, or in addition to physically remote nodes located in a common facility, one or more of nodes 1520 may be physically remote from one or more other nodes located, in separate facilities of the same building, facilities in different buildings within the same campus, etc. Nodes that are physically remote from each other may also include nodes in locations that are geographically remote from each other (e.g., facilities in different buildings within the same city, facilities in different cities, facilities in different states, facilities in different countries, ground and space satellite facilities, etc.) In any case, it is possible that two or more nodes 1520 may be interconnected as part of an edge network configuration.

In one example, the information management embodiment of FIG. 9C may function in a manner that enables a given user 1510 to be served from the particular information management node 1520 that corresponds, for example, to a node containing the specific information requested by the user, a node assigned to particular SLA policies associated with the user or the user's request (e.g., allowing particular nodes 1520 to maintain excess resources for immediately and quickly serving requests associated with high cost/high quality SLA policies), and other nodes 1520 having oversubscribed resources that must be allocated/queued for more slowly serving requests associated with lower cost/lower quality SLA policies, etc.

Also possible are configurations of separate processing engines, such as those of FIG. 1A or 2, that are distributively interconnected across a network, such as a LAN or WAN (e.g., using the disclosed distributed and deterministic system BIOS and/or operating system) to create a virtual distributed interconnect backplane between individual subsystem components across the network that may, for example, be configured to operate together in a deterministic manner as described elsewhere herein. This may be achieved, for example, using embodiments of the disclosed systems and methods in combination with technologies such as wavelength division multiplexing (“WDM”) or dense wavelength division multiplexing (“DWDM”) and optical interconnect technology (e.g., in conjunction with optic/optic interface-based systems), INFINIBAND, LIGHTNING I/O or other technologies. In such an embodiment, one or more processing functionalities may be physically remote from one or more other processing functionalities (e.g., located in separate chassis, located in separate buildings, located in separate cities/countries etc.). Advantageously such a configuration may be used, for example, to allow separate processing engines to be physically remote from each other and/or to be operated by two or more entities (e.g., two or more different service providers) that are different or external in relation to each other. In an alternate embodiment however, processing functionalities may be located in a common local facility if so desired.

FIG. 9D illustrates one possible embodiment of deterministic information management system 1302 having separate processing engines 1310, 1320 and 1330 distributively interconnected across network 1340 that is equipped with fiber channel-based DWDM communication equipment and flow paths 1350 in combination with optic/optic interfaces. In this embodiment, functions or tasks of a system management processing engine may be performed by host processing functionality 1330 located in city A and may include, for example, billing, metering, service level management (SLM) and CDM functions or tasks. Functions or tasks of a storage management processing engine may be performed by storage service provider (SSP)/storage farm functionality 1310 located in city B, functions or tasks of an application processing engine may be performed by application service provider (ASP)/compute farm functionality 1320 located in city C, etc. For example, a request for content may be received from a user 1360 by host processing functionality 1330. Host processing functionality 1330 may then process the request and any SLA-related information associated with the request, and then notify the appropriate storage service provider functionality 1310 to deliver the requested content directly to user 1360. In a similar manner, asymmetric, deterministic and/or direct path information management flow may advantageously occur between any two or more processing engines that may be present on a network and interconnected via a virtual distributed interconnect backplane.

Advantages offered by the network-distributed processing engines of the embodiment of FIG. 9D include the ability of a service provider to focus on one or more particular aspects of service delivery/utility (e.g., content storage, application processing, billing/metering, etc.) without having to worry about other infrastructure components that are maintained by other service providers. Thus, shared resources (e.g., storage capacity, processing capacity, etc.) may be purchased and virtually exchanged (e.g., with usage tracking of same) between service providers on an as-needed basis, thus allowing real time maximization of resource utilization and efficiency, as well as facilitating real time allocation of resources based on relative value to the network community. Advantageously then, a service provider need only consume an amount of a given resource as needed at any given time, and without having to maintain and waste excess resources that would otherwise be required to ensure adequate performance during periods of peak resource demand. Further, a given provider is enabled to sell or exchange any excess resources maintained by the provider during periods of lower demand, if the characteristics of the provider's business change, etc.

It will be understood that the individual components, layout and configuration of FIG. 9D is exemplary only, and that a variety of different combinations and other system configurations are possible. Thus, any number and/or type of system components suitable for performing one or more types of processing engine functions or tasks, may be provided in communication across a network using any connection/interface technology suitable for providing distributed interconnection therebetween, e.g., to allow deterministic information management and/or differentiated services to be provided as described elsewhere herein.

In one embodiment a virtual distributively interconnected system may be configured to allow, for example, system management functions (e.g., such as billing, data mining, resource monitoring, queue prioritization, admission control, resource allocation, SLA compliance, etc.) or other client/server-focused applications to be performed at one or more locations physically remote from storage management functions, application processing functions, single system or multi network management subsystems, etc. This capability may be particularly advantageous, for example, when it is desired to deterministically and/or differentially manage information delivery from a location in a city or country different from that where one or more of the other system processing engines reside. Alternatively or in addition, this capability also makes possible existence of specialized facilities or locations for handling an individual processing engine resource or functionality, or subset of processing engine resources or functionalities, for example, allowing distributed interconnection between two or more individual processing engines operated by different companies or organizations that specialize in such commodity resources or functionalities (e.g., specialized billing company, specialized data mining company, specialized storage company, etc.).

It will be understood that in the delivery of differentiated services using the disclosed systems and methods, including those illustrated in FIGS. 9A-9D, any packet classification technology (e.g., WAN packet classification technology) that is suitable for classifying or differentiating packets of data may be employed to enable such delivery of differentiated services. Such technologies may be employed to allow the disclosed systems and methods to read incoming packet markings/labels representative of one or more policy-indicative parameters associated with information management policy (e.g., class identification parameters, etc.), to allow the disclosed systems and methods to mark or tag outgoing packets with markings/labels representative of one or more policy-indicative parameters associated with information management policy, or a combination thereof. With regard to packet classification technologies, the disclosed differentiated service functionalities may be implemented using principals that are compatible with, or that apply to, any suitable types of layer two through layer seven packet classification technologies including, but not limited to, Ethernet 802.1 P/Q, Diffserv, Ipv6, MPLS, Integrated Services (RSVP, etc.), ATM QoS, etc. In one embodiment, the disclosed systems and methods may be advantageously enabled to perform such packet classification functionalities by virtue of the presence and functionality of a network interface processing engine as is described in relation to FIGS. 1A and 2 herein.

Thus, the disclosed systems and methods may be implemented to not only provide new and unique differentiated service functionalities across any given one or more separate network nodes (e.g., in one or more nodes positioned outside a network core), but may also be implemented in a manner that interfaces with, or that is compatible with existing packet classification technologies when applied to information traffic that enters a network core. However, it will be understood that the disclosed systems and methods may be advantageously implemented to deliver session-aware differentiated service in information management environments that is not possible with existing packet classification technologies and existing devices that employ the same (e.g., that function at the individual packet level, or at the individual packet vs. individual packet level).

It is possible to employ packet classification technologies in a variety of different ways to perform the desired differentiated service functions or tasks for a given implementation, including each of the embodiments illustrated in FIGS. 9A-9D. For example, an endpoint information management system 1440 of FIG. 9A may search incoming packets for tags or markings representative of one or more parameters and handle each such packet according to a policy associated with the parameter/s. In this regard, each incoming packet may be differentially handled, for example, in a deterministic manner as previously described.

Similarly, outgoing packets may be classified by the endpoint information management system 1440 by marking the outgoing packets with labels or tags that are related, for example, to service and/or application information or other parameters associated with the packet, and that indicate how the packet should be handled by one or more other components of the edge and/or core of network 1400. An endpoint information management system 1440 may then deliver the labeled packets to the intermediate nodes 1430 and core of network 1400, where the packet labels may be read by other nodes, such as routers, and routed/treated in a manner dictated by the individual labels or markings associated with each packet (e.g., queue position dictated by MPLS tag, Diffserv tag, Ipv6 tag, etc.). Advantageously, when endpoint information management system 1440 is configured to be application-aware (e.g., as described in relation to the systems of FIGS. 1A and 2), packet classification may advantageously be made in way that is application-aware. A similar packet classification methodology may be employed in data center embodiments, such as data center 1420 of FIG. 9A. In such embodiments, classified outgoing packets may be delivered directly to core component/s of network 1400. It will also be understood, however, that the disclosed systems and methods may be practiced in which one or more conventional types of packet classification functions are performed by external intermediate nodes (e.g., conventional intermediate edge routing nodes), rather than the above-described packet classification functions of the disclosed information management systems, or a combination of the two may be employed.

Similar packet classification methodology may be employed for incoming and/or outgoing packets by edge information management nodes 1520 of FIG. 9C, or by any other information management system of the disclosed systems and methods. It will be understood with benefit of this disclosure that classification methodology may be selected to fit the needs or characteristics of a particular network configuration. For example, outgoing packet classification as described above may be particularly desirable in the case of a network having limited core resources. On the other hand, outgoing packet classification may not be as desirable in the case of network having substantially unlimited core resources.

Returning now to FIG. 8, once objectives and system configuration have been defined in steps 1210 and 1220, an information management system may be assembled/manufactured according to the system configuration, purchased and installed as shown in step 1230 of FIG. 8. As previously described, a system may be installed in an HSP facility to provide differentiated business services for one or more tenants.

After an information system has been purchased and installed in step 1230, provisioning of system service parameters may be made in step 1240. Examples of such parameters include, but are not limited to, aggregate bandwidth ceiling, internal and/or external service level agreement (“SLA”) policies (e.g., policies for treatment of particular information requests based on individual request and/or individual subscriber, class of request and/or class of subscriber, including or based on QoS, CoS and/or other class/service identification parameters associated therewith, etc.), admission control policy, information metering policy, classes per tenant, system resource allocation (e.g., bandwidth, processing and/or storage resource allocation per tenant and/or class for a number of tenants and/or number of classes, etc.), etc.

Any parameter or combination of parameters suitable for partitioning system capacity, system use, system access, etc. in the creation and implementation of SLA policies may be considered. In this regard, the decision of which parameter(s) is/are most appropriate depends upon the business model selected by the host utilizing the system or platform, as well as the type of information manipulation function/s or applications (e.g., streaming data delivery, HTTP serving, serving small video clips, web caching, database engines, application serving, etc.) that are contemplated for the system.

Examples of capacity parameters that may be employed in streaming data delivery scenarios include, but are not limited to delivered bandwidth, number of simultaneous N kbit streams, etc. Although delivered Mbit/s is also a possible parameter upon which to provision and bill non-streaming data applications, an alternate parameter for such applications may be to guarantee a number (N) of simultaneous connections, a number (N) of HTTP pages per second, a number (N) of simultaneous video clips, etc. In yet another example, an network attached storage (“NAS”) solution may be ported to an information management system platform. In such a case, files may be delivered by NFS or CIFS, with SLA policies supplied either in terms of delivered bandwidth or file operations per second. It will be understood that the forgoing examples are exemplary and provided to illustrate the wide variety of applications, parameters and combinations thereof under with which the disclosed systems and methods may be advantageously employed.

Referring to FIG. 8 in more detail, a description of exemplary system service parameters that may be defined and provisioned in step 1240 follows. System bandwidth ceiling may be provisioned at step 1240, and may represent a desired bandwidth ceiling defined by a Tenant or HSP that is below the actual system bandwidth ceiling capability. For example, a system may be capable of supporting a maximum bandwidth of from 335 Mbps (20 Kbps×16,800 connections) to 800 Mbps (1 Mbps×800 connections), but the Tenant or HSP may elect to place a bandwidth ceiling underneath these maximums.

SLA policies that may be created at step 1240 may be based on any parameter or combination of parameters suitable, for example, for the creation of a useful business model for ISP/enterprise. Examples of SLA policies include, but are not limited to, class/service identification parameters such as CoS, QoS, combinations thereof, etc. A combination or sum of CoS and QoS may be used to define an SLA per class or flow (subscriber) within a system. Thus, in one embodiment, policy options may be stored in the system, and acted upon relative to state information within the system architecture, such as information on resource availability and/or capability. Examples of other SLA policies that may that may be created in step 1240 include, but are not limited to, protocols for receipt, adherence and acknowledgment of requests for information such as content. For example, a content delivery system may be configured to receive an SLA request from another network element (e.g., including, for example, CoS and QoS requirements), and to respond back to the external entity with available service alternatives based on the available system resources and the SLA requirements of the request. The system may then be configured to receive explicit selection of alternative from the external entity, and to take action on the connection request based thereon.

SLA policies may be internally maintained (e.g., database policy maintained within an information management system), may be externally maintained (e.g., maintained on external network-connected user policy server, content policy server, etc.), or may be a combination thereof. Where external SLA information is employed or accessed by one or more processing engines of an information management system, suitable protocols may be provided to allow communication and information transfer between the system and external components that maintain the SLA information.

SLA policies may be defined and provisioned in a variety of ways, and may be based on CoS and QoS parameters that may be observed under a variety of congestion states. For example, both single class-based and multiple class-based SLAs (e.g., three SLAs per class, etc.) are possible. Alternatively, an SLA may be defined and provisioned on a per-subscriber or per-connection basis. Furthermore, SLA policy definition and adherence management may be applied to subscribers or content, for example, in a manner that enables a content owner to force a particular SLA policy to all sessions/flows requesting access to a particular piece of content or other information.

SLA policies may also be implemented to distinguish different CoS's based on a variety of different basis besides based on content (e.g., content-aware service level agreements). For example, in the case of platform serving applications, the CoS may be based upon application. For a platform serving HTTP as multiple hosts, the CoS may be based upon host. NAS applications may also be based easily on content, or upon host (volume) in the case of one platform serving many volumes. Other CoS basis may include any other characteristic or combination of characteristics suitable for association with CoS, e.g., time of day of request, etc.

Further, it is also possible to direct a system or platform to create classes based on subscriber. For example, a system login may be required, and a user directed to a given URL reflective of the class to which the user belongs (e.g., gold, silver, bronze, etc.). In such an implementation, the login process may be used to determine which class to which the user belongs, and the user then directed to a different URL based thereon. It is possible that the different URL's may all in fact link ultimately to the same content, with the information management system configured to support mapping the different URL's to different service levels.

In yet other examples, more simplistic CoS schemes may be employed, for example, defining CoSs through the use of access control lists based on IP address (e.g., ISP service log-ins, client side metadata information such as cookies, etc.),. This may be done manually, or may be done using an automated tool. Alternatively, a service class may be created based on other factors such as domain name, the presence of cookies, etc. Further, policies may be created that map priority of incoming requests based on TOS bits to a class of service for the outbound response. Similarly, other networking methods may be used as a basis for CoS distinction, including MPLS, VLAN's, 802.1P/Q, etc. Thus, it will be understood that the forgoing examples are exemplary only, and that SLAs may be implemented by defining CoSs based on a wide variety of different parameters and combinations thereof, including parameters that are content-based, user-based, application-based, request-based, etc.

In one exemplary embodiment, a number n of single Tenant per system classes of service (CoS) may be defined and provisioned at step 1240 (e.g., where n=from about 1 to about 32). In this regard, a single CoS may be considered an aggregate amount of bandwidth to be allocated to a number of connections when congestion dictates that bandwidth and system resource allocation decisions must be made. For example, a single CoS may be an aggregate bandwidth allocated to a number of connections m, e.g., where m=from about 1 to about 16,800. QoS may be considered a packet loss/latency provision that may, for example, be assigned or provisioned on a per subscriber or per CoS basis, either alone or in combination with other QoS policies, as will be described in more detail below. For content delivery embodiments, characteristics of QoS policy may also be selected based on type of content (e.g., minimum loss/latency policy for non-continuous content delivery, zero loss/latency policy for continuous content delivery, etc.).

Policies such as per flow even egress bandwidth consumption (traffic shaping) may be defined and provisioned in step 1240, for example, for each CoS according to one or more possible network class types: Three specific examples of such possible class types are as follows. 1) Sustained rate (bps) provisioned to be equal to peak rate, i.e., so that available bandwidth is not oversubscribed within the CoS so that packets do not see any buffer delay. This may be described as being analogous to a continuous bit rate (“CBR”) connection. 2) Sustained rate (bps) allocated below its peak rate and oversubscribed within the CoS, i.e., bandwidth is allocated statistically. This may be described as being analogous to a variable bit rate (“VBR”) connection. In such a VBR embodiment, over-subscription may be controlled through the review of sustained and peak rate provisioning for individual connections, as well as the system aggregate of sustained and peak rate within the class. 3) No provisioned sustained or peak bandwidth per connection where class aggregate bandwidth is the only parameter provisioned and controlled, i.e., any number of connections, up to the maximum number set for a given class, are allowed to connect but must share the aggregate bandwidth without sustained or peak protection from other connections within the same class. This may be described as being analogous to a “best effort” class connection. It will be understood that the possible class types described above are exemplary only, and that other class types, as well as combinations of two or more class types may be defined and provisioned as desired.

In another exemplary embodiment, bandwidth allocation, e.g., maximum and/or minimum bandwidth per CoS, may be defined and provisioned in step 1240. In this regard, maximum bandwidth per CoS may be described as an aggregate policy defined per CoS for class behavior control in the event of overall system bandwidth congestion. Such a parameter may be employed to provide a control mechanism for connection admission control (“CAC”), and may be used in the implementation of a policy that enables CBR-type classes to always remain protected, regardless of over-subscription by VBR-type and/or best effort-type classes. For example, a maximum bandwidth ceiling per CoS may be defined and provisioned to have a value ranging from about 0 Mbps up to about 800 Mbps in increments of about 25 Mbps. In such an embodiment, VBR-type classes may also be protected if desired, permitting them to dip into bandwidth allocated for best effort-type classes, either freely or to a defined limit.

Minimum bandwidth per CoS may be described as an aggregate policy per CoS for class behavior control in the event of overall system bandwidth congestion. Such a parameter may also be employed to provide a control mechanism for CAC decisions, and may be used in the implementation of a policy that enables CBR-type and/or VBR-type classes to borrow bandwidth from a best effort-type class down to a floor value. For example, a floor or minimum bandwidth value for a VBR-type or for a best effort-type class may be defined and provisioned to have a value ranging from about 0 Mbps up to 800 Mbps in increments of about 25 Mbps.

It will be understood that the above-described embodiments of maximum and minimum bandwidth per CoS are exemplary only, and that values, definition and/or implementation of such parameters may vary, for example, according to needs of an individual system or application, as well as according to identity of actual per flow egress bandwidth CoS parameters employed in a given system configuration. For example an adjustable bandwidth capacity policy may be implemented allowing VBR-type classes to dip into bandwidth allocated for best effort-type classes either freely or to a defined limit. Other examples of bandwidth allocation-based CoS policies that may be implemented may be found in Examples 1-3 disclosed herein.

As previously mentioned, a single QoS or combination of QoS policies may be defined and provisioned on a per CoS, or on a per subscriber basis. For example, when a single QoS policy is provisioned per CoS, end subscribers who “pay” for, or who are otherwise assigned to a particular CoS are treated equally within that class when the system is in a congested state, and are only differentiated within the class by their particular sustained/peak subscription. When multiple QoS policies are provisioned per CoS, end subscribers who “pay” for, or who are otherwise assigned to a certain class are differentiated according to their particular sustained/peak subscription and according to their assigned QoS. When a unique QoS policy is defined and provisioned per subscriber, additional service differentiation flexibility may be achieved. In one exemplary embodiment, QoS policies may be applicable for CBR-type and/or VBR-type classes whether provisioned and defined on a per CoS or on a per QoS basis. It will be understood that the embodiments described herein are exemplary only and that CoS and/or QoS policies as described herein may be defined and provisioned in both single tenant per system and multi-tenant per system environments.

Further possible at step 1240 is the definition and provisioning of CAC policies per CoS, thus enabling a tenant or HSP to define policies for marginal connection requests during periods of system congestion. In this regard, possible policy alternatives include acceptance or rejection of a connection within a particular requested class. For example, a particular request may be accepted within a class up to a sustained bandwidth ceiling limitation for that class. As previously described, sustained bandwidth allocation may be equal to peak bandwidth allocated for a CBR-type class. For a VBR-type class, sustained bandwidth allocation may be less than allocated peak bandwidth and may be defined as a percentage of total bandwidth allocated. In the event the sustained bandwidth limitation has been exceeded, one or more different CAC policies may be implemented. For example, a connection may be rejected altogether, or may be rejected only within the requested class, but offered a lower class of service. Alternatively, such a connection may be accepted and other active connections allowed to service degrade (e.g., unspecified bit rate “UBR”, etc.). As described elsewhere herein, resource state information (e.g., resource availability, capability, etc.) may be considered in the decision whether to accept or reject particular requests for information, such as particular subscriber requests for content. Resources may also be re-allocated or exchanged as desired to support particular requests, e.g., borrowed from lower class to support higher class request, stolen from lower class to support higher class request, etc. Alternatively, requests may be redirected to alternative systems or nodes.

Summarizing with respect to step 1240, priority-indicative class/service identification parameters may be assigned to indicate the priority of service that a client on an external network is to receive, and a system may be provided with policies in step 1240 to prioritize and manage incoming and/or outgoing data and communication traffic flow through the system based on the characteristics of the class/service identification parameters associated therewith. Examples of such policies include, but are not limited to, policies capable of directing priority of system information retrieval from storage to satisfy a particular request having a class/service identification parameter relative to other pending requests for information, policies associating maximum time frame values for delivery of content based on class/service identification parameters associated with a particular request, and disposal of such a request based on the availability of system resources and the characteristics of the particular class/service identification parameters associated with the request.

Further, admission control policies may be provisioned in step 1240 as previously described to consider, for example, the above-described class/service identification parameters, separate admission control policy priority parameters associated with particular information requests, current resource availability of the system, and/or may be implemented to consider one or more inherent characteristics associated with individual requests (e.g., type of information requested, resources required to satisfy a particular information request, identity of information requestor, etc.).

In one embodiment, an optional provisioning utility may be provided that may be employed to provide guidance as to the provisioning of a system for various forms of service level support. For example, a host may initially create SLA policies in step 1240 using the optional provisioning tool which identifies provisioning issues during the process. In such an implementation, the provisioning tool may be provided to inform the host if policies have been selected that conflict, that exceed the capacity of the system platform as currently configured, etc.. For example, a host may be defining policies based on bandwidth allocation, but fail to recognize that the system storage elements lack the capacity to handle the guaranteed rates. The optional provisioning utility may inform the host of the conflict or other provisioning issue. Further, the utility may be configured to provide suggestions to resolve the issue. For example, under the above scenario the utility may suggest adding more mirrors, adding another FC loop, etc. In addition, a provisioning utility may be further configured to function in real time, for example, to assist and guide a host in making changes in service level provisioning after a system is placed in operation. Such real time provisioning may include optimization of SLA policies based on actual system performance and/or usage characteristics, changes to SLA policies as otherwise desired by user and/or host, etc. Specific examples include, but are not limited to, configuration of service quality per subscriber, class, tenant, box, etc.; decisions to allow over-provisioning; decisions to allow over-provisioning in combination with re-direction of new requests, etc. In yet a further embodiment, such a provisioning utility may be adapted to analyze and provide suggested changes to service level provisioning based on actual system performance.

Step 1250 of FIG. 8 illustrates how system performance parameters related to information management, such as content delivery, may be differentially monitored. As indicated, monitoring may include both real time and historical tracking of system performance. System performance parameters that may be so monitored or tracked include, but are not limited to, resource availability and/or usage, adherence to provisioned SLA policies, content usage patterns, time of day access patterns, etc. As will be further described, such parameters may be monitored on the basis of the characteristics of a particular hardware/software system configuration, characteristics of an individual session, characteristics of a particular class, characteristics of a particular subscriber, characteristics of a particular tenant, subsystem or system performance, individual resource consumption, combinations thereof, etc. For example, service monitoring step 1250 may be performed on a system basis (e.g., single box/chassis configuration, data center configuration, distributed cluster configuration, etc.), performed on a per tenant basis (e.g., in the case of multiple tenants per system), performed on a per class basis (e.g., in the case of multiple classes per tenant), performed on a per subscriber basis (e.g., in the case of multiple subscribers per class), or a combination thereof. Thus, in one embodiment, service monitoring may be performed in a manner that considers each of the forgoing levels (i.e., service monitoring for a particular subscriber of particular class of a particular tenant of a particular system).

Adherence to SLA policies may be monitored for an individual session or flow in real time and/or on a historical basis. In one exemplary embodiment, SLA adherence may be monitored or tracked by measuring packet throughput relative to sustained and peak rates per connection. For example, throughput statistics may be captured in specified time intervals (e.g., five-minute increments). In another example, behavior of a particular class relative to aggregate assigned sustained and peak bandwidth allocation may be monitored or tracked in real time, or may be monitored or tracked over a period of time (e.g., ranging from one hour to one day in one hour increments). In yet another example, behavior of an individual subsystem or an entire system relative to aggregate assigned sustained and peak bandwidth allocation may be monitored or tracked in real time, or may be monitored or tracked over a period of time (e.g., ranging from one hour to one day in one hour increments).

It will be understood that the forgoing examples of adherence monitoring are exemplary only, and that a variety of other parameters and combinations of parameters may be monitored or tracked in step 1250 of FIG. 8. Furthermore, it will be understood that monitored parameters may be displayed or otherwise communicated or recorded in any suitable manner. For example, current bandwidth consumption may be monitored in real time and presented, for example, via graphical user interface (“GUI”), data file, external report, or any other suitable means.

Also illustrated in FIG. 8 is information processing management step 1260, which may include managing disposition and/or prioritization of information manipulation tasks, such as any those of those information manipulation tasks described elsewhere herein. In this regard, information processing management step 1260 may involve system, inter-system and/or subsystem management of tasks including, but not limited to, admission control, resource allocation, queue prioritization, request transfer, etc. Furthermore, information manipulation tasks may be managed based on class/service identification parameters associated with particular information and/or requests for the same including, but not limited to, SLA policies or CoS/QoS parameters that may be defined and provisioned, for example, as described in relation to step 1240. As described elsewhere herein, such parameters may be defined and provisioned based on virtually any characteristic or combinations of characteristic associated with a particular information manipulation task including, but not limited to, identity or class of user or request, type of request, resource requirement associated with a particular request, etc.

As illustrated in FIG. 8, information processing management step 1260 may optionally utilize performance monitoring information obtained in step 1250, for example, to help make real time information processing management decisions (e.g., based on subsystem, resource, and/or overall system behavior or usage), to adjust processing management behavior based on real time or historical monitored service levels (e.g., to bring service level into adherence with SLA policy), etc.

In service reporting step 1270, a wide variety of performance and/or resource usage information may be collected and reported or otherwise communicated for the use of HSP, Tenants, Subscribers, etc. Such information may be utilized, for example, for purposes related to billing, demonstrating SLA policy adherence, system performance optimization, etc. and may be reported via GUI, data file, external report, or using any other suitable means (e.g., reports viewable through in-system WEB-based GUI or through external Report Writer/Viewer utility). Information that may be reported in step 1270 includes virtually any type of information related to operating or usage characteristics of an information management system, its subsystems and/or its resources, as well as information related to processing of individual requests or classes of requests, such as application and/or SLA performance.

Reporting functions possible in step 1270 include, but are not limited to, generation of any type of billing report based at least in part on collected performance and/or resource usage information, from generation of intermediate level reports (e.g., flat file reports, etc.) that third party entities may use to convert to desired billing format, to generation of finalized billing reports that may be forwarded directly to customers. Also possible are third party agents or client devices configured to receive billing information from the disclosed systems and configured to convert the information into desired format for passing onto a billing server. Such a scheme is also possible in which the disclosed systems are configured to output the billing information in desired format for transmittal to a billing server, without the need for a third party client.

In one example, service configuration information may be reported, and may include all configured attributes such as CoSs and their parameters, QoSs and their parameters, individual subscriber SLAs, system resource consumption, etc. System performance information may also be reported and may include, for example, periodic (e.g., hourly, daily, monthly, etc.) totals of system resource utilization metrics. Application or SLA performance data may also be reported and may include information related to SLA activity, such as packets transmitted, packets dropped, latency statistics, percentage of time at or below sustained level, percentage of time above sustained and at or below peak level, etc. In this regard, application or SLA performance data may also be reported on a periodic basis (e.g., hourly, daily, monthly totals, etc.). SLA performance data may also be reported, for example, as aggregate performance statistics for each QoS, CoS and system as whole.

Types of billing information that may be reported in step 1270 includes, but is not limited to, any type of information related to consumption or use of one or more system resources. In this regard, billing information may be generated on any desired detail level, for example, anywhere from a per-subscriber, per-request or per transaction basis to a per-class or per-tenant basis. Billing information may also be generated based on any desired fee basis, e.g., fixed per use basis, relative resource consumption basis, percentage-service guarantee basis, time of day basis, SLA conformance basis, performance level basis, combinations thereof, etc. Advantageously, billing basis may be static and/or dynamic as described further herein.

Examples of static resource consumption based billing include both application level billing information and system resource level billing information. Specific examples include, but are not limited to, static billing parameters such as fixed or set fees for processing cycles consumed per any one or more of subscriber/class/tenant/system, storage blocks retrieved per any one or more of subscriber/class/tenant/ system, bandwidth consumed per any one or more of subscriber/class/tenant/system, combinations thereof, etc. Advantageously, resource consumption based billing is possible from any information source location (e.g., content delivery node location, application serving node location, etc.) using the disclosed systems and methods, be it a origin or edge storage node, origin or edge application serving node, edge caching or content replication node, etc.

Examples of dynamic billing basis include, but are not limited to, SLA conformance basis billing such as standard rate applied for actual performance that meets SLA performance guarantee with reduced billing rate applied for failure to meet SLA performance guarantee, sliding scale schedule providing reductions in billing rate related or proportional to the difference between actual performance and SLA performance guarantee, sliding scale schedule providing reductions in billing rate related or proportional to the amount of time actual performance fails to meet SLA performance guarantee, combinations thereof, etc. Other examples of dynamic billing basis include performance level basis billing, such as sliding scale schedule providing multiple billing rate tiers that are implicated based on actual performance, e.g., higher rates applied for times of higher system performance and vice-versa.

Furthermore, SLA performance information may be used as a billing basis or used to generate a fee adjustment factor for billing purposes. As is the case for other types of information, information necessary for generating billing information and billing information itself, may be reported on a periodic basis (e.g., hourly, daily, monthly totals, etc.) if so desired.

In one embodiment, standard bandwidth information may be reported as billing data and may reflect, for example, allocated sustained and peak bandwidth per subscriber, percentage of time at or below sustained bandwidth level, percentage of time above sustained bandwidth level and at or below peak bandwidth level, etc. In another embodiment, content usage information may be tracked and reported including, but not limited to, information on identity and/or disposition of content requests. Specific examples of such information includes, for example, record of content requests honored/rejected, record of content requests by subscriber, content request start time and content request fulfillment finish time, etc.

Among the many advantages offered by the differentiated service methodology of the embodiment illustrated in FIG. 8 is the capability of providing value-added and flexible SLA policies and “no penalty” service management capabilities that may make possible, among other things, competitive service differentiation and enhanced revenue generation. As used herein, “no penalty” is used to describe a capability (e.g., differentiated service infrastructure capability) that may be offered in conjunction with basic information management functions (e.g., content delivery, service delivery) with little or substantially no increase in required application/subsystem processing time relative to processing time required to perform the basic information management function alone. Just a few examples of specific flexible SLA policies that may be so provided include, but are not limited to, guaranteed system and/or subscriber capacity support, QoS assurance, CoS, adaptive CoS, etc. Examples of real time “no penalty” service management capabilities include, but are not limited to, configuration, capacity planning, system and application performance monitoring, billing, usage tracking, etc.

In one embodiment, these advantageous characteristics are made possible by employing system-aware and/or subsystem-aware application program interfaces (“APIs”), so that state and load knowledge may be monitored on a system and/or subsystem basis and application decisions made with real time, intimate knowledge concerning system and/or subsystem resources, for example, in a deterministic manner as described elsewhere herein. In this regard, “no penalty” state and load management may be made possible by virtue of API communication that does not substantially consume throughput resources, and may be further enhanced by conveyance IPC communication protocol that supports prioritized I/O operations (i.e., so that higher priority traffic will be allowed to flow in times of congestion) and overcomes weaknesses of message-bus architectures. Furthermore, features such as application offloading, flow control, and rate adaptation are enhanced by the true multi-tasking capability of the distributively interconnected asymmetrical multi-processor architectures described elsewhere herein. Among other things, these extensible and flexible architectures make possible optimized application performance including allowing application-aware scalability and intelligent performance optimization. Other advantages that may be realized in particular implementations of systems with these architectures include, but are not limited to, reduced space and power requirements as compared to traditional equipment, intelligent application ports, fast and simple service activation, powerful service integration, etc.

As previously described, differentiated business services, including those particular examples described herein, may be advantageously provided or delivered in one embodiment at or near an information source (e.g., at a content source or origin serving point or node, or at one or more nodes between a content source endpoint and a network core) using system embodiments described herein (e.g., FIGS. 1A or 2), or using any other suitable system architecture or configuration. In one embodiment, a network core may be the public Internet and an associated information source may be, for example, a capacity-constrained content source such as storage network, storage virtualization node, content server, content delivery data center, edge content delivery node, or similar node in communication with the network core. In this embodiment, differentiated business services may be provided to allocate resources and/or costs at the content source and/or at a point or node anywhere between the content source and the network core, even in those cases where the core and last mile of the network provide relatively inexpensive and unlimited bandwidth and other resources for content delivery. Thus, a method of differentiating business services outside of a network core, and/or at a location upstream of the core is advantageously provided herein. The ability to differentiate business services under such circumstances provides a method for allocating resources and enhancing revenue generation that is not available using conventional network systems and methods.

Although the delivery of differentiated business services may be described herein in relation to exemplary content delivery source embodiments, the practice of the disclosed methods and systems is not limited to content delivery sources, but may include any other type of suitable information sources, information management systems/nodes, or combinations thereof, for example, such as application processing sources or systems. For example, the description of content delivery price models and content delivery quality models is exemplary only, and it will be understood that the same principals may be employed in other information management embodiments (e.g., application processing, etc.) as information management price models, information management quality models, and combinations thereof. Further, the disclosed systems and method may be practiced with information sources that include, for example, one or more network-distributed processing engines in an embodiment such as that illustrated in FIG. 9D, for example. Such network-distributed information sources may also be described as being outside the network core.

In one differentiated content delivery embodiment, the disclosed differentiated business services may be implemented to provide differentiated services at a content source based on one or more priority-indicative parameters associated with an individual subscriber, class of subscribers, individual request or class of request for content, etc. Such parameters include those types of parameters described elsewhere herein (e.g., SLA policy, CoS, QoS, etc.), and may be user-selected, system-assigned, predetermined by user or system, dynamically assigned or re-assigned based on system/network load, etc. Further, such parameters may be selected or assigned on a real time basis, for example, based on factors such as subscriber and/or host input, network and/or system characteristics and utilization, combinations thereof, etc. For example, a content subscriber may be associated with a particular SLA policy or CoS for all content requests (e.g., gold, silver, bronze, etc.) in a manner as previously described, or may be allowed to make real time selection of desired SLA policy or CoS on a per-content request basis as described further herein. It will be understood that the forgoing description is exemplary only and that priority indicative parameters may be associated with content delivery or other information management/manipulation tasks in a variety of other ways.

In one exemplary implementation of user-selected differentiated content delivery, a user may be given the option of selecting content delivery (e.g., a theatrical movie) via one of several pre-defined quality models, price/payment models, or combination thereof. In such an example, a high quality model (e.g., gold) may represent delivery of the movie to the subscriber with sufficient stream rate and QoS to support a high quality and uninterrupted high definition television (“HDTV”) presentation without commercials or ad insertion, and may be provided to the subscriber using a highest price payment model. A medium quality model (e.g., silver) may be provided using a medium price payment model and may represent delivery of the movie to the subscriber with a lower stream rate and QoS, but without commercials or ad insertion. A lowest quality model (e.g., bronze) may be provided using a lowest price payment model and may represent delivery of the movie to the subscriber with a lower stream rate and QoS, and with commercials or ad insertion. Quality/price models may so implemented in a multitude of ways as desired to meet needs of particular information management environments, e.g., business objectives, delivery configurations (e.g., movie download delivery rather than streaming delivery), etc.

When user selectable quality/price models are offered, a subscriber may choose a particular quality model based on the price level and viewing experience that is desired, e.g., gold for a higher priced, high quality presentation of a first run movie, and bronze for a lower priced, lower quality presentation of a second run movie or obscure sporting event, e.g. such as will be played in the background while doing other things. Such a selection may be may be based on a pre-defined or beforehand choice for all content or for particular types or categories of content delivered to the subscriber, or the subscriber may be given the option of choosing between delivery quality models on a real time or per-request basis. In one example, a GUI menu may be provided that allows a subscriber to first select or enter a description of desired content, and that then presents a number of quality/payment model options available for the selected content. The subscriber may then select the desired options through the same GUI and proceed with delivery of content immediately or at the desired time/s. If desired, a subscriber may be given the opportunity to change or modify quality/price model selection after content delivery is initiated. Examples of categories of content that may be associated with different quality and/or price models include, but are not limited to, news shows, situation comedy shows, documentary films, first run movies, popular or “hot” first run movies, old movies, general sports events, popular or “hot” sports events, etc.). Delivery of content at the selected quality/price model may be tracked and billed, for example, using system and method embodiments described elsewhere herein.

In another exemplary embodiment, multiple-tiered billing rates may be offered that are based on information management resource consumption that is controllable or dictated by the user. For example, a user may be offered a first billing rate tier linked to, for example, maximum amount of resource consumption for non-streaming or non-continuous content (e.g., maximum number of website hits/month, maximum number of HTTP files downloaded per month, maximum number of bytes of content streamed/month or downloaded/month from NAS, maximum amount of processing time consumed/month, etc.). In such an embodiment, resource consumption below or up to a defined maximum consumption rate may be delivered for a given flat fee, or may be delivered at a given cost per unit of resource consumption. One or more additional billing rate tiers (e.g., incremental flat fee, higher/lower cost per unit of resource consumption, etc.) may be triggered when the user's resource consumption exceeds the first tier maximum resource consumption level. It will be understood that such an embodiment may be implemented with a number of different billing rate tiers, and that more than two such billing rate tiers may be provided.

In another exemplary embodiment for content delivery, content delivery options may be offered to subscribers that are customized or tailored based on network and/or system characteristics such as network infrastructure characteristics, system or subsystem resource availability, application mix and priority, combinations thereof, etc. For example, a subscriber's last mile network infrastructure may be first considered so that only those content delivery options are offered that are suitable for delivery over the particular subscriber's last mile network infrastructure (e.g., subscriber's local connection bandwidth, computer processor speed, bandwidth guarantee, etc.). Such infrastructure information may be ascertained or discovered in any manner suitable for gathering such information, for example, by querying the subscriber, querying the subscriber's equipment, querying metadata (e.g., cookies) contained on the subscriber's computer, xSP, policy server, etc.

In one example, this concept may be applied to the user selectable quality/price model embodiment described above. In such a case, a subscriber with relatively slow dial-up or ISDN network access, and/or having a relatively slow computer processor, may only be given the option of a lowest quality model (e.g., bronze) due to restricted maximum stream rate. In another example, a subscriber may be provided with a plurality of content delivery options and recommendations or assessments of, for example, those particular content delivery options that are most likely to be delivered to the individual subscriber at high performance levels given the particular subscriber's infrastructure, and those that are not likely to perform well for the subscriber. In this case, the subscriber has the option of making an informed choice regarding content delivery option. The above approaches may be employed, for example, to increase the quality of a subscriber's viewing experience, and to reduce possible disappointment in the service level actually achieved.

In another example, customized or tailored content delivery options may be offered to subscribers based on characteristics associated with a particular request for content. In such an implementation, payment model and/or quality model may be host-assigned, system-assigned, etc. based on characteristics such as popularity of the requested content, category/type of the requested content (e.g., first run movie, documentary film, sports event, etc.), time of day the request is received (e.g., peak or off-time), overall system resource utilization at the time of the requested content delivery, whether the request is for a future content delivery event (e.g., allowing pre-allocation of necessary content delivery resources) or is a request for immediate content delivery (e.g., requiring immediate allocation of content delivery resources), combinations thereof, etc. For example, “hot” content such as highly popular first run movies and highly popular national sporting events that are the subject of frequent requests and kept in cache memory may be assigned a relatively lower price payment model based on the cost of delivery from cache or edge content delivery node, whereas more less popular or obscure content that must be retrieved from a storage source such as disk storage may be assigned a higher price payment model to reflect higher costs associated with such retrieval. Alternatively, it may be desirable to assign payment models and/or quality models based on a supply and demand approach, i.e., assigning higher price payment models to more popular content selections, and lower price payment models to less popular content selections. Whatever the desired approach, assignment of payment models may advantageously be made in real time based on real time resource utilization, for example, using the differentiated service capabilities of the disclosed systems and methods.

By offering customized or tailored content delivery options as described above, content may be made available and delivered on price and quality terms that reflect value on a per-request or per-content selection basis, reducing transaction costs and allowing, for example, content providers to recover costs required to maintain large libraries of content (e.g., a large number of theatrical movies) for video on demand or other content delivery operations. The disclosed methods thus provide the ability to match price with value and to recover content storage/delivery costs. This ability may be advantageously implemented, for example, to allow a large number of content selections to be profitably stored and made available to subscribers, including highly popular content selections as well as obscure or marginally popular content selections.

Utilizing the systems and methods disclosed herein makes possible the delivery of differentiated service and/or deterministic system behavior across a wide variety of application types and system configurations. Application types with which the disclosed differentiated service may be implemented include I/O intensive applications such as content delivery applications, as well as non-content delivery applications.

Advantageously, the disclosed systems and methods may be configured in one embodiment to implement an information utility service management infrastructure that may be controlled by an information utility provider that provides network resources (e.g., bandwidth, processing, storage, etc.). Such an information utility provider may use the capabilities of the disclosed systems and methods to maintain and optimize delivery of such network resources to a variety of entities, and in a manner that is compatible with a variety of applications and network users. Thus, network resources may be made available to both service providers and subscribers in a manner similar to other resources such as electricity or water, by an information utility provider that specializes in maintaining the network infrastructure and its shared resources only, without the need to worry or to become involved with, for example, application-level delivery details. Instead, such application-level details may be handled by customers of the utility (e.g., application programmers, application developers, service providers, etc.) who specialize in the delivery and optimization of application services, content, etc. without the need to worry or to become involved with network infrastructure and network resource details, which are the responsibility of the utility provider.

The utility provider service management characteristics of the above-described embodiment is made possible by the differentiated service capabilities of the disclosed systems and methods that advantageously allow differentiated service functions or tasks associated with the operation of such a utility (e.g., provisioning, prioritization, monitoring, metering, billing, etc.) to be implemented at virtually all points in a network and in a low cost manner with the consumption of relatively little or substantially no extra processing time. Thus, optimization of network infrastructure as well as applications that employ that infrastructure is greatly facilitated by allowing different entities (e.g., infrastructure utility providers and application providers) to focus on their individual respective specialties.

In one exemplary content delivery embodiment, such a utility provider service management infrastructure may be made possible by implementing appropriate content delivery management business objectives using an information management system capable of delivering the disclosed differentiated information services and that may be configured and provisioned as disclosed herein, for example, to have a deterministic system architecture including a plurality of distributively interconnected processing engines that are assigned separate information manipulation tasks in an asymmetrical multi-processor configuration, and that may be deterministically enabled or controlled by a deterministic system BIOS and/or operating system.

MANAGEMENT OF RESOURCE UTILIZATION

In the practice of the disclosed systems and methods, run-time enforcement of system operations may be implemented in an information management environment using any software and/or hardware implementation suitable for accomplishing one or more of the enforcement tasks described herein. For example, enforcement tasks may be implemented using one or more algorithms running on one or more processing engines of an information management system such as a content delivery system. Examples of such enforcement tasks include, but are not limited to, admission control, overload protection, monitoring of system and subsystem resource state, handling of known and unknown exceptions, arrival rate control, response latency differentiation based on CoS, rejection rate differentiation based on CoS, combinations thereof, etc. In one exemplary embodiment, a system and method for admission control may be provided that is capable of arrival shaping, overload protection, and optional differentiated service enforcement.

Systems with which the disclosed run-time enforcement of system operations may be implemented include, but are not limited to, any of the information management system embodiments described elsewhere herein, including those having multiple subsystems or processing engines such as illustrated and described herein in relation to FIGS. 1A, 1C through 1F, and FIG. 2. Further examples include, but are not limited to, clustered system embodiments such as those illustrated in FIGS. 1G through 1J, and network-distributed system embodiments such as illustrated in FIG. 9D. Examples of such systems are also described in U.S. patent application Ser. No. 09/797,200, filed Mar. 1, 2001 and entitled “SYSTEMS AND METHODS FOR THE DETERMINISTIC MANAGEMENT OF INFORMATION,” by Johnson et al.; and in U.S. patent application Ser. No. 09/797,413, filed Mar. 1, 2001 and entitled “NETWORK CONNECTED COMPUTING SYSTEM,” by Johnson et al., the disclosure of each application being incorporated herein by reference.

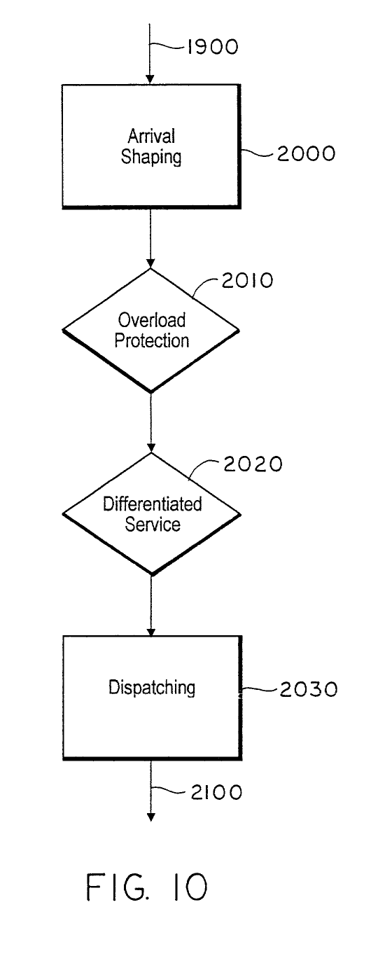

FIG. 10 illustrates one exemplary flowpath that may be utilized to administer admission control according to one embodiment of the systems and methods disclosed herein. As illustrated in FIG. 10, each new client/user request 1900 for information management (e.g., request for content, request for services, etc.) is first processed using arrival shaping policy 2000, before being processed using overload protection policy 2010. Optional differentiated service policy 2020 may be applied to incoming requests that successfully pass overload protection policy 2010, prior to sending each incoming request to dispatching policy 2030 where admitted new requests are forwarded to appropriate subsystems for processing. It will be understood that the embodiment of FIG. 10 is exemplary only, and that any one of policies 2000, 2010, 2020 and/or 2030 may be implemented alone, or in combination with any one or more other policies, described herein or otherwise. Furthermore, it will be understood that the individual steps and policies of FIG. 10 may be implemented, for example, using any software and/or hardware combination including, but not limited to, as one or more algorithms ninning on one or more processing engines or modules.

In one exemplary embodiment, the policies of FIG. 10 may be implemented for each subsystem or processing engine of an information management system (e.g., individual processing engines of a content delivery system of FIG. 1A or 2) by a system monitor 240 or system management (host) engine 1060 such as described elsewhere herein, for example, in relation to FIGS. 1A, 2 and 5. Alternatively, the policies of FIG. 10 may be implemented by one or more individual processing engines themselves, i.e., in addition to, or instead of, by a system monitor 240 or system management (host) engine 1060.

In the practice of the disclosed systems and methods, arrival shaping policy 2000 of FIG. 10 may be implemented, for example, using one or more arrival shaping techniques such as waiting queues, weighted-round-robin scheduling, arrival rate control, and/or selective dropping of new requests when a system is overloaded. In this regard, multiple CoS-based waiting queues may be configured based on the definition of supported classes of service, with each arriving request for information management (e.g., arriving request for streaming content) being directed to an appropriate CoS-based waiting queue based on characteristics of a CoS tag associated with the request. Requests may then be dequeued from each waiting queue using a weighted-round-robin (WRR) algorithm, with it being possible to optionally provide two or more selectable variations of WRR such that a system administrator may select and activate one of them at any time.

In one exemplary embodiment, a defined number of requests are first de-queued from the highest priority queue, then a defined number of requests is dequeued from each successive lower priority queue, with requests in the lowest priority queue being dequeued last. The defined number of requests dequeued from each respective queue may be weighted as desired so as to differentiate between queues, e.g., a larger defined number of requests being dequeued each iteration from any given higher priority queue relative to any given lower priority queue. If so desired, the highest priority queue (or a selected group of higher priority queues) may be dequeued before dequeueing each successive lower priority queue to further prioritize requests in higher priority queues. Dequeueing rate may be optionally shaped, for example, based on a maximum arrival rate value that may be a configurable value if so desired. Maximum queue size thresholds may be optionally associated with one or more of the waiting queues, and request-dropping policies may be invoked in the event the information management system becomes overloaded, e.g., waiting queue size continuing to grow. One exemplary embodiment of multiple CoS waiting queues is described in Example 6 herein.

Still referring to FIG. 10, overload protection policy 2010 may be implemented, for example, using a resource usage accounting methodology that characterizes resource consumption for various types of information management and/or various types of information manipulation tasks, e.g., in a heterogeneous information management system environment. Examples of such systems include those described elsewhere herein having multiple subsystems (e.g., processing engines) performing distinctive functions with each subsystem having different resource principals (e.g., memory, compute, I/O, bandwidth, number of buffers, number of connections, interfaces, etc.) that possess different usage characteristics. For example, a storage processing engine may be bottlenecked by memory and disk IOPS, but an application processing engine may be bottlenecked by memory and CPU. Furthermore, the usage of memory per stream for an application processing engine may be different from the memory usage for a storage processing engine. To address this heterogeneity, resource management and admission control may be performed using the disclosed systems and methods for each individual subsystem or processing engine, e.g., a new stream request may be admitted if, and only if, all subsystems or processing engines in its path have sufficient resources.

In a heterogeneous information management system environment, resource usage may not have linear relationship to the number of information streams (e.g., content streams) since different bandwidth streams consume different amounts of resources (e.g., a 20 kbps stream consuming much less resource than a 1 mbps stream). Furthermore, differences in resource usage between streams of different bandwidth may not be linearly proportional to the magnitude of the difference in the bandwidth magnitudes (e.g., resource usage for a 1 mbps stream is not equal to 51 (1024/20) times of resource usage for a 20 kbps stream). Thus, the disclosed systems and methods may be implemented in a manner so that resource usage accounting may be performed for each individual subsystem or processing engine, and usage accounting performed for each subsystem or processing engine may be implemented to support non-linear, non-polynomial resource consumption characteristics.

In one embodiment, resource usage accounting may be based on a resource utilization value that is reflective of the system resource consumption required to perform a particular type of information management and/or to accomplish a particular information manipulation task. Such a resource utilization value may also be reflective of system resource consumption required to perform the particular type of information management and/or to accomplish the particular information manipulation task under specified system performance conditions, e.g., performed within a given period of time, performed at a certain system data throughput rate, performed at a given priority with respect to other transactions, performed with respect to specific processing engines, etc.

In one exemplary embodiment, resource usage accounting may be implemented by associating a resource utilization value with a particular type of information management and/or a particular information manipulation task. Such an association may be achieved using any type of methodology suitable for associating a resource utilization value with a particular type of information management and/or a particular information manipulation task. Examples of suitable methods of association include, but are not limited to, look up table associations, etc. Association methods may also be implemented to be configurable, for example, by indicating via pre-configuration data what association methods to use at various loads, various utilization thresholds, on various application types, on various connection types, combinations thereof, etc.

Resource utilization values may be expressed using any unit of measure suitable for representing or reflecting absolute or relative magnitude of resource consumption or utilization for a given system (e.g., information management system) or subsystem thereof (e.g., processing engine). In one embodiment, resource utilization values may be expressed for a subsystem or processing engine in resource capacity utilization units. A resource capacity utilization unit may be characterized as a resource quantification unit which may be used to reflect the overall subsystem capacity based on the interaction of multiple available resource principals, and in one embodiment, based on the interaction of all available resource principals. As used herein, the term “resource principal” represents a specific computing resource including, but not limited to, a resource such as CPU usage, memory usage (RAM), I/O usage, media bandwidth usage, etc. The number of resource capacity utilization units required by a given subsystem (e.g., application processing engine) to support a given information management task (e.g., to support the delivery of one stream of content) may be assigned using any suitable methodology, for example, based on performance analysis as described in Example 4 herein.

For example, overload protection may be implemented in a streaming content delivery environment using a resource capacity utilization unit that is representative of the system resource consumption required to achieve a designated streaming content throughput rate. Such a resource capacity utilization unit may be defined in any suitable terms, and in one exemplary embodiment may be defined as the basic unit of system resources needed to support one kbps throughput (referred to herein as a “str-op”). It will be understood with benefit of this disclosure that embodiments utilizing the resource capacity utilization unit “str-op” are described in the discussion and examples herein for purposes of illustration and convenience only and that the disclosed systems and methods may be practiced in the same manner using any suitable alternative resource capacity utilization unit/s.

In the practice of the disclosed systems and methods, one or more selected resource principals of a given subsystem or processing engine may be quantified to obtain resource utilization status information in the form of specific resource utilization values. Resource principals may be calculated and expressed in any suitable manner that characterizes usage of a particular resource principal for a given subsystem or processing engine. For example, a resource principal may be expressed as a portion (e.g., fraction, percentage) of the total current used resource principal on a given subsystem or processing engine relative to the total available resource principal for that subsystem/processing engine. A resource utilization value may then be calculated from individual resource principal values for each subsystem or processing engine using any method suitable for combining multiple principals into a single resource utilization value including, but not limited to, using an average function (e.g., resource utilization value equals the statistical average of two or more selected separate resource principal values, resource utilization value equals the weighted average of two or more selected separate resource principal values), using a maximum function (e.g., resource utilization value equals the maximum value of two or more selected separate resource utilization values), etc.

Resource utilization values for each subsystem or processing engine may be determined as desired given the characteristics of the given subsystem/processing engine. For example, a resource utilization value for a given subsystem/processing engine may be based on an adjusted total available resource principal that represents the actual total available resource principal for the given subsystem/processing engine less a defined reserve factor for system internal activities that may be selected as needed. For example, a storage processing engine may reserve a certain amount of resources (e.g., a Reserved_Factor equal to about 10%) to support file system activities. Further information on Reserved_Factor may be found in U.S. patent application Ser. No. 09/947,869, filed Sep. 6, 2001 and entitled “SYSTEMS AND METHODS FOR RESOURCE MANAGEMENT IN INFORMATION STORAGE ENVIRONMENTS” by Qiu et. al, the disclosure of which is incorporated herein by reference.

In one embodiment, resource principals may be characterized into multiple categories, based on impact or affect on a given information management system operation. Examples of two such possible categories are: 1) critical resource principals (“CRP”); and 2) influencing resource principals (“IRP”). In such an embodiment, it may be desirable to only use critical resource principals to obtain specific resource utilization values. Alternatively, both critical and influencing resource utilization principals may be employed to obtain resource utilization values, but it may be desirable to differentially weight critical resource principals relative to influencing resource principals so that they have a greater effect on the calculated resource utilization values. Alternatively, influencing resource principals may be averaged in a resource utilization value calculation, while critical resource principals may be subjected to a maximum function in the resource utilization value calculation. In one embodiment, taking the maximum value of the critical resource principal utilization values for a given engine/subsystem may alone be employed for calculation of resource utilization value. However, in other embodiments, averaging may also be employed (e.g., when considering a larger set of resource principals, when considering influencing resource principals, etc.). It will be understood that the identity and number of particular resource principals selected for a given category (e.g., CRP, IRP) may be the same, or may vary, for each processing engine/subsystem depending on the needs and/or characteristics of a particular implementation.

In one exemplary content delivery system embodiment, resource principals that may be considered critical to system operations or processing include compute, memory, and I/O bandwidth (e.g., of buses, of media, etc.). In this embodiment, resource principals that may be considered potentially influencing to system operations or processing include buffer pool usage, disk drive activity levels, arrival rate of transactions or network connections, system management activity, and environmental factors (e.g., subsystem wellness, redundancy configurations, power modes, etc.). In this embodiment, resource utilization values may be calculated by taking the maximum value of the critical resource principal utilization values compute, memory, and I/O bandwidth for each given processing engine/subsystem.

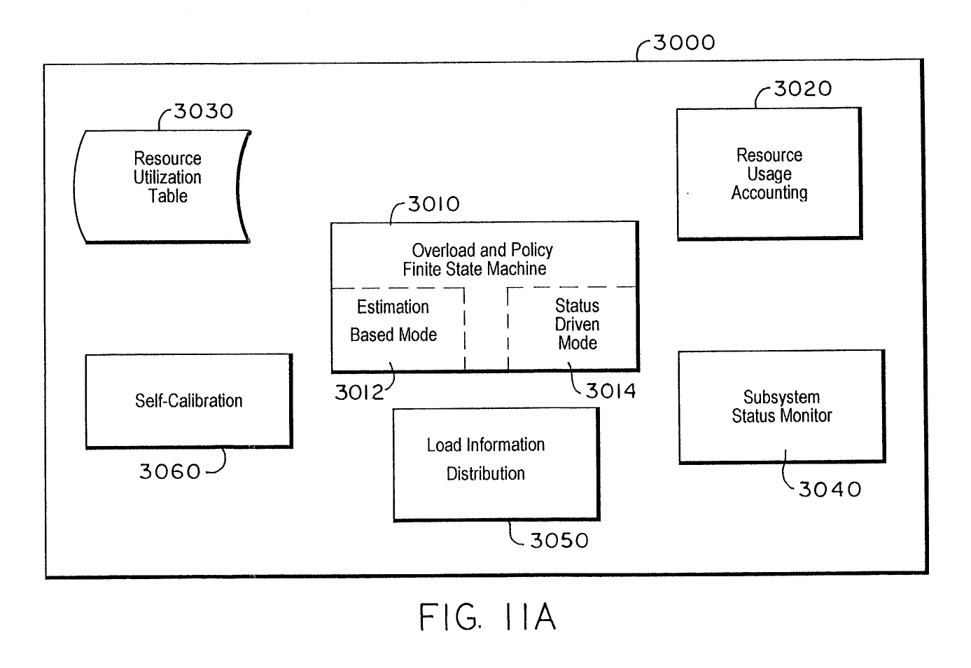

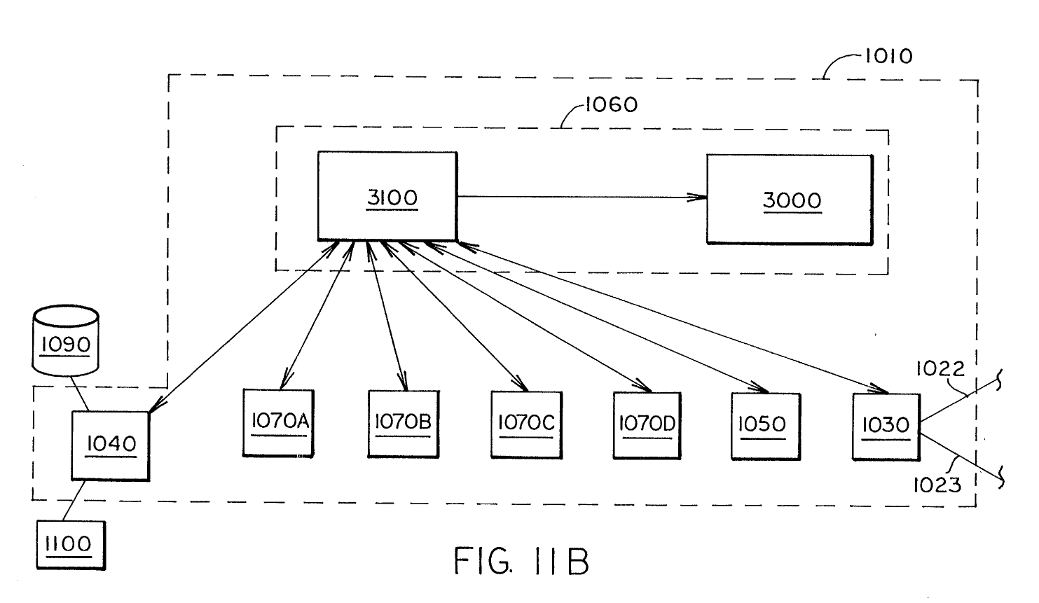

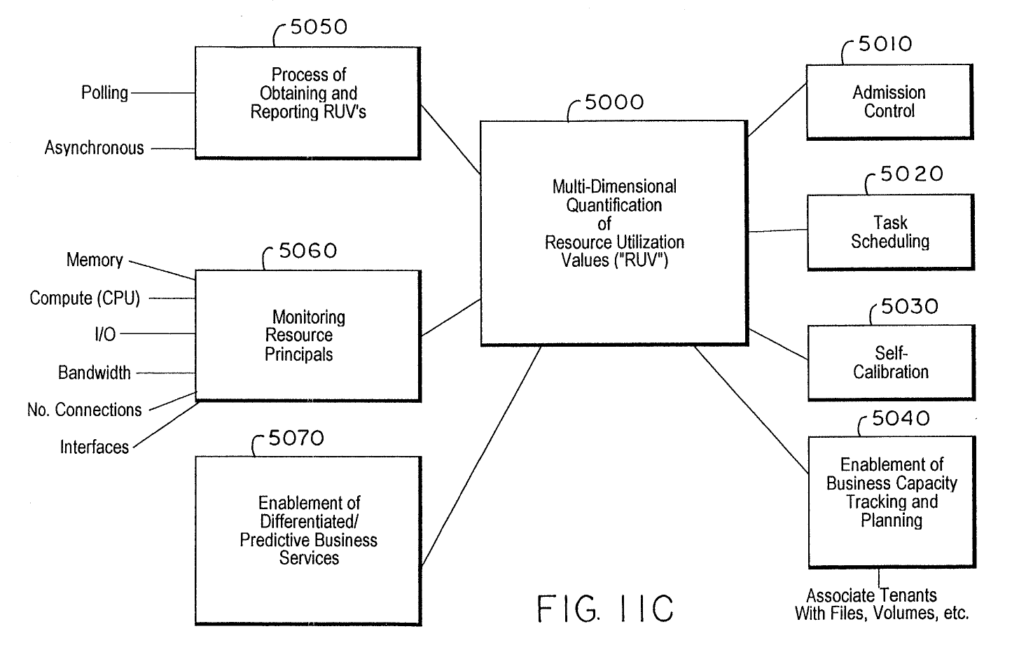

FIG. 11A illustrates one exemplary embodiment of a determinism module 3000 that may be employed to implement one or more of the policies of FIG. 10 (in one embodiment, all of the policies of FIG. 10). Processing modules illustrated in FIG. 11A include overload and policy finite state machine module 3010 (in this case capable of operating in an estimation based mode 3012 and a status driven mode 3014), resource usage accounting module 3020, resource utilization table module 3030, subsystem status monitor 3040, load information distribution module 3050 and self calibration module 3060. FIG. 11A illustrates the logical relationship between the individual modules illustrated therein, which share information as necessary to accomplish their respective defined tasks, with module 3010 acting as the brain.

It will be understood with benefit of this disclosure that determinism module 3000 illustrated in FIG. 11A may be implemented using any software and/or hardware configuration suitable for implementing the overload protection capabilities described herein, e.g., implemented as software running on a system monitor 240 or system management processing engine (host) 1060 of a content delivery system 1010 described elsewhere herein, by individual processing engines of a content delivery system 1010, or a combination thereof. Although each of the modules illustrated in FIG. 11A may be implemented by a single and common processing engine, it will be understood that any one or more of the illustrated modules may also be implemented on two or more separate processing engines in any desired configuration that is suitable for accomplishing the tasks of the modules described herein (e.g., at least one of the illustrated modules implemented on a respective processing engine separate from processing engine/s where the other modules are implemented). Furthermore, it will be understood that the capabilities of two or more of the processing modules illustrated in FIG. 11A may be combined into a single processing module (e.g., two or more of the illustrated modules together implemented on a common processing engine separate from at least one of the other modules), or that the capabilities of any given one of the illustrated processing modules may be divided among two or more processing modules (e.g., a portion of the described tasks of at least one of the illustrated modules implemented on a processing engine separate from other of the described tasks of the at least one module, etc.). It is also possible to implement any desired portion of the described capabilities of determinism module 3000 (e.g., without all of the illustrated processing modules of FIG. 11A), and/or with additional processing modules capable of performing other tasks. In addition, one or more capabilities of determinism module 3000 may be implemented externally to a given information management system (e.g., content delivery system 1010), for example, via management interface 1062 (e.g., 10/100 Ethernet, etc.) coupled to system management processing engine 1060.

In one implementation of overload protection policy 2010 of FIG. 10, resource usage accounting module 3020 may be employed (e.g., using resource usage accounting module 3020 of FIG. 11A) to keep track of system and/or subsystem workloads so that availability of resources may be evaluated with respect to new requests for information management. In this regard, resource usage accounting may be employed to keep track of current system/subsystem workloads (e.g., current total resource utilization values) to fulfill existing admitted requests, and/or to keep track of incremented system/subsystem workloads (e.g., incremented total resource utilization values) estimated to be required to fulfill both existing requests and new request/s that are not yet admitted.

In the practice of the disclosed systems and methods, resource usage accounting may be implemented using pre-defined resource utilization values (e.g., pre-defined or estimated resource utilization values based on resource modeling, system/subsystem bench-testing, etc.), measured resource utilization values (e.g., actual measured or monitored resource system/subsystem utilization values), or combinations thereof. Furthermore, resource usage accounting may be implemented using any suitable method of tracking current and/or incremented total resource utilization values for a given system, subsystem, or combination thereof.

Further, it will be understood that in the practice of the disclosed systems and methods, pre-defined and/or real-time system/subsystem workloads or resource utilization values may be measured and/or estimated using any suitable measurement/monitoring method or combination of such methods. In this regard, examples of methods that may be employed to monitor information delivery rates (e.g., streaming content delivery rates) and/or determine information retrieval rates (e.g., streaming content retrieval rates) is described in U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT,” which is incorporated herein by reference. Examples of other methods that may be employed to monitor and/or estimate resource utilization values or workloads include, but are not limited to, those methods and systems described in U.S. patent application Ser. No. 09/970,452 filed on Oct. 3, 2001, which is entitled “SYSTEMS AND METHODS FOR RESOURCE MONITORING IN INFORMATION STORAGE ENVIRONMENTS,” which is incorporated herein by reference.

For example, current total resource utilization values may be tracked or tallied by resource usage accounting module 3020 using current resource measurement counters that represent the sum of resource utilization values associated with current or existing requests for information management that are currently being processed by a given system and/or subsystem. Incremented total resource utilization values representing the sum of a current resource measurement counter value and the resource measurement value associated with fulfilling a new request for information management may be temporarily tracked or tallied locally by resource usage accounting module 3020 of FIG. 11A using incremental resource measurement counters. When a new request for information management is eventually accepted or admitted, then the current resource measurement counter will be incremented to a value corresponding to the temporary value in the incremental resource measurement counter. However, if the new request is rejected the current resource measurement counter will not be incremented, and the temporary value in the incremental resource measurement counter will be discarded. As used herein, total resource utilization values obtained based at least in part on pre-defined resource utilization values may be characterized as “estimated total resource utilization values”, and total resource utilization values obtained based at least in part on measured or monitored resource utilization values may be characterized as “measured total resource utilization values.”

In one exemplary embodiment, if no current system/subsystem overload condition exists, whenever a new client/user request for information management (e.g. request for content/information) is submitted for admission (e.g., passed from arrival shaping policy 2000 to overload protection policy 2010), resource usage accounting module 3020 may add the new resource measurement value (e.g., number of str-ops) associated with fulfilling the new request to a current resource measurement counter value that contains or represents the current total resource utilization value associated with existing requests for information management currently admitted and being processed by a given system and/or subsystem to obtain a incremental resource measurement counter value that represents the incremented total resource utilization value that would result if the new request is admitted.

In one exemplary embodiment, resource usage accounting may be performed to track resource utilization for each individual subsystem or processing engine implemented by a requested information management task. In such an embodiment, overload protection and/or admission control decisions may be made based on the individual processing engine resource state threshold that represents the highest resource utilization of each of the processing engines implemented by the requested information management task (e.g., requested content/information delivery).

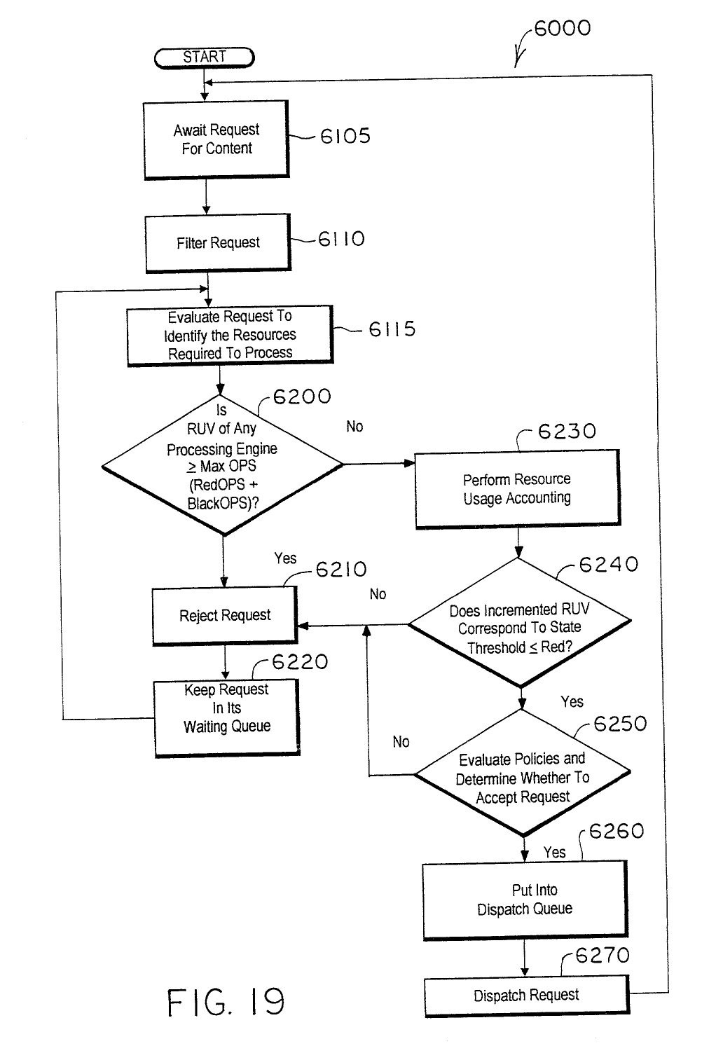

The incremented total resource utilization value contained in the incremental resource measurement counter may then be communicated to overload and policy finite state machine module 3010 of FIG. 11A where it may be compared to the total available resource utilization value (e.g., total number of available str-ops) to decide whether or not the new request is to be granted. For example, if the incremented resource utilization value exceeds the total available resource utilization value for any processing engine or task, then the request may be denied by overload and policy finite state machine module 3010. However, if the incremented total resource utilization value is less than or equal to the total available resource utilization value for any of the necessary processing engines or tasks, then the request may be granted by overload and policy finite state machine module 3010. Alternatively, overload and policy finite state machine module 3010 may maintain a reserve or cushion of available resources by refusing admittance to any new request that would result in an incremented resource utilization value that exceeds a specified portion (e.g., fraction or percentage) of the total available resource utilization value. One example of such a specified portion would be about 80% of the total available resource utilization value. One exemplary embodiment of a method of admission control using resource utilization value quantification is described and illustrated in relation to Example 10 and FIG. 19.

In one exemplary embodiment, overload and policy finite state machine module 3010 of FIG. 11A may implement an estimation-based resource usage accounting method by using pre-defined resource utilization values to determined estimated total resource utilization values. Pre-defined resource utilization values may be derived or defined in any suitable manner including, but not limited to, by estimation, bench testing (e.g., benchmark or quantification testing) of system/subsystem components, system/subsystem performance modeling, system/subsystem component simulation, specified or defined configuration values, etc. Furthermore, pre-defined resource capacity utilization unit values may optionally be verified, adjusted and/or updated, for example, based on benchmark or quantification testing and/or optional follow-up performance analyses to increase accuracy thereof. In the practice of the disclosed systems and methods, any benchmark or quantification testing methodology may be employed that is suitable for use in generating resource utilization values as described herein. For example, benchmark testing may be used to generate multiple utilization test points for a given system/subsystem at different loads (e.g., hit rates) to quantify system performance. Examples of suitable benchmark testing methods include, but are not limited to, available benchmark testing software tools known in the art such as SPECWEB, WEBBENCH, SPECsfs, IOMETER, IOZONE, etc.

Pre-defined resource utilization values based on performance data collection and performance analysis may be employed to advantageously detach real time admission control implementation from performance analysis, which may be more complicated and processing-intensive. In this regard, any suitable method of performance data collection and performance analysis may be employed including, for example, those methods described herein in relation to steps 1250, 1260 and 170 of FIG. 8 herein.

Pre-defined resource utilization values may be stored or maintained in any manner suitable for allowing access to such values for resource usage accounting purposes. Examples of suitable ways in which resource utilization values may be maintained for use in resource usage accounting include, but are not limited to, resource utilization formulas, resource utilization tables, etc. Specific examples of resource utilization formulas and tables, as well as the generation thereof, may be found in Example 4 herein. In one exemplary embodiment each subsystem or processing engine of a streaming content delivery system may be provided with a configurable resource utilization table module 3030 that contains pre-defined resource utilization values that represent or characterize the magnitude of resource utilization required for delivering various types of streaming content to a user (e.g., stored video/audio clips, SureStream clips, live streams in unitcasting or multicasting, etc.) and/or for streaming rates (e.g., in a spectrum from about 16kbps to about 3 mbps). Alternatively, a configurable master resource utilization table module 3030 may be provided separate from individual subsystems or processing engines of the system, for example, on a system monitor 240 or system management processing engine 1060. A master resource utilization table for streaming content delivery may be characterized as a function of two dimensions: stream rate and subsystem, i.e., because the resource utilization value required to deliver each content stream varies according to both the stream rate and the given subsystem. For a given individual subsystem of a content delivery system, a resource utilization table may be a one-dimensional function (i.e., a function of stream rates) that may be approximated by a piece-wise linear function, as described herein in Example 5.

In one embodiment, one or more resource utilization table modules 3030 and one or more resource usage accounting modules 3020 may be made available to an overload and policy finite state machine module 3010 to enable the implementation of resource management tasks using table based accounting, for example, rather than using sophisticated formulas, although such formulas may be additionally or alternatively employed in other embodiments if so desired. Using resource utilization table module/s 3030, resource usage accounting module/s 3020 may keep track of total resource capacity utilization unit usage in each subsystem or processing engine of an information management system. For example, resource usage accounting module/s 3020 may look up or otherwise obtain resource utilization values from resource utilization table/s 3030 in order to add the required number of resource capacity utilization units associated with a new stream to its current resource measurement counter when a new stream is admitted, and/or may subtract the required number of required number of resource capacity utilization units associated with a terminating active stream from its current resource measurement counter when the active stream terminates.

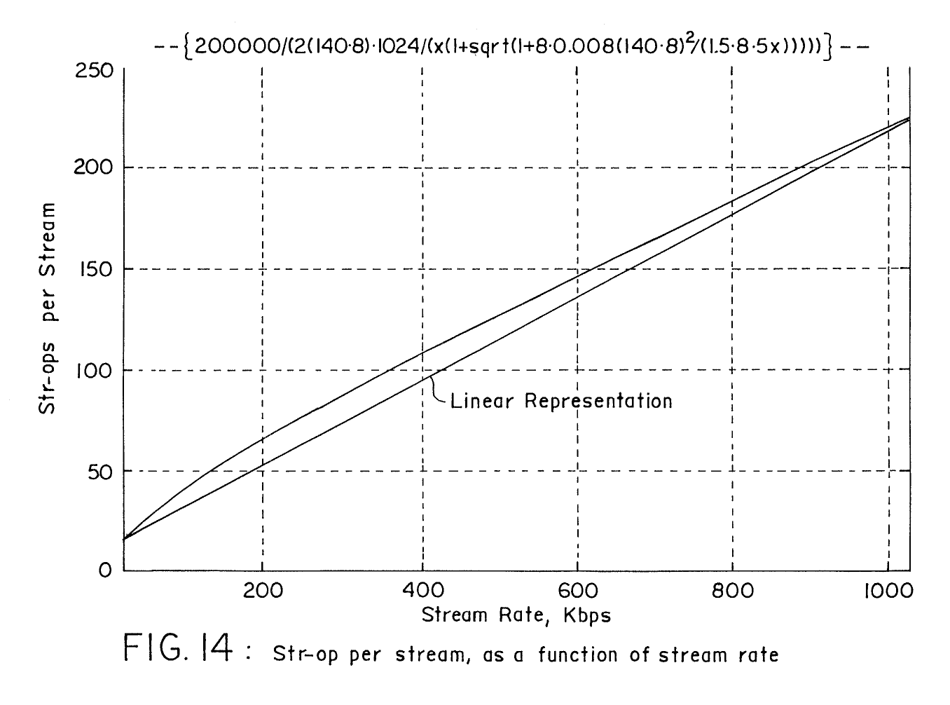

In the practice of the disclosed systems and methods, a resource utilization table module 3030 may employ a table that is constructed and maintained, for example, as a full table similar to Table 1 of Example 4. Such a table may be constructed of individual table entries that are read into and maintained, for example, in RAM memory of system monitor 240 or system management processing engine 1060. However, implementations other than a full resource utilization table may be employed to store and maintain pre-defined resource utilization values. For example, a linear approximation relationship such as illustrated and described in relation to FIG. 14 of Example 4 may be employed as a resource utilization table to reduce the amount of memory and processing associated with a full resource utilization table (e.g., for table storage and value look up processing). Such a linear approximation may be employed to represent resource utilization value per stream as a function of stream rate as a linear function.

Multiple linear approximations may be optionally employed to represent pre-defined resource utilization values, for example, to maintain generality and accuracy. In one exemplary embodiment up to five linear approximations may be implemented by a resource utilization table module 3030. In such a case, the whole stream rate spectrum may be partitioned into multiple intervals (e.g., five intervals in this case), allowing a different and separate linear expression to be employed to represent resource utilization table values within each interval. In this embodiment, only fifteen constant values are required for an accurate approximation of a five-interval resource utilization table (i.e., one interval limit and two linear line coefficients for each of the five intervals). Only eleven constant values are required for this purpose if they share a common endpoint.

In one embodiment of the disclosed systems and methods, data for a resource utilization table may be generated automatically and in real time. Such a capability may be desirable, for example, where configuration and/or provisioning of an information management system has not been finalized, or under any other circumstances where it is desired to generate new resource utilization values automatically (e.g., system prototype testing, etc.). Real time generation of values for a resource utilization table may be accomplished, for example, by taking inputs on a set of performance measurements and then directly generating a new table on the fly. This method may utilize the relationship described herein in relation to Example 5 (i.e., value of resource capacity utilization units per stream is a power function of stream rates and that may be approximated by a multiple straight lines).

As illustrated in further detail in Example 5 herein, real time generation of resource utilization table values may be accomplished in one embodiment using the following steps: 1) using performance benchmark or quantification testing data and constructing a new input parameter file; 2) converting the performance benchmark or quantification testing data into a resource utilization sample table; 3) constructing a piece-wise linear function for the sample resource utilization table str-op table; and 4) assigning a resource utilization value to a stream having a new streaming rate using a pair of known resource utilization values corresponding to known streams having streaming rates nearest to the streaming rate of the new stream.

In one embodiment of the disclosed systems and methods, resource state thresholds may be optionally implemented to classify or characterize the relative state of resource utilization within a system and/or subsystem. Such multiple state thresholds may be defined and implemented, e.g., by overload and policy finite state machine module 3010 of FIG. 11A. For example, multiple resource state thresholds may be provided that represent varying degrees of current system workload relative to system workload capacity.

One exemplary embodiment of a resource state threshold scheme is described in Example 7 herein. In this example, a maximum desired total resource utilization value for a system/subsystem may be specified for fulfilling admitted requests for information management, e.g., a Red state threshold that represents some portion (e.g., from about 85% to about 90%) of the maximum possible total resource utilization value the system/subsystem is capable of supporting. In such a case, the remaining portion (e.g., from about 10% to about 15%) of the maximum possible total resource utilization value may be reserved as a cushion by overload and policy finite state machine module 3010 and used partially or entirely as desired, for example, based on one or more optional policies implemented by overload and policy finite state machine module 3010. For a given subsystem or processing engine, reserved portion of the total subsystem resource utilization value may be selected based on the characteristics of the individual subsystem, and may include any additional resource utilization reserve requirements of the given subsystem or processing engine (e.g., reserved processing and/or memory for internal subsystem tasks).

An optional useable resource utilization reserve value may also be specified, e.g., a Black state threshold that represents some specified part of the remaining portion (e.g., about 2%) of the maximum desired total resource utilization value that may be temporarily utilized by overload and policy finite state machine module 3010 to fulfill additional requests for information management on an as needed basis. In one exemplary embodiment, an overload and policy finite state machine module 3010 will not exceed a system total resource utilization value that is equal to the sum of the maximum desired total resource utilization value for the system/subsystem (e.g., Red state threshold) and the useable resource utilization reserve value (e.g., Black state threshold). An optional warning state threshold may be specified (e.g., Yellow state threshold), that is triggered when system/subsystem resource utilization reaches some portion (e.g., reaches a value from about 70-85%, alternatively about 82%) of the sum of the maximum desired total resource utilization value for the system/subsystem (e.g., Red state threshold, e.g., over about 90%) and the useable resource utilization reserve value (e.g., Black state threshold) that may be implemented, for example, to notify a system administrator, user or other entity that the system/subsystem is entering a heavily loaded state. Such an alarm may be reported in any manner described elsewhere herein.

In one exemplary embodiment, additional state thresholds may be implemented, for example, a Green state threshold that represents from about 0% to about 70% utilization. Another type of state threshold that may also be optionally provided is a transient state threshold (e.g., Orange state threshold) that may be defined to represent a utilization state between a Yellow state threshold and a Red state threshold when a particular subsystem is unexpectedly entering its own Red state. It will be understood that the number and types of resource state thresholds described here and in Example 7 are exemplary only, and that a greater or lesser number of such thresholds and/or different types of such thresholds (including warning state thresholds) may be implemented as so desired.

In addition or as an alternative to estimation-based resource usage accounting, it is possible to implement status-driven resource usage accounting methodology that takes into consideration actual measured resource utilization values of a system and/or subsystems thereof (e.g., status-driven resource usage accounting methodology may be implemented by resource usage accounting module 3020 in conjunction with status driven mode 3014 of overload and policy finite state machine module 3010). In those embodiments where status-driven resource usage accounting is implemented to consider measured system/subsystem resource utilization values, such measured values may be obtained (e.g., monitored or tracked) in any suitable manner, including any manner for monitoring or tracking resource utilization described elsewhere herein, and/or as described in copending U.S. patent application Ser. No. 10/003,683 by Webb, et al. filed Nov. 2, 2001 and entitled “SYSTEMS AND METHODS FOR USING DISTRIBUTED INTERCONNECTS IN INFORMATION MANAGEMENT ENVIRONMENTS”, and in U.S. patent application Ser. No. 10/060,940, filed Jan. 30,2002 and entitled “SYSTEMS AND METHODS FOR RESOURCE UTILIZATION ANALYSIS IN INFORMATION MANAGEMENT ENVIRONMENTS” by Jackson et. al, each of which is incorporated herein by reference.

In one exemplary embodiment, measured system/subsystem resource utilization values may be obtained under status driven mode 3014 of overload and policy finite state machine module 3010 by soliciting or receiving resource utilization feedback from one or more subsystems or processing engines of an information management system through subsystem status monitor module 3040. Solicited or received resource utilization feedback may include any information that is reflective of actual subsystem workload and/or resource usage. In one exemplary embodiment, resource feed back may be solicited or received via system management/status/control messages or any other suitable type of message that may be sent as a subsystem resource status message across a distributed interconnect (e.g., such as a switch fabric). In this regard, subsystem resource status messages may be sent asynchronously by any one or more of the subsystems or processing engines directly, e.g., to subsystem status monitor 3040 of FIG. 11A. Such subsystem resource status messages may also provide additional information fields for more detailed workload information, e.g., to allow a storage processing engine to indicate which disk drive has the highest hit rate should a hot spot problem occur.

In another exemplary embodiment, solicited or received resource utilization feedback may include an overall resource utilization indicator sent via an overall resource status message (e.g., system management/status/control message or other suitable message) from a separate module/s (e.g., monitoring agent 245 implemented by an application processing engine 1070, storage processing engine 1040, transport processing engine 1050, network interface processing engine 1030, etc. of a content delivery system 1010). As illustrated in FIG. 11B, such an overall utilization indicator may represent one or more resource principals (e.g., compute, memory, I/O consumption, etc. and other resource principals described elsewhere herein) and result from polling of individual subsystems or processing engines by a separate wellness/availability module 3100 at any suitable or desired time interval (e.g., subsystem resource messages polled at the rate of from about one poll per second to about one poll per five seconds), with shorter polling intervals generally allowing quicker response time to exceptions.

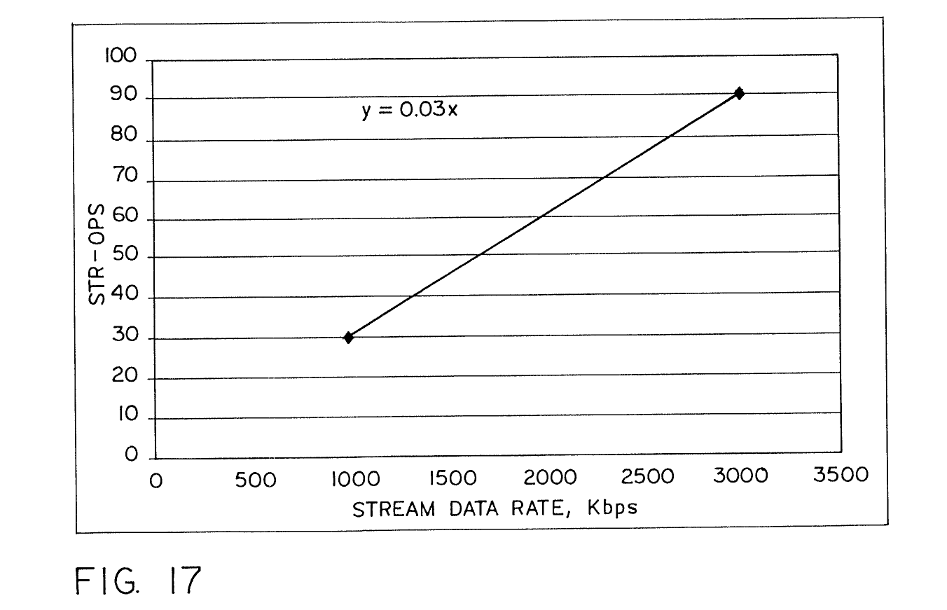

FIG. 11B illustrates one exemplary embodiment of a content delivery system 1010 such as illustrated and described in relation to FIGS. 1A or FIGS. 1C-1F herein. As shown in FIG. 11B, content delivery system 1010 has four application processing engines (1070a, 1070b, 1070c, 1070d), storage processing engine 1040, transport processing engine 1050, network interface processing engine 1030, and system management processing engine 1060. The multiple processing engines of content delivery system 1010 of FIG. 17 may be coupled together by a distributed interconnect 1080 (not shown), and system 1010 may be interconnected to one or more networks (not shown) via network connections 1022 and/or 1023 in a manner as previously described. Modules 3100 and 3000 may each be implemented in this exemplary embodiment by a system management processing engine 1060 or a system monitor module 240, although it is also possible to implement these modules on separate processing engines.

In one exemplary embodiment, wellness/availability module 3100 may be implemented as a resource utilization monitor as described and illustrated in U.S. patent application Ser. No. 10/060,940, filed Jan. 30, 2002 and entitled “SYSTEMS AND METHODS FOR RESOURCE UTILIZATION ANALYSIS IN INFORMATION MANAGEMENT ENVIRONMENTS” by Jackson et. al, the disclosure of which is incorporated herein by reference. As described in this reference, a resource utilization monitor (in this case, acting as a wellness/availability module 3100) may be continuously running in the background to monitor resource utilization information by using a pulse cycle to periodically poll each of application processing engines 1070A to 1070D, storage processing engine 1040, transport processing engine 1050, network interface processing engine 1030 and system management processing engine 1060. Such periodic polling may be accomplished using any suitable messaging protocol, e.g., with a general control message inquiring of the status of each given processing engine. This periodic polling may occur at any desired interval frequency, for example, once per every second, twice per every second, once per every five seconds, etc. In response to each poll received from wellness/availability module 3100, each given processing engine 1030, 1040, 1050, 1060 and 1070 may be configured to respond by communicating current resource utilization feedback or status information (e.g., overall resource utilization or status message) to wellness/availability module 3100, for example by means of a software utility or other processing object running on each respective processing engine. It will be understood that the embodiment of FIG. 17 is exemplary only, and that not all processing engines 1030, 1040, 1050, 1060 and 1070 need necessarily be polled at the same interval frequency, or even need be polled at all. Alternatively or additionally, each processing engine 1030, 1040, 1050, 1060 and 1070 may communicate asynchronously (e.g., in an unsolicited manner) to wellness/availability module 3100 the same type of resource utilization feedback or status information.

Not shown in FIG. 11B are an optional resource utilization logger, and an optional logging and analysis manager, each of which may also be implemented by system processing engine 1060 in any suitable manner, e.g. software or other logical implementation. Also not shown is optional history repository 2300 that may be coupled to system 1010 via system management processing engine 1060 using, for example, a management interface 1062 (e.g., 10/100 Ethernet, etc.). Further information on these modules, as well as their interaction with a resource utilization monitor that may optionally be used to implemented wellness/availability module 3100 may be found in U.S. patent application Ser. No. 10/060,940, filed Jan. 30,2002 and entitled “SYSTEMS AND METHODS FOR RESOURCE UTILIZATION ANALYSIS IN INFORMATION MANAGEMENT ENVIRONMENTS” by Jackson et. al, the disclosure of which is incorporated herein by reference. As described in this reference, the separate tasks of resource utilization monitor, resource utilization logger, and logging and analysis manager may be consolidated and performed by less than three processing objects, may be dispersed among more than three processing objects, and/or may be implemented on more than one processing engine of an information management system. Furthermore, any one or more of these three modules may be implemented on one or more processing entities (e.g., servers, processors, computers, etc.).

However implemented, a separate wellness/availability module 3100 (e.g., running on system monitor 240 or system management processing engine 1060) may be capable of preprocessing and forwarding the individual overall resource status messages to subsystem status monitor 3040 of determinism module 3000 of FIG. 11A. For example, such messages may be preprocessed to yield a categorized table or list of resource utilization values for each processing engine of a given system. Exemplary forms of overall resource utilization indicators include, but are not limited to, an overall resource utilization indicator for an application processing engine that represents the ratio of current total resource utilization value divided by total available resource utilization value, and an overall resource utilization indicator for storage processing engine that reflects the calculated new cycle time of a storage processing engine that would exist upon admittance of a given new client/user request. As an example, in one exemplary embodiment, the overall utilization for a storage processing engine may be defined as follows:

Overall_utilization=max { Cycle_time/Upper_bound, Lower_bound/Cycle_time}.

In this embodiment, “Upper_bound” and “Lower_Bound” are the results of an I/O admission control calculation in the storage processing engine, and the “Cycle_time” is calculated to derive the read-ahead buffer size for active streams. The “Cycle time” is different from the cycle time that a storage processing engine is currently using. As long as the old cycle time still falls between the new “Lower_bound” and the “Upper_Bound”, the old cycle time may be used continuously in order to reduce the frequency of changing read-ahead buffer size. The “Cycle_time” used in the above overall utilization calculation is the new cycle time that would exist upon admittance of the new stream. in order to provide an accurate load information. Further information on the above-described I/O admission control calculation may be found in U.S. patent application Ser. No. 09/947,869, filed Sep. 6, 2001 and entitled “SYSTEMS AND METHODS FOR RESOURCE MANAGEMENT IN INFORMATION STORAGE ENVIRONMENTS” by Qiu et. al, the disclosure of which is incorporated herein by reference.

Just a few examples of other types of resource utilization information that may be measured and/or estimated in the practice of the disclosed systems and methods include, but are not limited to, access information (such as request arrival and rejection), QOS information (such as setup latency and dropping rate), and more detailed subsystem workload information (such as the workload distribution on disk drives, one or more resource principals as described elsewhere herein), etc. In any case, subsystem status module 3040 may be implemented to preprocess either or both of the subsystem resource status messages and overall resource status messages, e.g., by reading the message and determining the subsystem resource state therefrom. This done, the latest resource utilization information is compared with the state threshold information currently tracked by overload and policy finite state machine module 3010, for example, as described elsewhere herein.

Resource utilization feedback information received by subsystem status monitor 3040 from one or more subsystems may be communicated to overload and policy finite state machine module 3010 where it may be processed or evaluated for a number of purposes, e.g., resource usage accounting, admission control decisions for client/user requests, etc. Overload and policy finite state machine module 3010 may also process and evaluate such resource utilization feedback information to warn overload and policy finite state machine module 3010 of inconsistency between total resource utilization system/subsystem values obtained by estimation-based resource usage accounting using pre-defined resource utilization values and actual total resource utilization values measured for the system/subsystem. One example of such an inconsistency is a measured total resource utilization value that exceeds an estimated total resource utilization value obtained using pre-defined resource utilization values and resource usage accounting. Such inconsistencies may arise due to known or unknown exceptions, such as if one or more subsystems are in a faulty condition, if a “hot spot” problem exists (e.g., if network traffic “storms” occur), if memory leaks, etc.

In one embodiment, state transitions between multiple resource state thresholds may be driven under normal system/subsystem operating conditions (e.g., system/subsystem workloads within maximum workload capabilities) using pre-defined resource utilization values in conjunction with an estimation-based resource usage accounting methodology described above. However, upon identification of an inconsistency between pre-defined resource utilization values and measured resource utilization values such as described above, overload and policy finite state machine module 3010 may enter status-driven mode 3014 and perform status-driven resource usage accounting operations (e.g., employing resource usage accounting methodology based on measured resource utilization values), for example, in the following manner.

In one embodiment of status-driven mode 3014, overload and policy finite state machine module 3010 may perform status-driven resource usage accounting in which resource usage accounting and/or admission control decisions are made based at least in part on measured resource utilization values and measured total resource utilization values calculated therefrom. As described above, in status-driven mode 3014 status-driven resource usage accounting may be employed to make admission control decisions (e.g., to determine whether or not to admit a new request) based on resource utilization feedback even though comparison of estimated total resource utilization value and available resource utilization value indicate there is sufficient system/subsystem resources available to admit and process the new request. In status-driven mode 3014, inter-subsystem communications and other useful system information (e.g., resource principals such as memory, compute, I/O utilization values, number of network connections, etc.) may be optionally logged for purposes of facilitating debugging and/or performance analyses, for example, using methodology for logging inter-subsystem/processing engine communications across a distributed interconnect that are described copending U.S. patent application Ser. No. 10/003,683 entitled “SYSTEMS AND METHODS FOR USING DISTRIBUTED INTERCONNECTS IN INFORMATION MANAGEMENT ENVIRONMENTS”, which is incorporated herein by reference.

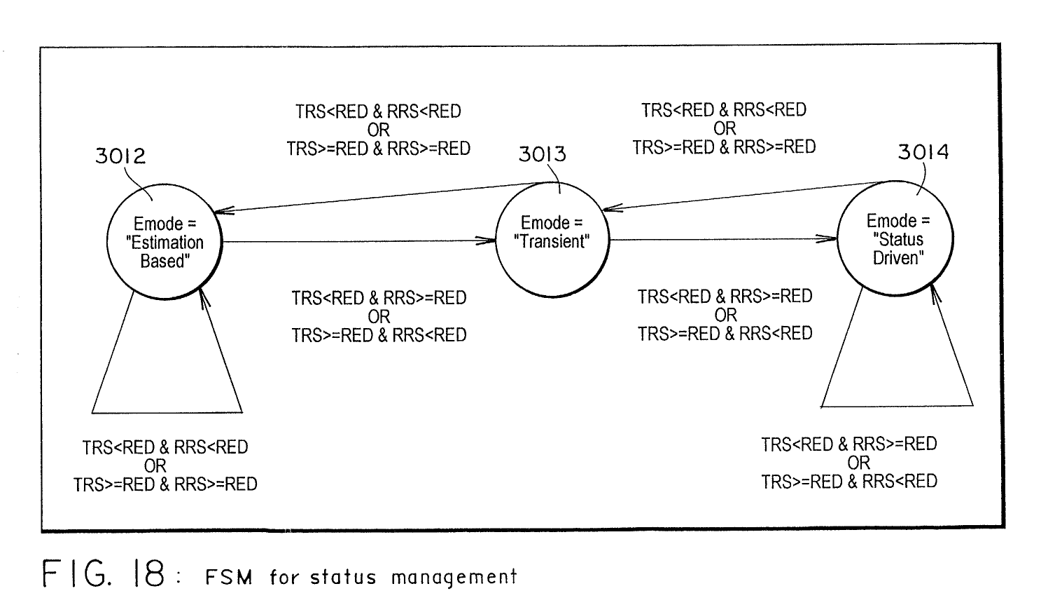

In the practice of the embodiment of FIG. 11A, transition from estimation-based mode 3012 to status-driven mode 3014 may be made by overload and policy finite state machine module 3010 based on a variety of system/subsystem conditions or other considerations. In this regard, it is possible to provide a variety of logical flowpaths or transition policies for transitioning to status-driven mode 3014 from estimation-based mode 3012, and vice-versa. One specific example of possible transition policy for transitioning between estimation-based mode 3012, status-driven mode 3014, and transient mode 3013 is described and illustrated in relation to FIG. 18 and Example 8 herein.

As an example, if estimation-based resource usage accounting results in an estimated total resource utilization value that differs by only a relatively small amount (e.g., less than or equal to about 5%) from a corresponding measured total resource utilization value obtained from subsystem resource utilization feedback through subsystem status monitor 3040, then overload and policy finite state machine module 3010 may be programmed to immediately enter the reported utilization status level (status driven mode 3014 for performance of status-driven resource usage accounting). This may occur, for example, if estimation-based resource usage accounting yields an estimated subsystem total resource utilization value corresponding to a resource utilization state that is below (albeit relatively close to), a Red resource utilization threshold at the same time that a measured total resource utilization value for the same subsystem is a value corresponding to the Red resource utilization state.

Alternatively, if estimation-based resource usage accounting results in an estimated total resource utilization value that differs by a relatively large amount (e.g., by greater than about 5% of reported utilization) from a corresponding measured total resource utilization value obtained from subsystem resource utilization feedback through subsystem status monitor 3040, then overload and policy finite state machine module 3010 may be programmed to enter a transient state (e.g. Orange resource utilization state) and to initiate a system workload poll for subsystem resource utilization feedback to confirm the previously-measured total resource utilization value and corresponding subsystem resource utilization state. This may occur, for example, if estimation-based resource usage accounting yields an estimated subsystem total resource utilization value corresponding to a first resource utilization state (e.g., resource utilization value that is greater than about 5% below a Red resource utilization threshold) at the same time that a measured total resource utilization value for the same subsystem is a value corresponding to a second resource utilization state (e.g., corresponding to a Red resource utilization state). If the results of the subsystem poll returns a measured total resource utilization value corresponding to the prior measured second state (e.g., Red state), then overload and policy finite state machine module 3010 enters the second resource utilization state (e.g., the Red state). However, if the results of the subsystem poll returns a measured total resource utilization value corresponding to the first resource utilization state (e.g., a state below the Red state), then overload and policy finite state machine module 3010 responds by entering the first resource utilization state and by re-sampling utilization levels until the estimated subsystem total resource utilization value corresponds to the same resource utilization state as the measured resource utilization value.

Using the methodology described in the above paragraph, it may be desirable to only utilize a transient resource utilization state when a critical (e.g., Red) resource utilization state is indicated by either the estimated or measured total resource utilization value. This is because of the system operation implications of entering a critical resource utilization state such as a Red resource utilization state. For those cases where estimated and measured total resource utilization values correspond to two respective and different non-critical resource utilization states (e.g. Green and Yellow states), overload and policy finite state machine module 3010 may go ahead and enter the higher resource utilization state (e.g. Yellow state) and perform the re-sampling task as described above. One exemplary embodiment of such a logic flow is illustrated and described in relation to Example 9 and Table 4.

In yet another embodiment, a self-calibration module 3060 may be employed to use subsystem resource utilization feedback obtained through subsystem status monitor 3040 to self-calibrate pre-defined resource utilization values, for example, as may be contained in resource utilization table 3030. This may be accomplished, for example, by employing an algorithm or other relationship suitable for adjusting pre-defined resource utilization values to more closely match or agree with measured resource utilization values received from subsystem feedback. One example of a suitable type algorithm is a Proportional-Integration-Differentiation (PID)-type algorithm. Examples of specific suitable algorithms include, but are not limited to Neural Networks algorithms such as Multilayer Perceptron (“MLP”) algorithms, Radial Basis Function (“RBF”) algorithms, etc.).

As illustrated in FIG. 10, optional differentiated service policy 2020 may be implemented, for example, to achieve differentiated services as described elsewhere herein. In one exemplary embodiment, differentiated service enforcement policy 2020 may be implemented by overload and policy finite state machine module 3010 employed, for example, to enforce a given SLA contract to ensure that the guaranteed throughput of the contract will be realized and that best effort services will be supported with potential discriminations. Such a differentiated service enforcement feature may be implemented based on simple usage quantification such as bandwidth and/or number of sessions. In one example, differentiated service policy 2020 may be implemented to operate by pre-configured thresholds or utilization levels.

Dispatching policy 2030 of FIG. 10 may next be implemented, e.g., by overload and policy finite state machine module 3010 of FIG. 11A. In this regard, dispatching policy 2030 may include any policy or combination of policies for dispatching admitted information management requests 2100 for processing, e.g., for dispatching newly admitted connection requests for processing by application processing engines 1070 and/or storage processing engines 1040 of a content delivery system 1010 such as in a manner illustrated in FIG. 1B herein. For example, dispatching policy 2030 may include a task scheduling policy by which admitted requests are placed in multiple dispatch queues based on their CoS priorities (e.g., low vs. medium vs. high, 0 to 7, Platinum vs. Gold vs. Silver vs. Bronze, etc.). Request dequeueing may then be accomplished using any priority dequeue algorithm suitable for dispatching admitted requests 2100, for example, to an application processing engine 1070 for processing. Just one example of a suitable type of dequeue algorithm is a weighted round robin algorithm. One exemplary embodiment of multiple CoS dispatching queues is described in Example 6 herein. It will be understood that in addition to multiple CoS arrival and/or dispatching queues, it is also possible to implement multi-tenant, multi-CoS methodologies using the systems and methods described herein. It is also possible to implement rate and latency shaping capabilities.

Also possible within dispatching policy 2030, is the implementation of a load balancing policy to perform load balancing of admitted requests when dispatching new connection requests to appropriate processing engines of an information management system, e.g. application processing engines 1070 of a content delivery system 1010. For example, referring to FIGS. 11A and 11B, a system load status message from load information distribution module 3050 to the various subsystems may be used to provide a load-balancing capable processing engine (e.g., a transport processing engine 1050) with resource state threshold information for one or more processing engines of an information management system. Such load status messages may be communicated periodically at any suitable or desired interval to inform the load-balancing capable processing engine of the updated or current resource state thresholds (e.g., Black, Red, Yellow or Green) of the processing engines of the system (e.g., the load status of each of four application processing engines 1070 in a content delivery system 1010) so that the load-balancing capable processing engine may perform load balancing when distributing new connection requests, e.g., to the application processing engines 1070, for example, using some form of weighted round robin algorithm to distributing new client/user requests. In such an implementation, the load of admitted new connection requests 2100 may be balanced by preferentially dispatching new requests 2100 first to those application processing engines 1070 in a relatively lower threshold state over those application processing engines 1070 in a relatively higher threshold state.

For example, referring to the previously described threshold state example, newly admitted request/s 2100 may be preferentially dispatched to an application processing engine/s 1070 in a Green threshold state rather than to other application processing engines 1070 in Yellow and Red threshold states. Where no application processing engines 1070 are in the Green threshold state, newly admitted request/s 2100 may be preferentially dispatched to an application processing engine/s 1070 in a Yellow threshold state rather than to other application processing engines 1070 in a Red threshold state. Where all application processing engines 1070 are in the same threshold state (e.g., Red, Yellow or Green), a dispatching algorithm may be implemented by a load-balancing capable processing engine (e.g., a transport processing engine 1050) module to distributively dispatch newly admitted requests equally among the processing engines 1070, e.g., using weighted-round-robin (WRR) algorithm/s. It will be understood that load balancing may be implemented in dispatching policy 2030 using any other suitable methodology, e.g., using differing number or types of threshold states, using a load balancing methodology that does not consider relative resource threshold states (e.g., using only weighted-round-robin (WRR) algorithm/s), etc. Furthermore it will be understood that dispatching policy 2030 may be implemented with or without load balancing, with or without multiple CoS-based dispatch queues, etc.

It will be understood that resource usage accounting and/or admission control/overload protection for a given subsystem may be implemented entirely by a system monitor 240 or system management processing engine (host) 1060 of a content delivery system 1010, by the given subsystem itself, or by a combination thereof. In an example embodiment of the latter case, when a new client/user request arrives at an application processing engine 1070, its internal processing engine admission control policy (e.g., using an admission control plug-in) may be implemented to perform resource usage accounting, and to decide whether or not the application processing engine 1070 will accept the new client/user request. If it decides to accept the new request, it may forward the request to an overload and policy finite state machine module 3010 executing on the system management processing engine 1060. Overload and policy finite state machine module 3010 running on the system management processing engine (host) 1060 may continue to track the resource usage for the given application processing engine 1070, but without performing the resource usage accounting for application processing engine 1070. Overload and policy finite state machine module 3010 may also generate updated resource utilization tables for an admission control plug-in. Overload and policy finite state machine module 3010 running on system management processing engine (host) 1060 may continue to perform resource usage accounting for other subsystems or processing engines, and may decide to reject the new client/user request if it decides that some other subsystem or processing engine in the service path of fulfilling the new request will be overloaded. Thus, the overload and policy finite state machine module 3010 running on system management processing engine (host) 1060 may override the local decision made by the application processing engine 1070 via its admission control plug-in.

FIG. 11C is a representation of a possible interrelation of active and passive resource utilization value functionalities that may be advantageously implemented, for example, using one embodiment of overload and policy finite state machine module 3010 in an information management environment. The illustrated functionalities are centered around multi-dimensional quantification of resource utilization values 5000, which advantageously provides a mechanism upon which system and subsystem resources may be estimated, monitored and predicted. Illustrated in FIG. 11C are passive and active resource utilization value functionalities enabled by multi-dimensional resource utilization value quantification 5000, and which may be implemented in one embodiment using overload and policy finite state machine module 3010.

FIG. 11C illustrates passive functionalities that may be passively performed by overload and policy finite state machine module 3010 and that may include monitoring of resource principals 5060, and obtaining and reporting resource utilization values (“RUV”) 5050. Also illustrated is enablement of business capacity tracking and planning 5040, a passive functionality that may be enabled by overload and policy finite state machine module 3010, and which may be performed externally to module 3010. Active functionalities that may be actively performed by overload and policy finite state machine module 3010 include admission control 5010, task scheduling (policy enforcement) 5020, self-calibration 5030 and enablement of differentiated/predictive business services policies 5070.

In one exemplary embodiment, the functionalities illustrated in FIG. 11C may be employed to implement the steps of FIG. 8 as follows. Resource quantification 5000 may be considered a language by which all steps of FIG. 8 may be implemented. The process of obtaining and reporting RUV's 5050 includes benchmark and performance testing and may also be used to implement all steps of FIG. 8 ,including service monitoring 1270. Business capacity tracking and planning 5040, obtaining and reporting resource utilization values 5050 and enablement of differentiated/predictive business services policies 5070 may be employed to implement steps 1220 to 1240 of FIG. 8, and enablement of business capacity tracking and planning 5040 may be used to implement step 1210 of FIG. 8. Admission control 5010, task scheduling 5020, self-calibration 5030 and monitoring resource principals 5060 may be employed to implement steps 1250 and 1260 of FIG. 8.

Dynamic monitoring and active enforcement aspects of the disclosed systems and methods may be implemented using any communication methodology suitable for continuously and/or periodically communicating real time or historical system/subsystem workload information (e.g., resource utilization values) to one or more active processing entities (e.g., processing engines or modules) capable of actively managing system/subsystem workflow to implement desired policies such as those described elsewhere herein (e.g., load balancing, overload protection, admission control, differentiated service, etc.). Examples of possible communication methodologies that may be employed include, but are not limited to, centralized methods, distributed methods, and combinations thereof.

In one exemplary embodiment of a centralized communication methodology, workload information/resource utilization status information may be communicated (e.g., asynchronously and/or in response to polling) from individual subsystems or processing engines (e.g., from monitoring agents 245 of individual storage processing engine/s 1040, application processing engine/s 1070, etc.) across a distributed interconnect 1080 to a common active processing entity (e.g., transport processing engine 1050), which processes this information and acts thereupon (e.g., load balances, performs admission control, prioritizes information flow, etc.). In another exemplary embodiment of a centralized communication methodology, workload information/resource utilization status information may be communicated across a distributed interconnect 1080 from one or more individual subsystems or processing engines to a re-directive pre-processing entity (e.g., wellness/availability module 3100) that preprocess raw information and redirects the preprocessed information to an active processing entity, (e.g., to a determinism module 3000 or other intelligent agent such as load balancer, intelligent web switch, etc.) which in turn processes the workload information and acts thereupon in a manner as described elsewhere herein.

In one exemplary embodiment of a distributed communication methodology, workload information/resource utilization status information may be communicated (e.g., asynchronously and/or in response to polling) across a distributed interconnect 1080 from each (or from a selected number of) individual subsystem or processing engine (e.g., from monitoring agents 245 of individual storage processing engine/s 1040, application processing engine/s 1070, etc.) to all other (or a selected number of) subsystems or processing engines (e.g., to monitoring agents 245 of such subsystems or processing engines) of an information management system. A distributed communication methodology may be implemented, for example, in a regulated or unregulated manner.

In an example of an unregulated manner, each individual subsystem or processing engine may communicate workload information/resource utilization status information to other subsystems or processing engines on an unregulated periodic basis. In an example of regulated manner, each individual subsystem or processing engine of an information management system may communicate workload information to a referee processing entity (e.g., system management processing engine 1060, system monitor 240, etc.) that then accumulates or coalesces this information and then forwards it selectively to other subsystems or processing engines (e.g., to monitoring agents 245 of such subsystems or processing engines) on a regulated periodic basis (e.g., on a customized as-needed basis for each individual processing engine). When a distributed communication methodology is implemented in a regulated manner, it may be advantageously employed to reduce system communication congestion that may result from multiple unregulated periodic workload messages sent between multiple processing engines that occur when using an unregulated distributed implementation.

It will be understood that the previously described centralized and distributed communication methodologies may be implemented in any suitable manner to enable inter-processing engine exchange of workload information. For example, a given processing engine may send workload information to other processing entities from a monitoring agent 245 of the given processing engine, and may also receive workload information from other processing engines on the same monitoring agent 245. However, it is also possible to implement a separate reporting agent on each processing engine that is responsible for sending workload information out to other processing engines, in addition to a monitoring agent 245 of the given processing engine that is responsible for receiving the workload information. Other suitable implementations may also be employed, e.g., using other types of modules or combinations thereof to achieve similar results.

### EXAMPLES

The following hypothetical examples are illustrative and should not be construed as limiting the scope of the invention or claims thereof.

### Examples 1-3

### Bandwidth Allocation Policies

Examples 1-3 relate to an application that is delivering streams (e.g., video streams) of long duration. In the following examples, it is assumed that one subdirectory contains premium content (subdirectory/P), and that other subdirectories on the file system have non-premium content. An external authorization scheme is provided to direct premium customers to the/P directory, and to deny access to this directory for non-premium users. In the scenario of the following examples, all policies are based on two priorities, and do not take into account other parameters that may be considered such as delivered bandwidth, storage or FC utilization, utilization of other system resources, etc.

### Example 1

### Strict Bandwidth Allocation Policy

In this example, the admission control policy states that 100 Mbit/s is reserved for premium content. No additional bandwidth is to be used for premium content. There are multiple logical conditions that must be detected and responses considered. 1000 Mbit/s is the maximum deliverable bandwidth.

Under the admission control policy of this example, a premium stream will be admitted if the total premium bandwidth after admission will be less than or equal to 100 Mbit/s, but will be denied admission if the total premium bandwidth after admission will exceed 100 Mbit/s. A non-premium stream will be admitted if total non-premium bandwidth after admission will be less than or equal to 900 Mbit/s, but will be denied admission if the total non-premium bandwidth after admission will be greater than 900 Mbit/s.

### Example 2

### Additional Premium Bandwidth Allocation Policy

In this example, the admission control policy states that 100 Mbit/s is reserved for premium content, but premium content will be allowed to peak to 200 Mbit/s, where bandwidth allocation to premium content greater than 100 Mbit/s will generate incremental billable traffic. Bandwidth from non-premium content is decreased in support of any additional premium bandwidth admitted. Therefore, in this example the platform is not over-subscribed.

Under the admission control policy of this example, a premium stream will be admitted if the total premium bandwidth after admission will be less than or equal to 200 Mbit/s, but will be denied admission if the total premium bandwidth after admission will exceed 200 Mbit/s. A log event will occur if total premium bandwidth admitted is greater than 100 Mbit/s. A non-premium stream will be admitted if total non-premium bandwidth after admission will be less than or equal to 800 Mbit/s, but will be denied admission if the total non-premium bandwidth after admission will be greater than 800 Mbit/s.

### Example 3

### Bandwidth Allocation Policy with Oversubscription

In this example, the admission control policy states that 100 Mbit/s is reserved for premium content. No additional bandwidth is to be used for premium content. Additional non-premium streams will be accepted if total bandwidth already being served is greater than 900 Mbit/s, and under the condition that premium users are NOT currently utilizing the full 100 Mbit/s. This scenario requires not only admission control behavior, but also requires system behavior modification should premium users request access when some of the 100 Mbit/s is being employed for non-premium streams.

Under the admission control policy of this example, a premium stream will be admitted if the total premium bandwidth after admission will be less than or equal to 100 Mbit/s, but will be denied admission if the total premium bandwidth after admission will exceed 100 Mbit/s. If the new total bandwidth after admission of a new premium stream will be greater than 1000 Mbit/s, non-premium streams will be degraded so that the total delivered bandwidth will be less than or equal to 1000 Mbit/s. A non-premium stream will be admitted if total admitted bandwidth (i.e., premium plus non-premium) after admission will be less than or equal to 1000 Mbit/s, but will be denied admission if the total admitted bandwidth after admission will be greater than 1000 Mbit/s.

To implement the policy of this example, bandwidth degradation of non-premium pool of streams may be accomplished, for example, by dropping one or more connections or typically more desirably, by degrading the rate at which one or more non-premium streams are delivered. In the latter case, once some of the premium bandwidth frees up, the non-premium streams may again be upgraded if so desired.

The three forms of policies represented in the foregoing examples may be used to handle an almost infinite number of possible configurations of an information management system or platform, such as a system of the type described in relation to the embodiment of FIG. 7. Furthermore, it will be understood that the principles utilized by these examples may be extended to cover a variety of information management scenarios including, but not limited to, for content delivery of multiple premium ‘channels’, for content delivery of multiple levels of premium channel, for metering bandwidth from a device serving files for multiple customers (e.g., where the customers have different classes of service), etc. Furthermore, an information management system utilizing the methodology of the above examples may also include an optional utility as previously described herein that helps a HSP who is deploying the platform to choose an optimum configuration for maximizing revenue.

### Examples 4-11

### Resource Utilization and Admission Control

### Example 4

### Resource Utilization Values

This example demonstrates how resource utilization values may be determined for a given information management task in one exemplary embodiment of the disclosed systems and methods. In this exemplary embodiment, the number of resource capacity utilization units consumed in the delivery of a given stream of streaming content by a storage processing engine of a content delivery system are determined. The specific type of resource capacity utilization units chosen for illustration purposes in this example are str-op resource capacity utilization units, although any other suitable type of resource capacity utilization units may be similarly employed. As described below, the total available number of str-ops for a subsystem may first be arbitrarily set. Then a calculation, based on performance analysis, may be conducted to set the number of str-ops a stream will consume.

In this example, a storage processing engine with 5 mirrors is assumed as subsystem. An arbitrary value of total available str-ops is set at 200,000 for the storage processing engine. One exemplary method for calculating the number of str-ops per stream may then be conducted as follows. For a storage processing engine having 5 mirrors, the available capacity for the storage processing engine, measured by total throughput, is a non-linear, non-polynomial function of the average stream rate that may be expressed by the following equation (1):

$$B W = max \{ 1024 , 2 * I O\_BW / ( 1 + sqrt ( 1 + 8 * AA * {IO\_BW}^{2} / ( B * R * ND ) ) ) \} = max \{ 1024 , 2 * ( 140 * 8 ) / ( 1 + sqrt ( 1 + 8 * 0.008 * {( 140 * 8 )}^{\hat{}} 2 / ( 1.5 * 8 * 5 * R ) ) ) \} \qquad ( 1 )$$

where: IO_BW represents overall total throughput a storage processor is capable of supporting, (which is determined by the number of fiber channels and the number of disk drives); AA represents estimated average disk access overhead for each I/O; B represents total available buffer space in the storage processor; R represents average stream rate that the concerned system is expected to encounter; and ND represents the number of disk drives that can contribute the simultaneous stream contents. Further information on average access (AA) may be found in U.S. patent application Ser. No. 09/947,869, filed Sep. 6, 2001 and entitled “SYSTEMS AND METHODS FOR RESOURCE MANAGEMENT IN INFORMATION STORAGE ENVIRONMENTS” by Qiu et. al, the disclosure of which is incorporated herein by reference.

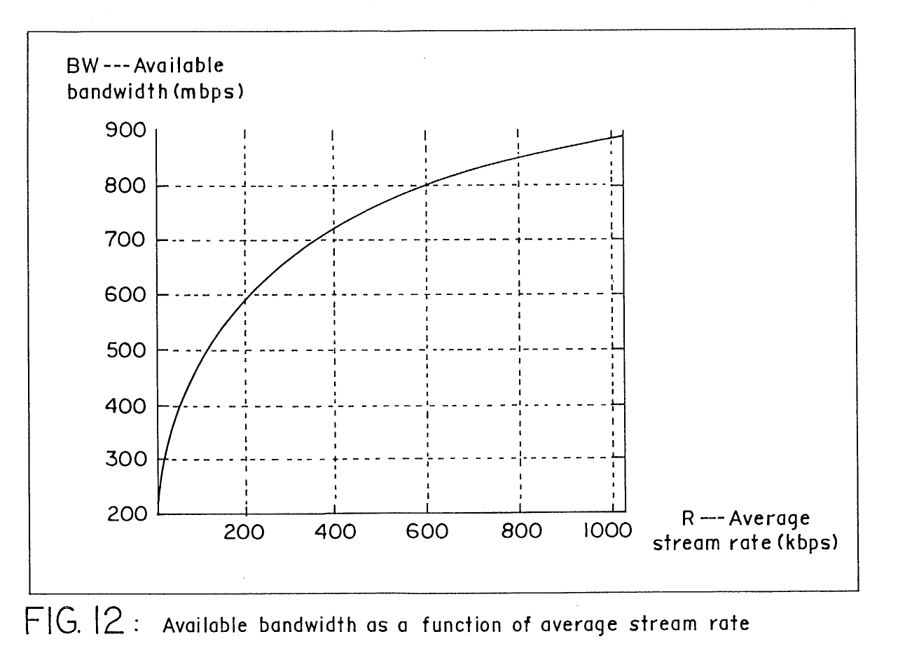

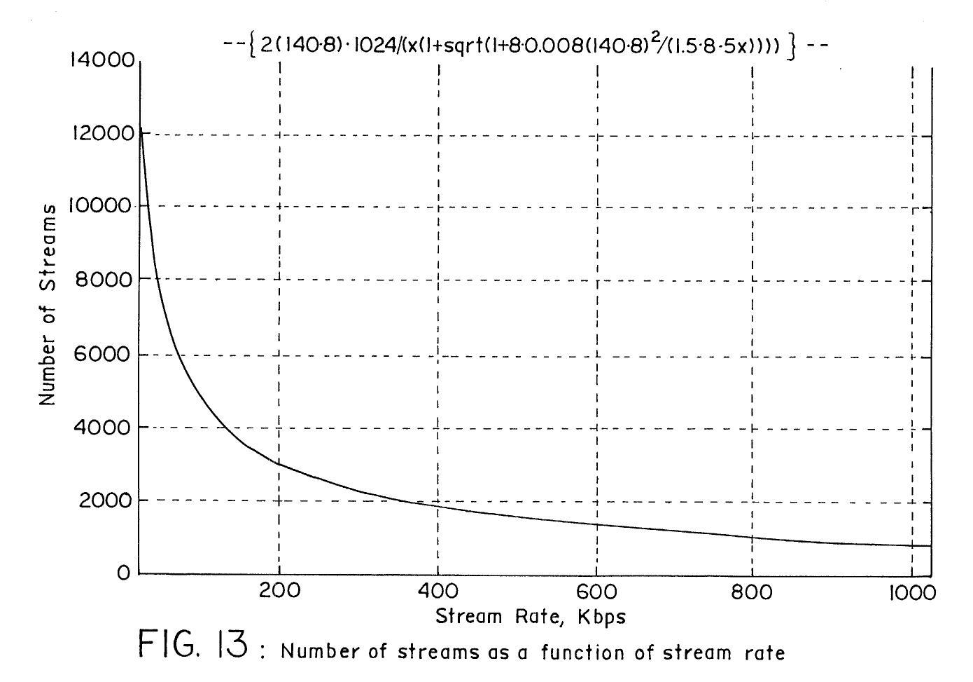

FIG. 12 shows the available bandwidth or total throughput for the storage processing engine as a function of the average stream rate generated based on equation (1). Using benchmarking and performance analysis, a total throughput curve may be generated for the storage processing engine as a function of stream rates, and from the same data set the number of streams may be derived as a function of stream rates as shown by the equation and graph in FIG. 13.

Because total available str-op units is 200,000 for the given storage processing engine of this example, the str-op number per stream may be derived as a function of stream rate by dividing 200,000 by the total number of streams for each stream rate. The upper curve shown in FIG. 14 represents the number of str-ops per stream as a function of stream rates. From the equation and graph of FIG. 14, a resource utilization table for the given storage processing unit of this example may be generated (see Table 1). Alternatively, the number of str-ops per stream as a function of stream rates may be represented as a linear finction, as shown by the straight line shown in FIG. 14.

TABLE 1
Resource Utilization Table for Storage Processing Engine of Example 1

| Stream | Number of str-op units per |
|---|---|
| rate, kbps | stream |
| 16 | 20 |
| 20 | 20 |
| 34 | 27 |
| 45 | 35 |
| 80 | 40 |
| 150 | 55 |
| 350 | 100 |
| 450 | 120 |
| 1024 | 250 |

### Example 5

### Automated Generation of Resource Utilization Table

In this example, an exemplary method of automatic generation of a multiple slope resource utilization table is described and illustrated. To begin the automatic generation of the table, benchmark performance measurement data was obtained from the output of a benchmarking tool that was run against a content delivery system, such as illustrated in FIG. 1A. The benchmark performance measurement data obtained was then used to construct a new input parameter file. In this example the multiple stream rates of Table 2 have been selected as representative sample stream rates for testing. The sample data points of Table 2 may be imported into an overload and policy finite state machine module in any suitable way, for example, by using an input parameter file (e.g., .ini file).

TABLE 2
Benchmark Test Stream Rates

| | | | | | | | | | | |
|---|---|---|---|---|---|---|---|---|---|---|
| Stream Data Rate | 16 | 20 | 34 | 45 | 80 | 150 | 350 | 450 | 1000 | 3000 |
| Actual Streams | 12050 | 12050 | 8668 | 7016 | 4406 | 2800 | 1395 | 1133 | 560 | 187 |

Next, the benchmark performance data of Table 2 is converted into a resource utilization sample table. For example, a base total available resource utilization value (e.g., 12,050 str-ops) may be assumed, and then the sample data points of Table 2 converted into resource utilization values for a resource utilization sample table, as shown in Table 3 below.

TABLE 3
Resource Utilization Sample Table

| | | | | | | | | | | |
|---|---|---|---|---|---|---|---|---|---|---|
| Stream Data Rate | 16 | 20 | 34 | 45 | 80 | 150 | 350 | 450 | 1000 | 3000 |
| Unit str-ops | 1.394 | 1.394 | 1.938 | 2.39 | 3.813 | 6 | 12 | 14.8 | 30 | 90 |

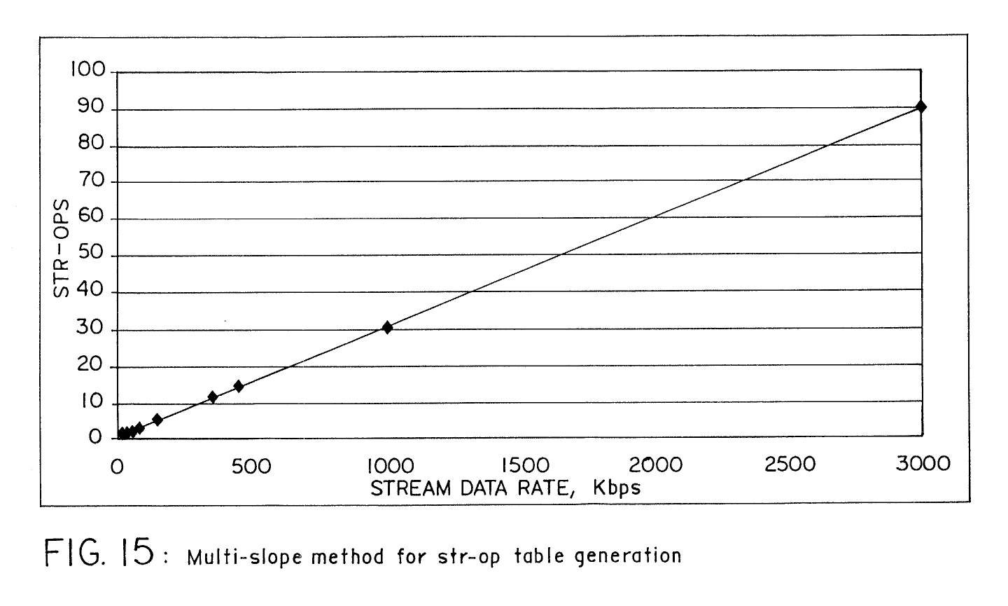

Using the sample data of Table 3, a piece-wise linear finction is constructed for a resource utilization table. As illustrated in FIG. 15, each pair of sample data in Table 3 with adjacent stream rates, such as (20, 1.394) and (34, 1.938), form two points in a x-y plane. These two points define one and only one straight line that may be presented by a straight-line equation with a slope constant and a y-intercept constant. For the example of (20, 1.394) and (34, 1.938), the straight line and its constants can be easily determined, for example, by using the following formula:

Slope=(1.938−1.394)/(34−20)=0.0389;

Y-intercept=1.938−Slope*34=0.6171.

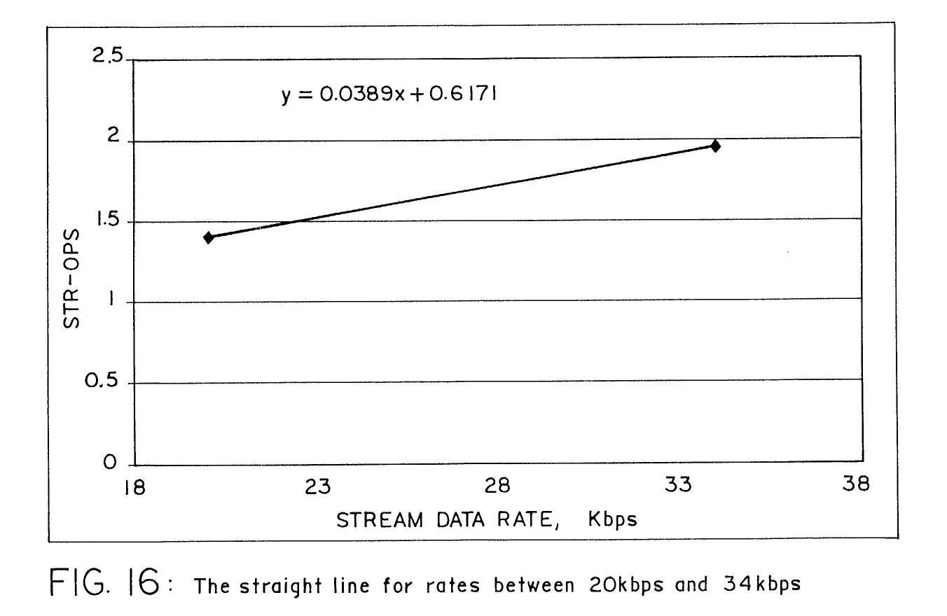

FIG. 16 illustrates more closely the construction of the straight line for this particular pair of two sample data points. The same calculation may be applied to every pair of the sample data in Table 3.

When a new stream rate occurs, its resource utilization value may be given by a pair of known resource utilization values associated with streams having the nearest streaming rates For example, when a new stream with a given rate R (e.g., 28 kbps) arrives for admission, its resource utilization value needs to be calculated. Because the given rate is not in the sample data table, its resource utilization value is unknown. However, because the given rate 28 kbps is between 20 kbps and 34 kbps (e.g., rates having known resource utilization values shown in Table 3), the resource utilization value (RUV) for the new stream may be determined using the straight line equation of FIG. 16:

RUV (28)=0.0389*28+0.6171=1.7063 str-ops

As another example, assume a new stream having a rate of 2250 kbps. Checking Table 3 the two nearest points are chosen (1000 kbps, 30 str-op units) and (3000 kbps, 90 str-op units). Using the same linear interpolation method:

Slope=(90−30)/(3000−1000)=0.03;

y-intercept=30−0.03*1000=0.

This straight line is illustrated in FIG. 17. The resource utilization value for the new stream at b 2250 kbps may be determined as follows:

RUV (2250)=0.03*2250+0=67.5 str-ops.

It will be understood that in this example, a resource utilization table may be configured to characterize resource usage for content streams of various types, e.g., stored video/audio clips (i.e. “.ra” and “.rm” files), stored SureStream files, live stream in either unicasting mode or multicasting mode, etc.

### Example 6

### CoS Dispatching and Arrival Queues

In this example, an overload and policy finite state machine module is implemented to run in an infinite while loop. Within each iteration, already-processed requests in the dispatch (output) queues are first flushed in their priority order. All messages in the dispatching queues will be dequeued in their priority order and sent to intended entities in determinism module 3000 as illustrated and described herein in reference to FIG. 11A.

Next, arrival queues are checked and processed. In this example, five CoS arrival (input) queues may be provided:

1) COS_CTL: The control messages have the highest priority.

2) COS_GOLD: The highest priority queue for client/user requests.

3) COS_SILVER: The second highest priority queue for client/user requests.

4) COS_BRONZE: The third highest priority queue for client/user requests.

5) COS_LEAD: The low est priority queue for client/user requests.

The arrival dequeueing procedure starts with the control message queue (i.e. COS_CTL). All messages in the control queue will be processed first and unconditionally. The dequeueing for other request queues follow their priority order and the weights assigned to each queue. Upon checking if there are any messages in the gold class queue (COS_GOLD), they will be dequeued and processed. The total number of messages to be dequeued in the current iteration is capped by the weight associated with the gold class queue (COS_GOLD). Next, upon checking if there are any messages in t he silver class message queue (COS_SILVER) they are dequeued and processed in a similar manner. The same process of checking and dequeueing is followed next for the bronze class message queue (COS_BRONZE), and then followed last for the lead class message queue (COS_LEAD). A dequeued request from the COS_CTL queue is communicated to a subsystem module that handles control messages/subsystem status feedbacks, e.g., subsystem status monitor 3040 of FIG. 11A. A dequeued request from one of the client/user CoS request queues is communicated to a subsystem module that exercises admission control logics, e.g., overload and policy finite state machine module 3010 of FIG. 11A. One example of further processing of each type of request from this point forward is described in Example 7 herein.

The summation of all weights to the request queues (GOLD, SILVER, BRONZE, and LEAD) is the maximal number of requests that may be processed in the rest of the current iteration. The maximal number of requests that may be processed in the current iteration for each queue is bounded by their corresponding weights. This is the normal weighted round robin algorithm.

Two examples of other types of possible WRR algorithms possible in the practice of the disclosed systems and methods include, but are not limited to, algorithms in which the current iteration may be broken if new requests arrive at higher priority queues (e.g., GOLD) before the requests in lower priority queues (e.g., SILVER and below) are processed. Specifically, using one of these algorithms allows the newly arriving client/user requests in higher-class queues to interrupt the current iteration, to skip the process for lower class queues, and to jump to the next iteration. In doing so, they allow faster processing of higher-class messages at the expense of the lower class queues. In a “Very Strong Weighting” implementation, the arrival of the new higher priority request is allowed to break the current iteration almost immediately (i.e., the higher queue is checked for new client/user requests before processing every message in the lower queues). In a “Strong Weighting” implementation, the arrival of the higher priority request is only allowed to break the current iteration when the dequeueing moves to the next queue (i.e., the higher queue is checked for new client/user requests only before starting to process a lower queue). The implementation of the three WRR algorithms of this example may be used to allow fine-tuning and balancing of the response time for client/user requests and for internal status updates.

It will be understood that the number and types of CoS queues, as well as the three WRR algorithms described in this example are exemplary only, and that many other numbers and types of CoS queues and/or WRR algorithms are possible. For example, an additional queue may be provided for messages that inform of the termination of some service sessions (e.g., “free queue”). When present, the messages in such a queue may be treated in a priority equal to the control message queue (COS_CTL) to ensure that resources may be recovered as soon as possible to give new client/user requests a better chance to be accepted.

### Example 7

### State Thresholds and Admission Control

In this example, a content delivery system or subsystem thereof may be configured with a maximum desired total resource utilization value, that may be denoted as “User_MaxOPs”. Such a value may be may be a default value specified by an overload and policy finite state machine module or may be defined for the overload and policy finite state machine module in an initialization file.

For this example, it is first assumed that the user perceived User_MaxOPs for a subsystem of the content delivery system is equal to 100 str-ops, and that another 10-15 str-ops is held in reserve. Assuming that the current total resource utilization value for the subsystem is 92 str-ops, and a newly requested relatively high bandwidth stream at 1 mbps would require 10 str-ops, then upon admittance of this new client/user request the total resource utilization value would be 92+10=102 str-ops, which is greater than the 100 str-op value of User_MaxOPs. Therefore, absent additional resource utilization value to temporarily draw from for this request, the overload and policy finite state machine module will reject the new client/user request.

Next, for the same subsystem it is assumed that the current total resource utilization value for the system is 97 str-ops, and a newly requested relatively lower bandwidth stream at 20 kbps would require 2 str-ops, then upon admittance of the new client/user request the total resource utilization value would be 97+2=99, which is less that the 100 str-op value of User_MaxOPs, and the overload and policy finite state machine module will accept the new client/user request.

Next, for this example it is assumed that the overload and policy finite state machine module is set up with state thresholds (e.g., whether or not to accept a new client/user request is based on the current subsystem resource state threshold), and an admission control policy may be defined for this example as follows:

| | |
|---|---|
| | If (currentUsage < RedOPs AND currentUsage + newusage < = |
| | BlackOPs) |
| | Accept the new request. |
| Else | |
| | Reject the new request. |

wherein:

1) RedOPs=User_MaxOPs. Overload and policy finite state machine module “views” this as what a user perceives to be safe total resource utilization value.

2) BlackOPs=Black Percentage * RedOPs. This is the additional resource utilization value that the overload and policy finite state machine module may temporarily utilize under certain circumstances described below.

3) MaxOPs=RedOPs+BlackOPs. The overload and policy finite state machine module treats this as the absolute maximal resource utilization value and will never allow the resource usage to exceed this level.

4) YellowOPs=Yellow_threshold * MaxOPs. This is the warning level, indicating the system entering a busy (or heavy) load.

In this case, a temporary additional resource utilization value (e.g., BlackOPs) is provided for the overload and policy finite state machine module to draw from to optimize resource utilization, e.g., to assist admittance of relatively high bandwidth streams where additional useable resources are available. Assuming that User_MaxOPs=100, and Black_Percentage=2%:

RedOPs=User_MaxOPs=100;

BlackOPs=2% * 100=2; and

MaxOPs=RedOPs+BlackOPs=100+2=102.

In this example, admission control decisions may be based on the current resource state threshold and the would-be resource state threshold if a new client/user request is accepted. Using the above-defined policy, the overload and policy finite state machine module will accept both the 1 mbps stream and the 20 kbps stream in the previous example. However, in the case that the total usage is already 100 str-ops, and a new client/user request at 20 kbps is received that requires only 2 str-ops, the new client/user request will not be accepted. Thus, if one of the subsystems in the service path for a new client/user request shows “RED” or “BLACK” state, then the new client/user request is rejected.

To summarize this example, for each subsystem the decision of admitting a new stream may be based on the following policy:

a. The resource status for the subsystem is not in “RED” state; and

b. The remaining available resource utilization value, after discounting the needed resource capacity utilization units for the new stream, will not trigger a resource “BLACK” state.

If a new stream is to be admitted by a subsystem, the exemplary finite state machine illustrated in Table 4 and described in relation to Example 9 may be used to adjust the new resource state. Upon termination of a stream, its resource capacity utilization units may be returned to the available resource utilization value pool, the process of which may cause resource status changes.

### Example 8

### Transition Between Modes

In this example, an overload and policy finite state machine module is implemented in a determinism module using two system/subsystem state information sources: 1) system states based on resource usage accounting (e.g. str-op usage); and 2) real-time state information feedback (e.g., received via subsystem resource status messages) from each subsystem. Using the methodology of this Example, the overload and policy finite state machine module uses system states based on resource usage accounting as its baseline, but is configured to act upon receipt of real-time state information feedback (e.g., such as resource state warnings) from one or more subsystems. The overload and policy finite state machine module implements the following synchronization finite state machine to synchronize the two above-described resource state views, 1) and 2), to perform admission control under three modes:

a. Estimation-based mode (i.e., table driven mode based on resource usage accounting). This is the normal and default mode.

b. Status-driven mode. This is the mode employed upon identification of an inconsistency between pre-defined resource utilization values and measured resource utilization values in a given subsystem. In this mode, admission control decisions are based on the resource usage status reports from the given subsystem.

c. Transient mode (e.g., Orange state threshold). This is the mode employed upon identification of a relatively large inconsistency between pre-defined resource utilization values and measured resource utilization values in a given subsystem, and further verification is made to determine whether or not the report from the subsystem is a transient condition or a real resource state. This state may also be entered when some messages arrive at the synchronization finite state machine in the wrong order.

Admission control may be performed in this example under the above three modes based on two values, Tracked_Resource_State (TRS) based on current resource measurement counter value, and Reported_Resource_State (RRS) based on subsystem resource status message (e.g., system management/status/control message). In this regard, TRS represents the resource state threshold obtained by comparing current total resource utilization value against predefined state threshold triggers, for example as described above in Example 7. RRS reflects the resource state threshold obtained using resource status information reported directly by the subsystem as a subsystem resource status message or reported indirectly as an overall resource status message via a separate module, such as wellness/availability module 3100 of FIG. 1 B. In the first case, the subsystem resource status message reports resource state threshold. In the latter case, information in the overall resource status message may be compared with pre-defined trigger parameters to determine a resource state threshold.

In this example, admission control may be implemented with transitioning between the three modes in a manner as follows based on TRS and RRS values:

1) TRS>=RED & RRS>=RED: The two sides of the information sources are at least roughly in synchronization and there is no ambiguity in admission control decision:

A. Mode Transition——If already in Estimation-based mode, then remain in Estimation-based mode. If in Transient mode, then transition to Estimation-Based mode. If in Status-Driven mode, then transition to Transient mode.

B. Admission Control Decision——Reject the new stream/request. 2) TRS<RED & RRS<RED: The two sides of the information sources are at least roughly in synchronization and there is no ambiguity in admission control decision:

A. Mode Transition——If in Transient mode, then transition to Estimation-Based mode. If in Status-Driven mode, then transition to Transient mode.

B. Admission Control Decision——Accept the new stream/request. 3) TRS>=RED & RRS<RED: The tracked resource utilization value indicates that the resource state is still in Red, but the subsystem report shows that it is no longer in Red. A determination needs to made as to which value is to be followed (i.e., a transition policy is invoked):

A. Mode Transition——If in Estimation-based mode, then transition to Transient mode. If already in Transient mode, then transition into Status-driven mode. If in Status-driven mode, then remain in Status-driven mode.

B. Admission Control Decision——Reject the new stream/request. 4) TRS<RED & RRS>=RED: The tracked str-op usage indicates that the resource state is not in Red, but the subsystem report shows that it is already in Red. A determination needs to made as to which value is to be followed (i.e., a transition policy is invoked).

A. Mode Transition——If in Estimation-based mode, then transition to Transient mode. If already in Transient mode, then transition into Status-driven mode. If in Status-driven mode, then remain in Status-driven mode.

B. Admission Control Decision——Reject the new stream/request.

In summary, if TRS and RRS values are in synchronization (i.e., as in scenarios 1 and 2 immediately above), then admission control proceeds in its normal mode, i.e., in estimation-based mode. However, if an inconsistency exists between TRS and RRS values (i.e., as in scenarios 3 and 4 immediately above), then the system should proceed with caution while trying to synchronize the two values as soon as possible. Described above is a general synchronization policy that may be implemented in one exemplary embodiment of the disclosed systems and methods. In further exemplary embodiments, it is possible to implement additional refinements to the methodology of this Example to further improve robustness of an overload and policy finite state machine module. For example, the following two policies may be implemented:

1) Under some conditions of inconsistency between TRS and RRS values, the overload and policy finite state machine module may be configured to accept new streams/requests if it decides that the potential damage to the system upon admittance of such new streams/requests is minimal. For example, a defined parameter “redOpsDeviationTrigger” may be used as a measure of whether or not the TRS exceeds the “Red status trigger” by a minimal amount that is deemed acceptable for a given system. For example, redOpsDeviationTrigger may be set to a value of about 3% of total available resource utilization value, and if admittance of a new stream/request will result in a current resource utilization value that exceeds the “Red” state threshold resource utilization value by less than about 3% of the total available resource utilization value, then the new stream will be accepted. 2) When the overload and policy finite state machine module first transitions into Transient Mode, it may be configured to send a status query message “out-of-band” (meaning: using the highest priority message class) to the concerned subsystem(s) to re-check the resource state. This policy may be implemented to shorten the time for the overload and policy finite state machine module to stay in an undetermined mode (i.e., the Transient mode).

FIG. 18 illustrates a finite state machine that may be used to implemented the policies of this example.

### Example 9

### Transition Between State Thresholds

Table 4 is a state transition definition table illustrating performance of post admission resource state management actions according to one embodiment of the disclosed systems and methods. In Table 4, TRS represents Tracked_Resource_State based on the current resource measurement (e.g., str-op) counter value and RRS represents Reported Resource_State from subsystem resource status message (e.g., system management status/control message reported subsystem resource state). For example, as used in Table 4, “TRS<Yellow” means the current resource measurement counter value is less than a Yellow state threshold value, “RRS=Red” means a subsystem resource status message indicates resource utilization for the concerned subsystem is in Red state, and “Subsystem fails” means a subsystem resource status message indicates the subsystem fails.

For each current state threshold in which a given system/subsystem may currently exist, Table 4 lists the possible actions that may be triggered, and resulting new state thresholds that may occur, based on various TRS and RRS information. For illustration purposes Table 4 describes actions with reference to the exemplary finite state machine of FIG. 18. However, it will be understood that even though the method of Table 4 refers to the exemplary finite state machine of FIG. 18 when mentioning various modes, the method of this table is not limited to implementation with the finite state machine of FIG. 18, which is only one possible exemplary embodiment of finite state machine that may be employed in the practice of the disclosed systems and methods. In this regard, FIG. 18 may be considered to represent simplified state transition at a higher level, i.e., one exemplary embodiment of how to handle the possible discrepancies that may occur between current total resource utilization value-based information (TRS) and the corresponding reported resource state from a concerned subsystem (RRS). It should be noted that FIG. 18 uses a “Transient” mode designation corresponding to the “Orange” state threshold of Table 4.

TABLE 4
State Transition Definition Table

| Current | | | Resultant |
|---|---|---|---|
| State | Trigger | Action | State |
| Green | TRS < Yellow, AND | In “Estimation-based” | Green |
| | RRS = Green | mode (FIG. 18). | |
| Green | TRS > = Yellow, AND | In “Estimation-based” | Yellow |
| | TRS < Red; OR | mode (FIG. 18). | |
| | RRS = Yellow | | |
| Green¹ | TRS < Red, AND | Request Status message | Orange |
| | RRS = Red | immediately; | |
| | | Enter “Transient” mode | |
| | | (FIG. 18). | |
| Green | TRS > = Red | In “Estimation-based” | Red |
| | | mode (FIG. 18). | |
| Green | Subsystem fails | Nullify TRS for this | Black |
| | | subsystem | |
| | | Enter “Status-driven” | |
| | | mode (FIG. 18). | |
| Yellow | TRS < Yellow, AND | In “Estimation-based” | Green |
| | RRS = Green | mode (FIG. 18). | |
| Yellow | TRS > = Yellow, AND | In “Estimation-based” | Yellow |
| | TRS < Red, OR RRS = | mode (FIG. 18). | |
| | Yellow | | |
| Yellow | TRS < Red, AND | Request Status message | Orange |
| | RRS = Red | immediately; | |
| | | Enter “Transient” mode | |
| | | (FIG. 18). | |
| Yellow | TRS > = Red | In “Estimation-based” | Red |
| | | mode (FIG. 18). | |
| Yellow | Subsystem fails | Nullify TRS for this | Black |
| | | subsystem | |
| | | Enter “Status-driven” | |
| | | mode (FIG. 18). | |
| Orange | TRS < Yellow, AND | In “Estimation-based” | Green |
| | RRS = Green | mode (FIG. 18). | |
| Orange | TRS > = Yellow, AND | In “Estimation-based” | Yellow |
| | TRS < Red, AND RRS = | mode (FIG. 18). | |
| | Yellow | | |
| Orange | TRS < Red, AND RRS = | Enter “Status-driven” | Red |
| | Red | mode (FIG. 18). | |
| Orange | TRS > = Red, AND | In “Estimation-based” | Red |
| | RRS = Red | mode (FIG. 18). | |
| Orange | Subsystem fails | Nullify TRS for this | Black |
| | | subsystem. | |
| | | Enter “Status-driven” | |
| | | mode (FIG. 18). | |
| Red | TRS < Yellow, AND | In “Estimation-based” | Green |
| | RRS = Green | mode (FIG. 18). | |
| Red | TRS > = Yellow, AND | In “Estimation-based” | Yellow |
| | TRS < Red, AND RRS = | mode (FIG. 18). | |
| | Yellow | | |
| Red | TRS < Red, AND | Request Status message | Orange |
| | RRS = Red | immediately; | |
| | | Enter “Transient” mode | |
| | | (FIG. 18). | |
| Red | TRS > = Red | In “Estimation-based” | Red |
| | | mode (FIG. 18). | |
| Red | Subsystem fails | Nullify TRS for this | Black |
| | | subsystem | |
| | | Enter “Status-driven” | |
| | | mode (FIG. 18). | |
| ¹In one exemplary embodiment, it is possible to add additional stabilizing parameters to the above state transition table to address cases when the resource utilization status is not stable (e.g., such as CPU utilization percentage in some applications that may experience short spikes),. For example, it is possible to modify the indicated trigger condition TRS < RED, AND RRS = RED to instead be: (1 − 0.1)*Red < = TRS < Red, AND RRS = Red. | | | |
| #Otherwise, there will be no move to the Orange state. This modification may be implemented to reduce the status check messages in the system. | | | |

### Example 10

### Admission Control Using Resource Utilization Value Quantification

FIG. 19 is a flow diagram illustrating an exemplary embodiment of a method 6000 for deterministic delivery of content in response to a request for the same, as it may be enabled using multi-dimensional resource utilization value quantification and as it may be implemented in a content delivery system using overload and policy finite state machine module 3010 of FIG. 11A. As with FIG. 5, although FIG. 19 is described in relation to content delivery, it will be understood with benefit of this disclosure that the deterministic methods and systems described herein may be used in a wide variety of information management scenarios, including application serving, and are therefore not limited to only processing requests for content. It will also be understood that the types of content that may be deterministically managed or delivered include any types of content described elsewhere herein, e.g., static content, dynamic content, etc.

In FIG. 19, method 6000 may being in the same manner as method 100 of FIG. 5, with awaiting a request for content at step 6105, receiving a request for content at step 6105, filtering the request at step 6110, and evaluating the request at step 6115, with these steps being the same as described in relation to FIG. 5. At step 6200 the current system status is evaluated, and if any one of the subsystems or processing engines in the service path for the request is in the “BLACK” state, then the new request is rejected at step 6210. After rejection at step 6210, the new request proceeds to step 6220 for reconsideration for admission, beginning with evaluation of the request at step 6115 occurring once again. These steps will be repeated and the request will be maintained in its waiting queue until no subsystems or processing engines in the service path for the content access/delivery request are in the “BLACK” state, or until the request has expired (e.g., via expiration of automatic timer or client termination as described further below).

If none of the subsystems or processing engines in the service path for the request is in the “BLACK” state, then the new request is submitted for admission and resource usage accounting performed at step 6230 by adding the resource measurement value associated with fulfilling the new request to the current total resource utilization value associated with existing requests for information management currently admitted and being processed by each system and/or subsystem in the service path for the request to obtain an incremental resource measurement counter value that represents the incremented total resource utilization value for each such subsystem/processing engine that would result if the new request is admitted.

Next, in step 6240 the incremented total resource utilization values determined in step 6230 are considered to ensure that all of these incremented values correspond to a state threshold that is equal to Red, or that is lower than Red (e.g., Yellow or Green). If any of the incremented values correspond to a state threshold that is greater than Red (e.g., Black), then the new request is rejected at step 6210.

If at step 6240 all incremented total resource utilization values correspond to a state threshold that is equal to or lower than Red, then one or more handling policies may be evaluated at step 6250 to determine the proper disposition of the request for content. Examples of possible parameters that may be evaluated at step 6250 to determine the appropriate handling policy for a given request include, but are not limited to, resource availability, capability and/or anticipated time until availability of resources in the present content delivery system, the source of the request, the request priority (e.g., SLA, QoS, CoS), etc. As described in relation to step 150 of FIG. 5, it is possible to select a given policy on a request-by-request or user-by-user basis, for example, based on a specified maximum allowable content delivery time frame that may vary for each request according to one or more parameters such as type of request, type of file or service requested, origin of request, identification of the requesting user, priority information (e.g., QoS, Service Level Agreement (“SLA”), etc.) associated with a particular request, etc.

After policy evaluation in step 6250, if it is determined not to accept the new request, then the request is rejected at step 6210. However, if it is determined to accept the request, then the request is placed into a dispatch queue at step 6260 according to the evaluated policy. In this regard, the request may be placed into an appropriate dispatch queue based on CoS priority. Next, the request is dispatched at step 6270, for example, by weighted round robin algorithm. Method 6000 then returns to step 6105 where receipt of a subsequent request for content is awaited by the system.

It will be understood with benefit of this disclosure that the flow diagram of FIG. 19 represents only one possible embodiment that may be implemented using the disclosed systems and methods. Further, it will be understood that a particular request enters the flow diagram of FIG. 19 may have several outcomes. For example, the request may be admitted at step 6250 (either the first time or after two or more iterations). Alternatively the request may terminate as a result of being dropped by the requesting remote client, or as a result of action by a determinism module 3000 (e.g., via timer check as described below).

For example, after a request is rejected at step 6210 in one iteration of the decision flow of FIG. 19, its fate may depend on the implementation of desired policy. One possible policy implementation is to always keep the rejected request in the waiting queue for later resubmittal for admission. This policy is reflected in FIG. 19 by the line from step 6220 back to step 6115. However, another possible implementation (not illustrated in FIG. 19) is to immediately and finally reject the request at step 6210 without resubmittal for admission. This may be implemented, for example, by preparing a rejection response message and sending the rejection response message to the application processing engine via dispatch queue. Upon receiving the rejection response, the application processing engine may communicate with the remote client to terminate the connection.

Another alternative policy implementation is to eliminate step 6220 (along with the flow line from step 6220 back to step 6115) and replace it with a line from step 6210 to step 6270, so that the request is dispatched after rejection. Yet another possible policy implementation is to employ an internal timer to limit how long a particular rejected request may stay in the waiting queue and be resubmitted for admission via step 6220 and the line from step 6220 back to step 6115. In this possible implementation, a timer check may be performed when the request processing flows from step 6210 and into step 6220 to measure the time that the given request has been cycling between steps 6210, 6220 and 6115 with respect to a defined time limit. If the time limit has not been exceeded (e.g.., the timer hasn't expired), then the request may go back to the waiting queue at step 6220. However, if the timer has expired, then a rejection message is sent to the dispatch queue. It is possible to implement this time policy in a policy-based manner (e.g., in a CoS-based manner, meaning that the timer may take on various time limit values based on its policy, CoS and/or QoS requirements, etc.).

### Example 11

### Application Processing Engine Admission Control and Resource Threshold Alerts

In the exemplary embodiment of this example, the disclosed systems and methods may be implemented to detect and prevent overcapacity in a content delivery system that includes multiple application processing engines in a manner as follows. Each application processing engine may be configured with the ability to independently implement admission control functionality, for example through a software plug-in that is capable of checking the availability of application processing resources upon each stream request (e.g., content transaction) received by the content delivery system. Such a plug-in may either grant or deny each stream request based on the availability of application processing engine resources. In this regard, application processing engine resources may be measured or otherwise quantified as resource capacity utilization units that may take into account one or more actual resources and/or other parameters, such as compute utilization, arrival rates, total number of connections, bandwidth limits, etc. It will be understood that implementation with application processing engines of a content delivery system is described in this example for illustration purposes, but that similar methodology may be implemented with any type of subsystem or processing engine of any type of information management system, for example, any other processing engine and/or information management system described elsewhere herein.

As stream requests are granted and as sessions are terminated, the plug-in may additionally perform bookkeeping functions to track the quantity of available resource capacity utilization units versus the quantity of allocated resource capacity utilization units. For example, the plug-in may be configured to prevent over-utilization of total available resource capacity utilization units, and in a manner that guarantees that an accepted stream request is satisfied by delivery of the stream in a reliable manner. The plug-in may monitor or track the number of allocated or used resource capacity utilization units per application processing engine in relation to one or more pre-defined “water marks” or thresholds, and may also generate alerts or invoke policies when the number of allocated or used resource capacity utilization units for given application processing engine exceeds and/or recedes below each of these pre-defined thresholds.

In one exemplary embodiment of this example, the following resource threshold alerts may be implemented by an application processing engine plug-in, for example, to alert a system administrator: 1) Alert issued when yellow alert threshold exceeded, representing that application processing engine resource utilization level is not yet at a pre-defined critical level, but is at a level approaching the critical level. 2) Alert when yellow alert receded (resource utilization drops below yellow threshold) indicating that the yellow alert condition is cancelled. 3) Alert issued when red alert threshold exceeded indicating that application processing engine resource utilization level is at maximum capacity, and although the system is continuing to function reliably with current accepted stream requests, all new content stream requests are to be rejected. 4) Alert when red alert receded (resource utilization drops below yellow threshold) indicating that the red alert condition is cancelled.

In this exemplary embodiment, a “debounce” capability may be implemented to avoid flooding a system administrator with threshold alerts. Such a debounce capability be implemented, for example by algorithm/s, to ensure that an application processing engine remains in a state that exceeds or recedes below a given alert threshold state for a pre-defined amount of time to ensure that it is not a transient state.

In this exemplary embodiment, alerts may be generated and communicated to a system administrator in a number of different ways including, but not limited to, by way of Web User Interface Alert Frame, via SNMP Traps, via Email notification, etc. Threshold alerts may be configured to be enabled or disabled by a system administrator. When the content delivery system reaches maximum capacity, all new stream requests may be rejected.

It will be understood with benefit of this disclosure that although specific exemplary embodiments of hardware and software have been described herein, other combinations of hardware and/or software may be employed to achieve one or more features of the disclosed systems and methods. For example, various and differing hardware platform configurations may be built to support one or more aspects of deterministic functionality described herein including, but not limited to other combinations of defined and monitored subsystems, as well as other types of distributive interconnection technologies to interface between components and subsystems for control and data flow. Furthermore, it may be understood that operating environment and application code may be modified as necessary to implement one or more aspects of the disclosed technology, and that the disclosed systems and methods may be implemented using other hardware models as well as in environments where the application and operating system code may be controlled.

Thus, while the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus, systems and methods may be utilized in various combinations and/or independently. Thus the invention is not limited to only those combinations shown herein, but rather may include other combinations.

### REFERENCES

The following references, to the extent that they provide exemplary system, method, or other details supplementary to those set forth herein, are specifically incorporated herein by reference.

U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”

U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS”

U.S. patent application Ser. No. 09/797,413 filed on MAR. 1, 2001 which is entitled “NETWORK CONNECTED COMPUTING SYSTEM”

U.S. Provisional Patent Application Serial No. 60/285,211 filed on Apr. 20, 2001 which is entitled “SYSTEMS AND METHODS FOR PROVIDING DIFFERENTIATED SERVICE IN A NETWORK ENVIRONMENT,”

U.S. Provisional Patent Application Serial No. 60/291,073 filed on May 15, 2001 which is entitled “SYSTEMS AND METHODS FOR PROVIDING DIFFERENTIATED SERVICE IN A NETWORK ENVIRONMENT”

U.S. Provisional Patent Application Serial No. 60/246,401 filed on Nov. 7, 2000 which is entitled “SYSTEM AND METHOD FOR THE DETERMINISTIC DELIVERY OF DATA AND SERVICES”

U.S. patent application Ser. No. 09/797,200 filed on Mar. 1, 2001 which is entitled “SYSTEMS AND METHODS FOR THE DETERMINISTIC MANAGEMENT OF INFORMATION”

U.S. Provisional Patent Application Serial No. 60/187,211 filed on Mar. 3, 2000 which is entitled “SYSTEM AND APPARATUS FOR INCREASING FILE SERVER BANDWIDTH”

U.S. patent application Ser. No. 09/797,404 filed on Mar. 1, 2001 which is entitled “INTERPROCESS COMMUNICATIONS WITHIN A NETWORK NODE USING SWITCH FABRIC”

U.S. patent application Ser. No. 09/947,869 filed on Sep. 6, 2001 which is entitled “SYSTEMS AND METHODS FOR RESOURCE MANAGEMENT IN INFORMATION STORAGE ENVIRONMENTS”

U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT”

U.S. Provisional Patent Application Serial No. 60/246,343, which was filed Nov. 7, 2000 and is entitled “NETWORK CONTENT DELIVERY SYSTEM WITH PEER TO PEER PROCESSING COMPONENTS”

U.S. Provisional Patent Application Serial No. 60/246,335, which was filed Nov. 7,2000 and is entitled “NETWORK SECURITY ACCELERATOR”

U.S. Provisional Patent Application Serial No. 60/246,443, which was filed Nov. 7, 2000 and is entitled “METHODS AND SYSTEMS FOR THE ORDER SERIALIZATION OF INFORMATION IN A NETWORK PROCESSING ENVIRONMENT”

U.S. Provisional Patent Application Serial No. 60/246,373, which was filed Nov. 7, 2000 and is entitled “INTERPROCESS COMMUNICATIONS WITHIN A NETWORK NODE USING SWITCH FABRIC”

U.S. Provisional Patent Application Serial No. 60/246,444, which was filed Nov. 7,2000 and is entitled “NETWORK TRANSPORT ACCELERATOR”

U.S. Provisional Patent Application Serial No. 60/246,372, which was filed Nov. 7, 2000 and is entitled “SINGLE CHASSIS NETWORK ENDPOINT SYSTEM WITH Network processor for load balancing”

What is claimed is:

1. A method of performing run-time enforcement of system operations in an information management environment in which multiple information management tasks are performed, comprising:
monitoring resource consumption for each of said multiple information manipulation tasks performed in said information management environment based on an individual resource utilization value that is reflective of the resource consumption required to perform each of said multiple information manipulation tasks;
tracking total resource consumption to perform said multiple information manipulation tasks in said information management environment based on said individual resource utilization values; and
controlling said total resource consumption to avoid over utilization of one or more resources within said information management environment.

2. The method of claim 1, wherein said controlling comprises at least one of differentiated service enforcement, overload protection, resource utilization threshold enforcement, or a combination thereof.

3. The method of claim 1, wherein said multiple information manipulation tasks comprise current information manipulation tasks performed in said information management environment; wherein said tracking comprises tracking current total resource consumption to perform said current multiple information manipulation tasks; and wherein said method further comprises:
responding to requests to perform new requested information manipulation tasks in said information management environment by predicting a new resource consumption associated with the performance of said new information manipulation tasks;
calculating an incremental total resource consumption based on a combination of said new resource consumption and said current total resource consumption; and
controlling said current total resource consumption by performing admission control on said requests for new information manipulation tasks to admit or reject each of said requests for performance in said information management environment.

4. The method of claim 3, wherein said method comprises using estimation-based resource usage accounting to track said current total resource consumption.

5. The method of claim 4, wherein said method further comprises measuring a value of current total resource consumption; comparing said measured current total resource consumption with said estimated total resource consumption; and transitioning between status-driven usage accounting and said estimation-based resource usage accounting based on the magnitude of the difference between said measured value of current total resource consumption and said estimated value of total resource consumption.

6. The method of claim 5, wherein said method further comprises transitioning to a transient state in an attempt to confirm said measured value of current total resource consumption; said transitioning to said transient state being based on a magnitude of the difference between said measured value of current total resource consumption and said estimated value of total resource consumption.

7. The method of claim 1, further comprising generating at least a portion of said individual resource utilization values in real time based on performance testing.

8. The method of claim 3, further comprising performing arrival shaping on said requests for new information manipulation tasks prior to performing said responding, calculating and controlling.

9. The method of claim 8, further comprising differentially performing at least one admitted request for new information manipulation task/s relative to at least one other admitted request for new information manipulation task/s to achieve differentiated service within said information management environment.

10. The method of claim 1, wherein said information management environment comprises a heterogeneous information management system environment.

11. The method of claim 10, wherein said method comprises performing said run-time enforcement of system operations in a network connectable information management system comprising multiple processing engines assigned separate information manipulation tasks in an asymmetrical multi-processor configuration, said plurality of processing engines being coupled together with a distributed interconnect.

12. The method of claim 11, wherein said distributed interconnect comprises a virtual distributed interconnect.

13. The method of claim 11, wherein said distributed interconnect comprises a switch fabric.

14. The method of claim 13, further comprising characterizing a relative state of resource utilization within one or more of said multiple processing engines based on a value of a total resource utilization value within said one or more of said multiple processing engines relative to one or more state thresholds.

15. The method of claim 14, further comprising load-balancing among two or more of said multiple processing engines based on said characterizing.

16. The method of claim 13, wherein said controlling comprises using at least one of said individual multiple processing engines to independently perform admission control on at least one request for a new information manipulation task based on availability of resources of said individual processing engine that are available to perform said requested information manipulation task.

17. The method of claim 13, wherein said information management system comprises a content delivery system.

18. The method of claim 17, wherein said method comprises performing said run-time enforcement of system operations for each processing engine of said multiple processing engines.

19. The method of claim 17, wherein said method comprises performing said run-time enforcement of system operations for each processing engine in the data processing path implemented by a given request to perform new requested information manipulation tasks in said information management environment.

20. The method of claim 18, wherein each of said multiple processing engines comprises one or more resource principals; and wherein said method further comprises quantifying one or more of said resource principals for each of said multiple processing engines to determine said resource utilization values.

21. The method of claim 20, wherein said resource utilization values are expressed in terms of a number of resource capacity utilization units to support delivery of said content at a designated rate; and wherein said controlling comprises implementing overload protection using said resource utilization values to ensure said delivery of said content at said designated rate.

22. The method of claim 20, wherein said multiple resource principals comprise at least one of memory resources, compute resources, I/O resources, number of buffers, number of current connections, number of new connections number of dropped-out connections, number of interfaces, transaction latency, number or outstanding I/O requests, disk drive utilization, loading of applications, or a combination thereof.

23. The method of claim 20, wherein said multiple resource principals comprise at least one of memory resources, compute resources, I/O resources, or a combination thereof.

24. The method of claim 20, wherein said method comprises determining at least one of said resource utilization values based on a combination of two or more of said resource principals.

25. The method of claim 22, wherein said tracking comprises performing resource usage accounting for each of said multiple processing engines in said information management system.

26. The method of claim 1, further comprising using said run-time enforcement of system operations to achieve differentiated service within said information management environment.

27. The method of claim 26, wherein said information management system comprises a multi-tenant environment, a multi-class of service environment, or a combination thereof; and wherein said method further comprises enforcing policy-based access and delivery of said resources in said multi-tenant environment, said multi-class of service environment, or a combination thereof.

28. A method of enforcing differentiated service in an information management environment in which multiple information management tasks are performed, comprising:
performing resource usage accounting in said information management environment; and
enforcing said differentiated service with respect to the performance of at least one of said information management tasks based at least in part on said resource usage accounting.

29. The method of claim 28, wherein sad differentiated service enforcement comprises enforcing policy-based access and delivery of system or subsystem resources in a multi-tenant environment, a multi-service environment, or a combination thereof.

30. The method of claim 28, wherein said differentiated service enforcement comprises using said resource usage accounting to track current resource utilization relative to maximum resource utilization thresholds; and allocating available system or subsystem resources to multiple tenants based upon said tracked current resource utilization according to one or more differentiated service policies in a manner that guarantees sufficient system or subsystem resource availability to satisfy said one or more differentiated service policies without degradation of service quality.

31. The method of claim 28, wherein said differentiated service enforcement comprise using said resource usage accounting to ensure said information management task may be performed in a manner that satisfies a guaranteed service level for performing said information manipulation task.

32. The method of claim 31, wherein said differentiated service enforcement comprises enforcing a given SLA contract to ensure that the guaranteed throughput of the contract will be realized and that best effort services will be supported with potential discriminations.

33. The method of claim 28, wherein said differentiated service enforcement comprises dispatching for processing at least one admitted request for a new information manipulation task in a manner that is differentiated relative to dispatching for processing at least one other admitted request for a new information manipulation task.

34. The method of claim 33, performing said dispatching by using a task scheduling policy by which admitted requests for new information manipulation tasks are placed in multiple dispatch queues and dispatched for processing based on a respective CoS priority associated with each of said requests.

35. The method of claim 28, wherein said resource usage accounting is performed by a method comprising:
characterizing resource consumption for each of said multiple information manipulation tasks performed in said information management environment based on an individual resource utilization value that is reflective of the resource consumption required to perform each of said multiple information manipulation tasks; and
tracking total resource consumption to perform said multiple information manipulation tasks in said information management environment based on said individual resource utilization values.

36. The method of claim 35, further comprising generating at least a portion of said individual resource utilization values in real time based on performance testing.

37. The method of claim 28, wherein said method further comprises:
monitoring resource consumption for each of said multiple information manipulation tasks performed in said information management environment based on an individual resource utilization value that is reflective of the resource consumption required to perform each of said multiple information manipulation tasks;
tracking total resource consumption to perform said multiple information manipulation tasks in said information management environment based on said individual resource utilization values; and
controlling said total resource consumption to differentiate between the performance of said at least two of said information management tasks.

38. The method of claim 37, wherein said multiple information manipulation tasks comprise current information manipulation tasks performed in said information management environment; wherein said tracking comprises tracking current total resource consumption to perform said current multiple information manipulation tasks; and wherein said method further comprises:
responding to requests to perform new requested information manipulation tasks in said information management environment by predicting a new resource consumption associated with the performance of said new information manipulation tasks;
calculating an incremental total resource consumption based on a combination of said new resource consumption and said current total resource consumption; and
controlling said current total resource consumption by performing admission control on said requests for new information manipulation tasks to admit or reject each of said requests for performance in said information management environment.

39. The method of claim 37, wherein said method comprises using estimation-based resource usage accounting to track said current total resource consumption.

40. The method of claim 39, wherein said method further comprises measuring a value of current total resource consumption; comparing said measured current total resource consumption with said estimated total resource consumption; and transitioning between status-driven usage accounting and said estimation-based resource usage accounting based on the magnitude of the difference between said measured value of current total resource consumption and said estimated value of total resource consumption.

41. The method of claim 40, wherein said method further comprises transitioning to a transient state in an attempt to confirm said measured value of current total resource consumption; said transitioning to said transient state being based on a magnitude of the difference between said measured value of current total resource consumption and said estimated value of total resource consumption.

42. The method of claim 28, further comprising performing arrival shaping on requests for new information manipulation tasks prior to performing said resource usage accounting and enforcing said differentiated service.

43. The method of claim 28, further comprising differentially performing at least one admitted request for new information manipulation task/s relative to at least one other admitted request for new information manipulation task/s to achieve differentiated service within said information management environment.

44. The method of claim 28, wherein said information management environment comprises a heterogeneous information management system environment.

45. The method of claim 44, wherein said method comprises enforcing said differentiated service in an information management system comprising multiple processing engines assigned separate information manipulation tasks in an asymmetrical multi-processor configuration, said plurality of processing engines being coupled together with a distributed interconnect.

46. The method of claim 45, wherein said distributed interconnect comprises a virtual distributed interconnect.

47. The method of claim 45, wherein said distributed interconnect comprises a switch fabric.

48. The method of claim 47, further comprising characterizing a relative state of resource utilization within one or more of said multiple processing engines based on a value of a total resource utilization value within said one or more of said multiple processing engines relative to one or more state thresholds.

49. The method of claim 48, further comprising load-balancing among two or more of said multiple processing engines based on said characterizing.

50. The method of claim 47, wherein said enforcing comprises using at least one of said individual multiple processing engines to independently perform admission control on at least one request for a new information manipulation task based on availability of resources of said individual processing engine that are available to perform said requested information manipulation task.

51. The method of claim 47, wherein said information management system comprises a content delivery system.

52. The method of claim 51, wherein said method comprises enforcing said differentiated service for each processing engine of said multiple processing engines.

53. The method of claim 51, wherein said method comprises enforcing said differentiated service for each processing engine in the data processing path implemented by a given request to perform new requested information manipulation tasks in said information management environment.

54. The method of claim 52, wherein said resource usage accounting is performed by a method comprising characterizing resource consumption for each of said multiple information manipulation tasks performed in said information management environment based on an individual resource utilization value that is reflective of the resource consumption required to perform each of said multiple information manipulation tasks, and tracking total resource consumption to perform said multiple information manipulation tasks in said information management environment based on said individual resource utilization values; and
wherein each of said multiple processing engines comprises one or more resource principals; and
wherein said method further comprises quantifying one or more of said resource principals for each of said multiple processing engines to determine said resource utilization values.

55. The method of claim 54, wherein said resource utilization values are expressed in terms of a number of resource capacity utilization units to support delivery of said content at a designated rate; and wherein said controlling comprises implementing overload protection using said resource utilization values to ensure said delivery of said content at said designated rate.

56. The method of claim 54, wherein said multiple resource principals comprise at least one of memory resources, compute resources, I/O resources, number of buffers, number of current connections, number of new connections number of dropped-out connections, number of interfaces, transaction latency, number or outstanding I/O requests, disk drive utilization, loading of applications, or a combination thereof.

57. The method of claim 54, wherein said multiple resource principals comprise at least one of memory resources, compute resources, I/O resources, or a combination thereof.

58. The method of claim 54, wherein said method comprises determining at least one of said resource utilization values based on a combination of two or more of said resource principals.

59. The method of claim 54, wherein said tracking comprises performing resource usage accounting for each of said multiple processing engines in said information management system.

60. The method of claim 28, further comprising using said run-time enforcement of system operations to achieve differentiated service within said information management environment.

61. The method of claim 60, wherein said information management system comprises a multi-tenant environment, a multi-class of service environment, or a combination thereof; and wherein said method further comprises enforcing policy-based access and delivery of said resources in said multi-tenant environment, said multi-class of service environment, or a combination thereof.

62. A determinism module for use in an information management environment, comprising an overload and policy finite state machine module and a resource usage accounting module.

63. The determinism module of claim 62, further comprising a resource utilization table module, a subsystem status monitor, a load information distribution module, and a self calibration module.

64. The determinism module of claim 63, wherein said subsystem status monitor is configured to receive resource status messages from at least one of a wellness/availability module in communication with said determinism module, one or more individual subsystems of an information management system that are in communication with said determinism module, or a combination thereof.

65. The determinism module of claim 63, wherein said resource utilization table module is configured to make available resource utilization values to said resource usage accounting module.

66. The determinism module of claim 62, wherein said determinism module comprises a resource usage accounting module that is configured to track workload within said information management environment.

67. The determinism module of claim 66, wherein said resource usage accounting module is configured to track current workload within said information management environment; and to track incremental workload estimated to be required to fulfill both current workload and requested workload within said information management environment.

68. The determinism module of claim 67, wherein said overload and policy finite state machine module is configured to obtain said current workload and said incremental workload from said resource usage accounting module; and wherein said overload and policy finite state machine module is further configured to compare said current workload with said incremental workload, and to decide whether or not the requested workload is to be performed within said information management environment based on said comparison.

69. The determinism module of claim 68, further comprising a subsystem status monitor configured to receive information on said current workload from at least one of a wellness/availability module in communication with said determinism module, from one or more individual subsystems of an information management system that are in communication with said determinism module, or a combination thereof.

70. A network connectable information management system, comprising:
a plurality of multiple processing engines coupled together by a distributed interconnect; and
a determinism module coupled to said multiple processing engines via said distributed interconnect.

71. The system of claim 70, wherein said distributed interconnect comprises a virtual distributed interconnect.

72. The system of claim 70, wherein said distributed interconnect comprises a switch fabric.

73. The system of claim 72, wherein at least one of said individual multiple processing engines is configured to independently perform admission control for requests for new information manipulation tasks.

74. The system of claim 72, wherein said multiple processing engines comprise a system management processing engine; and wherein said determinism module is implemented on said system management processing engine.

75. The system of claim 74, wherein said information management system comprises a content delivery system; and wherein said multiple processing engines further comprise at least one application processing engine, at least one storage processing engine, at least one transport processing engine, and at least one network interface processing engine.

76. The system of claim 75, wherein said determinism module comprises an overload and policy finite state machine module, a resource usage accounting module, a resource utilization table module, a subsystem status monitor, a load information distribution module, and a self calibration module.

77. The system of claim 76, wherein said subsystem status monitor is configured to receive resource status messages from at least one of a wellness/availability module in communication with said determinism module, one or more individual subsystems of an information management system that are in communication with said determinism module, or a combination thereof.

78. The system of claim 76, wherein said resource utilization table module is configured to make available resource utilization values to said resource usage accounting module.

79. The system of claim 76, wherein said resource utilization table module is further configured to make available resource utilization values to said resource usage accounting module, at least a portion of said resource utilization values being generated in real time by said self-calibration module based on one or more performance measurements.

80. The system of claim 75, wherein said determinism module comprises a resource usage accounting module that is configured to track system and/or subsystem workloads.

81. The system of claim 80, wherein said resource usage accounting module is configured to track current system/subsystem workloads to fulfill current admitted requests; and to track incremental system/subsystem workloads estimated to be required to fulfill both existing requests and new request/s that are not yet admitted.

82. The system of claim 81, wherein said determinism module further comprises an overload and policy finite state machine module that is configured to obtain said current system/subsystem workload and said incremental system/subsystem workload from said resource usage accounting module; and wherein said overload and policy finite state machine module is further configured to compare said current system/subsystem workload with said incremental system/subsystem workload, and to decide whether or not the new request is to be granted based upon said comparison.

83. The system of claim 81, wherein said determinism module further comprises a subsystem status monitor configured to receive information on said current system/subsystem workload from at least one of a wellness/availability module in communication with said determinism module, from one or more individual subsystems of an information management system that are in communication with said determinism module, or a combination thereof.
